(19) United States
(12) Patent Application Publication
(10) Pub. No.: US 2026/0207301 A1
(43) Pub. Date: Jul. 23, 2026

(54) Geometric Deep Learning For Final Setups And Intermediate Staging In Clear Tray Aligners

(71) Applicant: Solventum Intellectual Properties Company, Maplewood, MN (US)

(72) Inventors: Seyed Amir Hossein Hosseini, Saint Paul, MN (US); Kristopher W. Kampshoff, Forest Lake, MN (US); Michael B. Starr, Toomevara (IE); Francis J.T. Yates, Dublin (IE); Mariah Sonja Pereira Penha, Dublin (IE); Jonathan D. Gandrud, Woodbury, MN (US)

(21) Appl. No.: 19/139,072

(22) PCT Filed: Dec. 14, 2023
(86) PCT No.: PCT/IB2023/062693

§ 371 Date: Jun. 13, 2025

Related U.S. Application Data
(60) Provisional application No. 63/432,627, filed on Dec. 14, 2022.
(60) Provisional application No. 63/460,590, filed on Apr. 19, 2023.

(51) Int. Cl. A61C 7/00; A61C 7/08; G06N 3/0455; G06N 3/0475; G06N 3/08; G06T 17/20

(52) U.S. Cl. CPC A61C 7/002; A61C 7/08; G06N 3/0455; G06N 3/0475; G06N 3/08; G06T 17/20

(57) ABSTRACT

Systems and techniques are disclosed for generating setups for orthodontic alignment treatment. The method involves receiving a digital representation of a patient's teeth and at least one value pertaining to the customization of orthodontic treatment. A prediction for one or more tooth movements for a setup is formed by executing a generator network comprising one or more neural networks. The generator network is further trained based on the formed prediction by performing operations that include predicting the tooth movements, quantifying the difference between the predicted tooth movements and reference tooth movements, generating a loss value based on the quantified difference, and modifying the generator network based on the loss value to form a modified generator network. These systems and techniques enable the efficient generation of setups for orthodontic alignment treatment, improving the accuracy and customization of the treatment process.

### RELATED DOCUMENTS

The entire disclosure of PCT Application No. PCT/IB2022/057373 is incorporated herein by reference. The entire disclosures of each of PCT applications with Publication Nos. WO2022123402A1, WO2021245480A1, and WO2020026117A1 are incorporated herein by reference. The entire disclosure of each of the following Provisional U.S. patent applications is incorporated herein by reference: 63/432,627; 63/366,492; 63/366,495; 63/352,850; 63/366,490; 63/366,494; 63/370,160; 63/366,507; 63/352,877; 63/366,514; 63/366,498; 63/366,514; and 63/264,914.

### TECHNICAL FIELD

This disclosure relates to configurations and training of neural networks to improve the accuracy of automatically generated clear tray aligner (CTA) devices used in orthodontic treatments.

### SUMMARY

Some existing techniques have attempted to use machine learning to generate the CTA devices, but with mixed results. As a result, there is a need for better machine learning models and training approaches to improve the systems that automate the production of CTAs.

The present disclosure describes systems and techniques for training and using one or more machine learning models, such as neural networks to produce intermediate stages and final setups for CTAs, in a manner which is customized to the treatment needs of the patient. Such a neural network is termed herein as a “setups prediction neural network” or simply a “setups prediction model.” A final setup (also referred to as final setups) is a target configuration of 3D tooth representations (such as 3D tooth meshes) such as the teeth appear at the end of treatment. An intermediate setup (also referred to as an “intermediate stage” or as “intermediate staging”) describes a configuration of teeth during one of the several stages of treatment, after the teeth leave their maloccluded poses (e.g., positions and/or orientations) and before the teeth reach their final setup poses. In some implementations, a final setup may be used to generate, at least in part, one or more intermediate stages. Each stage may be used in the generation of a clear tray aligner. Such aligners may incrementally move the patient's teeth from the initial or maloccluded poses to the final poses represented by the final setup.

In a first aspect, a first computer-implemented method for generating setups for orthodontic alignment treatment is described including the steps of receiving, by one or more computer processors, a first digital representation of a patient's teeth, using, by the one or more computer processors and to determine a prediction for one or more tooth movements for a final setup, a generator that is a machine learning model, such as comprising one or more neural networks (e.g., a 3D encoder, 3D decoder, a 3D U-Net, an MLP, a transformer, an autoencoder, a pyramid encoder-decoder, a neural network with an attention layer and other neural networks disclosed herein) that has been initially trained to predict one or more tooth movements for a final setup, further training, by the one or more computer processors, the setups prediction model based on the using, and where the training of the setups prediction model is modified by performing operations including predicting, by the generator, one or more tooth movements for a final setup based on the first digital representation of the patient's teeth, computing a loss function which quantifies the difference between predicted tooth movements and reference tooth movements, and modifying the setups prediction model using that loss.

The first aspect can optionally include additional features. For instance, the method can produce, by the one or more processors, an output state for the final setup. The method can determine, by the one or more computer processors, a difference between the one or more predicted tooth movements and the one or more reference tooth movements. The determined difference between the one or more predicted tooth movements and the one or more reference tooth movements can be used to modify the training of the generator. Modifying the training of the generator can include adjusting one or more weights of the generator's neural network. The method can generate, by the one or more computer processors, one or more lists specifying mesh elements of the first digital representation of the patient's teeth. At least one of the one or more lists can specify one or more edges in the first digital representation of the patient's teeth. At least one of the one or more lists can specify one or more polygonal faces in the digital representation of the patient's teeth. At least one of the one or more lists can specify one or more vertices in the first digital representation of the patient's teeth (e.g., such as derived from a 3D mesh). At least one of the one or more lists can specify one or more points in the first digital representation of the patient's teeth (e.g., such as derived from a 3D point cloud). A 3D point cloud may, in some instances, comprise the plurality of vertices extracted from a 3D mesh. At least one of the one or more lists can specify one or more voxels in the first digital representation of the patient's teeth (e.g., such as derived from a sparse representation). The method can compute, by the one or more computer processors, one or more mesh element features. In the case of edges, the one or more mesh element features can include edge endpoints, edge curvatures, edge normal vectors, edges movement vectors, edge normalized lengths, vertices, faces of associated three-dimensional representations, voxels, and combinations thereof. Other mesh element features for edges are disclosed herein. Mesh element features for each of vertices, points, faces and voxels are also disclosed herein. The method can generate, by the one or more computer processors, a digital representation predicting the position and orientation of the patient's teeth based on the one or more predicted tooth movements. A prediction for the movement of a tooth may comprise a transform (e.g., such as one or more of an affine transformation matrix, a translation vector, a quaternion, or one or more Euler angles). The setups prediction model may predict each of tooth position and tooth orientation information. In some non-limiting examples, the network may predict the orientation and position information substantially concurrently. The setups prediction model may predict a setup transform for each tooth in the arch, to place each tooth in the final setup pose. The method can generate, by the one or more computer processors, a digital representation of the patient's teeth based on the one or more reference tooth movements. In some non-limiting implementations, the generator of a setups prediction model may be trained, at least in part, with the assistance of a discriminator. The discriminator may determine whether a representation of the one or more tooth movements predicted by the generator is distinguishable from a representation of one or more reference tooth movements can include the steps of receiving the representation of the one or more tooth movements predicted by the generator, the representation of the one or more reference tooth movements, and the first digital representation of the patient's teeth, comparing the representation of the one or more tooth movements predicted by the generator, the representation of the one or more reference tooth movements, wherein the comparison is based at least in part on the first digital representation of the patient's teeth, and determining, by the one or more computer processors, a probability that the representation of the one or more tooth movements predicted by the generator is the same as the representation of one or more reference tooth movements.

In a second aspect, a second computer-implemented method for generating setups for orthodontic alignment treatment pertains to intermediate staging prediction. Intermediate staging of teeth from a malocclusion stage to a final stage requires determining accurate individual teeth movements in a way that teeth are not colliding with each other, the teeth move toward their final state, and the teeth follow optimal and preferably short trajectories. Because each tooth has six degrees-of-freedom and an average arch has about fourteen teeth, finding the optimal teeth trajectory from initial to final stage is a large and complex problem.

The second computer-implemented method is customized to the treatment needs of the patient (e.g., as specified by a clinician, which may include technician or healthcare professional) and is described including the steps of receiving, by one or more computer processors, a first digital representation of a patient's teeth, and a representation of a final setup, using, by the one or more computer processors and to determine a prediction for one or more tooth movements for one or more intermediate stages, a generator that is a machine learning model, such as a neural network, included in a setups prediction machine learning model, such as comprising one or more neural networks (e.g., a 3D encoder, 3D decoder, a multilayer perceptron (MLP), an encoder-decoder structure or other neural networks disclosed herein), and that has been initially trained to predict one or more tooth movements for one or more intermediate stages, further training, by the one or more computer processors, the setups prediction model based on the using, wherein the training of the setups prediction model is modified by performing operations including predicting, by the generator, one or more tooth movements for at least one intermediate stage based on the first digital representation of the patient's teeth, computing a loss function which quantifies the difference between predicted tooth movements and reference tooth movements and modifying the setups prediction model using that loss. The second aspect can also include one or more of the optional features described above in reference to the first aspect.

3D representations of a patient's teeth may be provided to a first ML module (e.g., a U-Net structure, a pyramid encoder-decoder structure, or a transformer structure-such as a 3D SWIN transformer), which may provide latent representations of the patient's teeth (e.g., including hierarchical neural network features) to a second ML module (e.g., an MLP, a transformer, an encoder, or other architects described herein). The second ML module may optionally contain one or more coordinate normalization layers. Operations including mesh pooling, mesh unpooling, mesh convolution, or mesh unconvolution may be applied to the 3D representations of the patient's teeth in the course of the execution of the first ML module. The operations may function in a manner that is invariant to at least one of rotation, scale or translation of the patient's teeth. A 3D representation may include any of a 3D mesh, a 3D point cloud, a 3D surface, or a voxelized representation. A 3D representation of a tooth may contain one or more mesh elements. Mesh element feature vectors may be computed for the mesh elements in the 3D representations of the patient's teeth. These mesh element feature vectors may be provided to the first ML module to improve the accuracy of the latent representations generated by the first ML module. The mesh element feature vectors may contain spatial mesh element features, structural mesh element features, or color-based mesh element features. Oral care argument values (e.g., pertaining to a customization of orthodontic treatment with respect to a patient) may be provided to either of the first or second ML modules.

Oral care arguments which may be provided to the second ML module may include oral care procedure parameters, or oral care metrics, to customize outputs. Doctor preferences may be provided to the second ML module, to customize outputs. In some implementations, information about interproximal reduction for one or more teeth may be provided to the second ML module. In some implementations, case classification information may be provided to the second ML module. In some implementations, information about an anterior posterior shift may be provided to the second ML module.

The second ML module may generate setups transforms for the patient's teeth (e.g., which may describe tooth movements). The first or second ML modules may be trained, at least in part, by a loss function which quantifies the difference between one or more predicted transforms and one or more corresponding ground truth transforms. A loss value may be computed which quantifies the difference between a predicted setup and a predetermined ground truth setup. An example loss function may compute at least one pairwise distance between at least one aspect of a 3D tooth representation of a tooth pose as represented in the predicted setup and at least one corresponding aspect of a representation of a corresponding tooth in a reference pose in a ground truth setup. In some implementations, the accuracy of loss calculation may be improved by registering the predicted setup with a corresponding ground truth setup.

The second ML module may, in some implementations, contain a generator which is trained, at least in part, by a discriminator. The orthodontic setup prediction methods described herein may be used in conjunction with other digital oral care treatment methods for patient treatment (e.g., a machine learning model which predicts a restoration tooth design, or a machine learning model which generates at least one component or places at least one component for the generation of an oral care appliance). The tooth transforms predicted by second ML module may be used in the generation of an orthodontic appliance (e.g., a thermoformed or 3D printed clear tray aligner (CTA)). One or more binary flags may be provided to the second ML module, to indicate that one or more teeth are fixed, pinned, pontic, extracted, implanted, or missing.

In some implementations, the first ML module and the second ML module may be trained using representation learning. In some implementations, the first ML module and the second ML module may be trained end-to-end. In some implementations, the first ML module and the second ML module may be trained using transfer learning (e.g., based on a neural network which has first be trained on coordinate system prediction). In some implementations, the first ML module and the second ML module may be used as the basis to train a third neural network module using transfer learning (e.g., to train a third neural network using the first or second ML modules as an initial state). In some implementations, the first ML module or the second ML module may contain an attention mechanism (e.g., as is used in a transformer).

In some implementations, the first ML module and/or the second ML module may be trained to use sparse processing (e.g., using voxels). The training data may, in some instances, undergo augmentation, according to techniques of this disclosure. In some implementations, tooth movements may employ relative local tooth transformation encoding. In some implementations, tooth movements may employ absolute tooth transformation encoding. In some implementations, one or more archforms for the patient may be provided to the second ML module.

In some instances, an interproximal reduction operation may be performed on at least one 3D representation of a tooth of the patient before automated setups prediction is performed. In some implementations, information pertaining to IPR may be provided to the second ML module, to influence the generated setups transforms. An IPR cut surface may be provided to the second ML module. A designation of which tooth should receive IPR (and optionally at which stage of orthodontic treatment) may be provided to the second ML module.

Tooth transforms may take the form of at least one of: a transformation matrix, a translation vector, a quaternion, or at least Euler angle. In some implementations, a tooth transform may apply a rotation a tooth of the patient, where the pivot point of that rotation is at one of: the crown centroid, apex of the root tip, origin of malocclusion transform or at a point along an archform in proximity to the tooth.

In some instances, the training dataset may be filtered to remove outlier cases, for example, filtered based on at least one oral care metric. In some instances, techniques of this disclosure may be performed in a clinical context, such as a clinic or doctor's office.

### BRIEF DESCRIPTION OF DRAWINGS

FIG. 1 shows a method of augmenting training data for use in training machine learning (ML) models of this disclosure.

FIG. 2 shows a summary of some of the setups prediction methods described herein.

FIG. 3 shows a setups prediction method using denoising diffusion probabilistic models.

FIG. 4 shows a method for setups prediction called Similarity Setups.

FIG. 5 shows a method of training a setups prediction model which generates setups which are customized to the treatment needs of the patient.

FIG. 6 shows an example generator implementation for a setups prediction model.

FIG. 7 shows a method of generating orthodontic setups transforms using a U-Net and an encoder.

FIG. 8 shows a method of generating orthodontic setups transforms using a U-Net and a multi-layer perceptron (MLP).

FIG. 9 shows a method of generating orthodontic setups transforms using a U-Net and a transformer encoder (or a transformer decoder).

FIG. 10 shows a transformer which may be configured to generate orthodontic setups transforms.

### DETAILED DESCRIPTION

Techniques of this disclosure may train an encoder-decoder structure (e.g., a U-Net) to generate transforms to place 3D representations of oral care data (e.g., teeth, appliance components, fixture model components, etc.) into poses which are suitable for oral care appliance generation (e.g., to place the patient's teeth into setups poses for use in aligner treatment). An encoder-decoder structure may comprise at least one encoder or at least one decoder. Non-limiting examples of an encoder-decoder structure include a 3D U-Net, a transformer (e.g., a 3D SWIN transformer), a pyramid encoder-decoder, or an autoencoder, among others.

Described herein are techniques for the automatic prediction of setups, which may provide the advantage of improving accuracy in comparison to existing techniques, enable new clinicians to be trained in the generation of effective setups, enable customized setups to be produced (e.g., which align with the specifications of clinicians), and provide the technical improvement of enhanced data precision in the formulation of these setups.

A setups prediction model of this disclosure may receive a variety of input data, which, as described herein, may include tooth meshes representing one or both arches of the patient. The tooth data may be presented in the form of 3D representations, such as 3D meshes, 3D point clouds, voxelized representations, or the like. These data may be preprocessed, for example, by arranging the constituent mesh elements into lists and computing an optional mesh element feature vector for each mesh element. Such vectors may impart valuable information of the shape and/or structure of the tooth to the setups prediction neural network. Additional inputs may enable the setups prediction neural network to better understand the distribution of the provided data (e.g., tooth meshes), which provides the technical improvement of enabling customization to the specific medical/dental needs of the patient when the setups prediction model is deployed. For example, one or more oral care metrics may be computed. Oral care metrics may be used for measuring one or more physical aspects of a setup (e.g., physical relationships within a tooth or between teeth). In some instances, an orthodontic metric may be computed for a ground truth setup which is then used in the training of a machine learning model (e.g., a setups prediction model). The metric value may be received at the input of the setups prediction model, as a way of training the model to encode a distribution of such a metric over the several examples of the training dataset. For example, an “overbiteleft” metric may be computed for a setup which is received by the setups prediction model (e.g., at least one of mal and/or approved setup). During training, the network may then receive this metric value as an input, to assist in training the network to link that provided metric value to the physical aspects of the received setup (e.g., to learn a distribution over the possible values of that metric across the examples of the training dataset). The metric may be computed for the mal setup, and that metric value be provided as an input the network during training, alongside the malocclusion transforms and/or tooth meshes. The metric may additionally or alternatively be computed for the approved setup, and that metric may be provided as an input to the network during training, alongside the approved setup transforms and/or tooth meshes (e.g., for application during loss calculation time). Such a loss calculation may quantify the difference between a prediction and a ground truth example (e.g., between a predicted setup and a ground truth setup). By providing the network a metric value at training time, the network may, through the course of loss calculation and subsequent backpropagation, learn to encode a distribution of that metric. A technical improvement provided by the setups prediction techniques described herein is the customization of orthodontic treatment to the patient. Oral care parameters may enable a clinician to customize specific desired aspects of the dimensions, proportions and other physical aspects of a predicted setup. For example, in deployment, one or more oral care parameters (procedure parameters or restoration design parameters) may be defined and provided to the trained setups prediction model as part of the execution-phase input to specify one or more aspects of an intended setup upon an execution run. In some implementations, a procedure parameter may be defined which corresponds to an oral care metric (e.g., such as the overbiteleft metric described above), which may be received at the input to a deployed setups prediction neural network and be taken as an instruction to the setups prediction neural network to generate a setup with the specified quantity of the metric (e.g., overbiteleft). The setups prediction model may be especially suited to generating a setup with a prescribed value of a procedure parameter in the circumstance where that prescribed value falls within the distribution of the corresponding metric value that appeared in the training dataset. Other procedure parameters may also be defined corresponding to other orthodontic metrics and be taken as instructions to the setups prediction model for the quantity of the relevant metric that is to be imparted to the predicted setup. This interplay between oral care metrics and oral care parameters may also apply to the training and deployment of other predictive models in oral care as well.

To train the setups prediction neural network effectively, aspects of this disclosure are directed to forming training data that have a distribution which describes the kind of setup that the setups prediction neural network is configured to produce. For example, to produce a final setup with an overbite of approximately 2.0 mm, one approach is to use ground truth training data with an overbite of approximately 2.0 mm. This approach may lead to a clean training signal and may produce useful results, and an alternative method may enable the network to learn to account for differences in overbite among the various ground truth training samples in the training dataset. An overbite metric may be computed for the malocclusion arches of a training sample (a patient case). This overbite value may be received as an input to the setups prediction neural network at training time, along with the maloccluded tooth data, and serve as a signal to the neural network regarding the magnitude of overbite present in that mal arch. The network thereby learns that different cases have different overbite magnitudes and can encode a distribution of possible overbite magnitudes, which can then be imparted to the predicted setup. Upon deployment, the trained neural network may receive the maloccluded tooth data as input and may also receive an input to indicate a magnitude of the overbite (e.g., or some other oral care metric) that is desired in the predicted setup (e.g., in the form of a procedure parameter which has been defined for the purpose). This approach may enable the setups prediction neural network to account for differences in the distribution of the training dataset without excluding patient cases from the training dataset (e.g., as may be done in the case of filtering the training dataset), with the added benefit of enabling the deployed setups prediction neural network to customize the predicted setup, according to the specification of the clinician who uses the setups prediction model. Other orthodontic metrics (e.g., those disclosed herein) may also be computed in keeping with this technique. Corresponding procedure parameters ((e.g., those disclosed herein or those defined to correspond to specific metrics) may be provided to the trained network to effect the customization of the outputted setups prediction. Other techniques disclosed herein, besides setups prediction, may also be trained with this use of oral care metrics and procedure parameters being received as inputs to a predictive model.

A setups prediction neural network of this disclosure may be trained, at least in part, by the calculation of one or more loss values (e.g., reconstruction loss or other loss values described herein). Such loss values may quantify the difference between a predicted setup and a corresponding ground truth setup. In some instances, these setups may be registered with each other (e.g., using iterative closest point (ICP) or singular value decomposition (SVD)) before the loss is computed, to reduce noise and improve the accuracy of the resulting trained setups prediction neural network. Such a registration may alternatively or additionally be performed between the maloccluded setup and the corresponding ground truth setup, with the advantage of reducing noise in the loss measurement and improving the accuracy of the trained network.

The setups prediction neural network may compute a transform for each tooth, to move that tooth into a pose which is suitable for the end of orthodontic treatment (e.g., the final setup). The pose of the tooth may include a change in position in 3D space and may also include a change in orientation (e.g., with respect to one or more coordinate axes—e.g., local coordinate axes with origin at the crown centroid). The transform may effect the change in orientation by pivoting the tooth mesh relative to a pivot point or tooth origin. This pivot point may be chosen to lie within the crown centroid. Alternatives include at the apex of the root tip, origin of malocclusion transform or at a point along an archform in proximity to the tooth.

In some implementations, the setups prediction neural network may be trained conditionally on interproximal reduction (IPR) information. IPR may be applied to the teeth, to enable greater packing of teeth a in final setup. The setups model may be trained to account to IPR quantities (e.g., millimeters of offset in from either or both of the mesial and distal sides of a tooth) and/or IPR cut planes (which may be used in conjunction with mesh Boolean operations to remove material on either or both of the mesial and distal sides of a tooth). For example, IPR cut planes may be used to modify one or more tooth meshes for one or more patient cases which are used to train the setups prediction model. This step improves the accuracy of setups prediction model training by improving data precision, because material is removed from the teeth which may otherwise lead to collisions between teeth in the final setup (and result in noise in the training data). After the trained setups prediction model is deployed, IPR may be applied to a trial patient case, to modify the shapes of the teeth before the case is received as input to the setups prediction model. In some instances, IPR may be applied to one or more tooth meshes of a patient case before the computation of orthodontic metrics.

In orthodontics, an anterior posterior (AP) shift may involve a sagittal shift of the mandible (lower arch), moving the mandible either forward or backwards. The application of the AP Shift may improve the class relationship of the teeth. Class may describe the patient's malocclusion. Possible classes include: class 1, class 2 or class 3. Elastics may aid in the shift of the mandible. Such elastics may attach to hardware on the teeth, such as buttons. In some instances, the setups prediction model of this disclosure may directly receive an AP shift transform as an input, which may improve the data precision of the resulting model. In some instances, an AP shift transform may first be applied to the patient case data before the patient case data are received as input to the setups prediction model of this disclosure.

The predictive models of the present disclosure may, in some implementations, may produce more accurate results by the incorporation of one or more of the following inputs: archform information V, interproximal reduction (IPR) information U, tooth dimension information P, tooth gap information Q, latent capsule representations of oral care meshes T, latent vector representations of oral care meshes A, procedure parameters K (which may describe a health care professional's intended treatment of the patient), doctor preferences L (which may describe the typical procedure parameters chosen by a doctor), flags regarding tooth status M (such as for fixed or pinned teeth), tooth position information N, tooth orientation information O, tooth name/dental notation R, oral care metrics S (comprising at least one of oral care metrics and restoration design metrics).

Systems of this disclosure may, in some instances, be deployed in a clinical context (such as a dental or orthodontic office) for use by clinicians (e.g., doctors, dentists, orthodontists, nurses, hygienists, oral care technicians). Such systems which are deployed in a clinical context may enable clinicians to process oral care data (such as dental scans) in the clinic environment, or in some instances, in a “chairside” context (where the patient is present in the clinical environment). A non-limiting list of examples of techniques may include: segmentation, mesh cleanup, coordinate system prediction, CTA trimline generation, restoration design generation, appliance component generation or placement or assembly, generation of other oral care meshes, the validation of oral care meshes, setups prediction, removal of hardware from tooth meshes, hardware placement on teeth, imputation of missing values, clustering on oral care data, oral care mesh classification, setups comparison, metrics calculation, or metrics visualization. The execution of these techniques may, in some instances, enable patient data to be processed, analyzed and used in appliance creation by the clinician before the patient leaves the clinical environment (which may facilitate treatment planning because feedback may be received from the patient during the treatment planning process).

Systems of this disclosure may automate operations in digital orthodontics (e.g., setups prediction, hardware placement, setups comparison), in digital dentistry (e.g., restoration design generation) or in combinations thereof. Some techniques may apply to either or both of digital orthodontics and digital dentistry. A non-limiting list of examples is as follows: segmentation, mesh cleanup, coordinate system prediction, oral care mesh validation, imputation of oral care parameters, oral care mesh generation or modification (e.g., using autoencoders, transformers, continuous normalizing flows or denoising diffusion models), metrics visualization, appliance component placement or appliance component generation or the like. In some instances, systems of this disclosure may enable a clinician or technician to process oral care data (such as scanned dental arches). In addition to segmentation, mesh cleanup, coordinate system prediction or validation operations, the systems of this disclosure may enable orthodontic treatment planning, which may involve setups prediction as at least one operation. Systems of this disclosure may also enable restoration design generation, where one or more restored tooth designs are generated and processed in the course of creating oral care appliances. Systems of this disclosure may enable either or both of orthodontic or dental treatment planning, or may enable automation steps in the generation of either or both of orthodontic or dental appliances. Some appliances may enable both of dental and orthodontic treatment, while other appliances may enable one or the other.

A final setup, an intermediate stage or combinations or sequences thereof may be used in the design and manufacture of orthodontic appliances, such as clear tray aligners (CTAs). A fixture model may be generated from a setup (or a stage), which may be 3D printed. A clear plastic tray may be thermoformed onto such a fixture model. The thermoformed tray is cut away from the fixture model (e.g., by following a CTA trimline), thereby completing the aligner tray. In some instances, a digital fixture model may be used to create a 3D oral care representation of an aligner tray, which may then be directly 3D printed.

Techniques of this disclosure may require a training dataset of hundreds or thousands of cohort patient cases, to ensure that the neural network is able to encode the distribution of patient cases which are likely to be encountered in clinical treatment. A cohort patient case may include a set of tooth crown meshes, a set of tooth root meshes, or a data file containing attributes of the case (e.g., a JSON file). A typical example of a cohort patient case may contain up to 32 crown meshes (e.g., which may each contain tens of thousands of vertices or tens of thousands of faces), up to 32 root meshes (e.g., which may each contain tens of thousands of vertices or tens of thousands of faces), multiple gingiva mesh (e.g., which may each contain tens of thousands of vertices or tens of thousands of faces) or one or more JSON files which may each contain tens of thousands of values (e.g., objects, arrays, strings, real values, Boolean values or Null values).

In some implementations, a setups prediction model (e.g., such as a setups prediction model which uses a U-Net) may contain aspects derived from a denoising diffusion model (e.g., a neural network which may be trained to iteratively denoise one or more setups transforms-such as transforms which are initialized stochastically or using Gaussian noise). In some implementations, a setups prediction model (e.g., such as a setups prediction model which uses a U-Net) may generate setups transforms, at least in part, using one or more neural networks which are trained to use neural networks which have been trained with continuous normalizing flows (e.g., the use of a neural network which may be trained in one form and then be inverted for use during inference).

Aspects of the present disclosure can provide a technical solution to the technical problem of predicting, using 3D representations of a patient's dentition, orthodontic setups for use in oral care appliance generation (e.g., intermediate stages or final setups for the generation of aligner trays). In particular, by practicing techniques disclosed herein computing systems specifically adapted to perform setups transform prediction for oral care appliance generation are improved. For example, aspects of the present disclosure improve the performance of a computing system having a 3D representation of the patient's dentition by reducing the consumption of computing resources. In particular, aspects of the present disclosure reduce computing resource consumption by decimating 3D representations of the patient's dentition (e.g., reducing the counts of mesh elements used to describe aspects of the patient's dentition) so that computing resources are not unnecessarily wasted by processing excess quantities of mesh elements. Additionally, decimating the meshes does not reduce the overall predictive accuracy of the computing system (and indeed may actually improve predictions because the input provided to the ML model after decimation is a more accurate (or better) representation of the patient's dentition). For example, noise or other artifacts which are unimportant (and which may reduce the accuracy of the predictive models) are removed. That is, aspects of the present disclosure provide for more efficient allocation of computing resources and in a way that improves the accuracy of the underlying system.

Furthermore, aspects of the present disclosure may need to be executed in a time-constrained manner, such as when an oral care appliance must be generated for a patient immediately after intraoral scanning (e.g., while the patient waits in the clinician's office). As such, aspects of the present disclosure are necessarily rooted in the underlying computer technology of setups transform prediction for oral care appliance generation and cannot be performed by a human, even with the aid of pen and paper. For instance, implementations of the present disclosure must be capable of: 1) storing thousands or millions of mesh elements of the patient's dentition in a manner that can be processed by a computer processor; 2) performing calculation on thousands or millions of mesh elements, e.g., to quantify aspects of the shape and or/structure of an individual tooth in the 3D representation of the patient's dentition; and 3) predicting, based on a machine learning model, orthodontic setups for use in oral care appliance generation (e.g., orthodontic setups transforms which are customized to the treatment needs of the patient by providing oral care metrics or oral care parameters to the machine learning model), and do so during the course of a short office visit.

This disclosure pertains to digital oral care, which encompasses the fields of digital dentistry and digital orthodontics. This disclosure generally describes methods of processing three-dimensional (3D) representations of oral care data, and/or associated transforms. It should be understood, without loss of generality, that there are various types of 3D representations. One type of 3D representation is a 3D geometry. A 3D representation may include, be, or be part of one or more of a 3D polygon mesh, a 3D point cloud (e.g., such as derived from a 3D mesh), a 3D voxelized representation (e.g., a collection of voxels—for sparse processing), or 3D representations which are described by mathematical equations. Although the term “mesh” is used frequently throughout this disclosure, the term should be understood, in some implementations, to be interchangeable with other types of 3D representations. A 3D representation may describe elements of the 3D geometry and/or 3D structure of an object.

Dental arches S1, S2, S3 and S4 all contain the exact same tooth meshes, but those tooth meshes are transformed differently, according to the following description. A first arch S1 includes a set of tooth meshes arranged (e.g., using transforms) in their positions in the mouth, where the teeth are in the mal positions and orientations. A second arch S2 includes the same set of tooth meshes from S1 arranged (e.g., using transforms) in their positions in the mouth, where the teeth are in the ground truth setup positions and orientations. A third arch S3 includes the same meshes as S1 and S2, which are arranged (e.g., using transforms) in their positions in the mouth, where the teeth are in the predicted final setup poses (e.g., as predicted by one or more of the techniques of this disclosure). S4 is a counterpart to S3, where the teeth are in the poses corresponding to one of the several intermediate stages of orthodontic treatment with clear tray aligners.

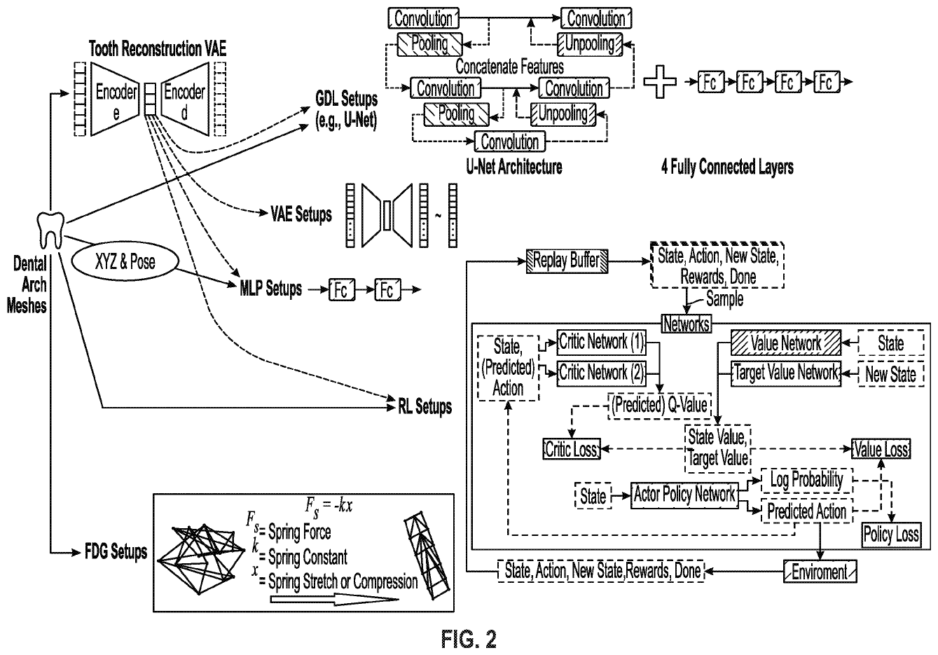

It should be understood, without the loss of generality, that the techniques of this disclosure which apply to final setups are also applicable to intermediate staging in orthodontic treatment, particularly geometric deep learning (GDL) Setups, reinforcement learning (RL) Setups, variational autoencoder (VAE) Setups, Capsule Setups, multilayer perceptron (MLP) Setups, Diffusion Setups, pose transfer (PT) Setups, Similarity Setups, force directed graphs (FDG) Setups, Transformer Setups, Setups Comparison, or Setups Classification. The Metrics Visualization aspects of this disclosure may also be configured to visualize data from both final setups and intermediate stages. MLP Setups, VAE Setups and Capsule Setups each fall within the scope of Autoencoder Setups. Some implementations of MLP Setups may fall within the Scope of Transformer Setups. FIG. 2 shows a non-limiting selection of models which may be trained for setups prediction. Representation Setups refers to any of MLP Setups, VAE Setups, Capsule Setups and any other setups prediction machine learning model which uses an autoencoder to create the representation for at least one tooth.

Each of the setups prediction techniques of this disclosure is applicable to the fabrication of clear tray aligners and/or indirect bonding trays. The setups predictions techniques may also be applicable to other products that involve final teeth poses, also. A pose may comprise a position (or location) and a rotation (or orientation).

A 3D mesh is a data structure which may describe the geometry or shape of an object related to oral care, including but not limited to a tooth, a hardware element, or a patient's gum tissue. A 3D mesh may include one or more mesh elements such as one or more of vertices, edges, faces and combinations thereof. In some implementations, mesh element may include voxels, such as in the context of sparse mesh processing operations. Various spatial and structural features may be computed for these mesh elements and be provided to the predictive models of this disclosure, with the predictive models of this disclosure providing the technical advantage of improving data precision in the form of the models of this disclosure outputting more accurate predictions.

A patient's dentition may include one or more 3D representations of the patient's teeth (e.g., and/or associated transforms), gums and/or other oral anatomy. An orthodontic metric (OM) may, in some implementations, quantify the relative positions and/or orientations of at least one 3D representation of a tooth relative to at least one other 3D representation of a tooth. A restoration design metric (RDM) may, in some implementations, quantify at least one aspect of the structure and/or shape of a 3D representation of a tooth. An orthodontic landmark (OL) may, in some implementations, locate one or more points or other structural regions of interest on a 3D representation of a tooth. An OL may, in some implementations, be provided to the generation of an orthodontic or dental appliance, such as a clear tray aligner or a dental restoration appliance. A mesh element may, in some implementations, comprise at least one constituent element of a 3D representation of oral care data. For example, in the case of a tooth that is represented by a 3D mesh, mesh elements may include at least: vertices, edges, faces and voxels. A mesh element feature may, in some implementations, quantify some aspect of a 3D representation in proximity to or in relation with one or more mesh elements, as described elsewhere in this disclosure. Orthodontic procedure parameters (OPP) may, in some implementations, specify at least one value which defines at least one aspect of planned orthodontic treatment for the patient (e.g., specifying desired target attributes of a final setup in final setups prediction). Orthodontic Doctor preferences (ODP) may, in some implementations, specify at least one typical value for an OPP, which may, in some instances, be derived from past cases which have been treated by one or more oral care practitioners. Restoration Design Parameters (RDP) may, in some implementations, specify at least one value which defines at least one aspect of planned dental restoration treatment for the patient (e.g., specifying desired target attributes of a tooth which is to undergo treatment with a dental restoration appliance). Doctor Restoration Design Preferences (DRDP) may, in some implementations, specify at least one typical value for an RDP, which may, in some instances, be derived from past cases which have been treated by one or more oral care practitioners. 3D oral care representations may include, but are not limited to: 1) a set of mesh element labels which may be applied to the 3D mesh elements of teeth/gums/hardware/appliance meshes (or point clouds) in the course of mesh segmentation or mesh cleanup; 2) 3D representation(s) for one or more teeth/gums/hardware/appliances for which shapes have been modified (e.g., trimmed, distorted, or filled-in) in the course of mesh segmentation or mesh cleanup; 3) one or more coordinate systems (e.g., describing one, two, three or more coordinate axes) for a single tooth or a group of teeth (such as a full arch—as with the LDE coordinate system); 4) 3D representation(s) for one or more teeth for which shapes have been modified or otherwise made suitable for use in dental restoration; 5) 3D representation(s) for one or more dental restoration appliance components; 6) one or more transforms to be applied to one or more of: dental restoration appliance library component placement relative to one or more teeth, a tooth to be placed for an orthodontic setup (either final setup or intermediate stage), a hardware element to be placed relative to one or more teeth or the like; 7) an orthodontic setup; 8) a 3D representation of a hardware element (such as facial bracket, lingual bracket, orthodontic attachment, button, hook, bite ramp, etc.) to be placed relative to one or more teeth, etc.; 8) a 3D representation of a bonding pad for a hardware element (which may be generated for a specific tooth by outlining a perimeter on the tooth, specifying a thickness to form a shell, and then subtracting-out the tooth via a Boolean operation); 9) 3D representation of a clear tray aligner (CTA); 10) the location or shape of a CTA trimline (e.g., described as either a mesh or polyline); 11) archform that describes the contours or layout of an arch of teeth (e.g., described as a 3D polyline or as a 3D mesh or surface), which may follow the incisal edges one or more teeth, which may follow the facial surfaces of one or more teeth, which may in some implementations correspond to the maloccluded arch and in other implementations correspond to the final setup arch (the effects of malocclusion on the shape of the archform may be diminished by smoothing or averaging of the shape of the archform), which may be described by one or more control points and/or a spline; 12) 3D representation of a fixture models (e.g., depictions of teeth and gums for use in thermoforming clear tray aligners, or depictions of teeth/gums/hardware for use in thermoforming indirect bonding trays); 13) one or more latent space vectors (or latent capsules) produced by the 3D encoder stage of a 3D autoencoder which has been trained on the reconstruction of oral care meshes (e.g., a variational autoencoder which has been trained for tooth reconstruction); 14) one or more oral care metrics values (e.g., such as orthodontic metrics or restoration design generation metrics) for one or more teeth; 15) one or more landmarks (e.g., 3D points) which describe the shapes and/or geometrical attributes of one or more teeth, other dentition structures or hardware structures (e.g., to be used in orthodontic setups creation or restoration appliance component generation or placement); 16) 3D representation created by scanning (e.g., optically scanning, CT scanning or MRI scanning) a 3D printed part corresponding to one or more teeth/gums/hardware/appliances (e.g., a scanned fixture model); 17) 3D printed aligners (including optionally local thickness, reinforcing rib geometry, flap positioning, or the like) 18) 3D representation of the patient's dentition that was captured chairside by a clinician or medical practitioner (e.g., in a context where the 3D representation is validated chairside, before the patient leaves the clinic, so that errors can be detected and re-scans performed as necessary); 19) dental restoration tooth design (e.g., for veneers, crowns, bridges or dental restoration appliances); 20) 3D representations of one or more teeth for use in digital oral care treatment; 21) other 3D printed parts pertaining to oral care procedures or other fields; 22) IPR cut surfaces; 23) one or more orthodontic setups transforms associated with one or more IPR cut surfaces; 24) a (digital) pontic tooth design which may fill at least a portion of the space between teeth to allow room in an orthodontic setup for an erupting tooth to later emerge from the gums; or 25) a component of a fixture model (e.g., comprising fixture model components such as interproximal webbing, block-out, bite locks, bite ramps, interproximal reinforcement, gingival ridges, torque points, power ridges, pontic tooth or dimples, among others).

The techniques of this disclosure may be advantageously combined. For example, the Setups Comparison tool may be used to compare the output of the GDL Setups model against ground truth data, compare the output of the RL Setups model against ground truth data, compare the output of the VAE Setups model against ground truth data and compare the output of the MLP Setups model against ground truth data. With each of these setups prediction models compared against ground truth data, it may be possible to determine which model gives the best performance on a certain dataset or within a given problem domain. Furthermore, the Metrics Visualization tool can enable a global view of the final setups and intermediate stages produced by one or more of the setups prediction models, with the advantage of enabling the selection of the best setups prediction model. The Metrics Visualization tool, furthermore, enables the computation of metrics which have a global scope over a set of intermediate stages. These global metrics may, in some implementations, be consumed as inputs to the neural networks for predicting setups (e.g., GDL Setups, RL Setups, VAE Setups, Capsule Setups, MLP Setups, Diffusion Setups, PT Setups, Similarity Setups, among others). The global metrics may also be provided to FDG Setups. The local metrics from this disclosure (i.e., a local metric is a metric which may be computed for one stage or setup of treatment, rather than over several stages or setups) may, in some implementations, be consumed by the neural networks herein for predicting setups, with the advantage of improving predictive results. The metrics described in this disclosure may, in some implementations, be visualized using the Metric Visualization tool.

The VAE and MAE models for mesh element labelling and mesh in-filling can be advantageously combined with the setups prediction neural networks, for the purpose of mesh cleanup ahead of or during the prediction process. In some implementations, the VAE for mesh element labelling may be used to flag mesh elements for further processing, such as metrics calculation, removal or modification. In some instances, such flagged mesh elements may be provided as inputs to a setups prediction neural network, to inform that neural network about important mesh features, attributes or geometries, with the advantage of improving the performance of the resulting setups prediction model. In some implementations, mesh in-filling may cause the geometry of a tooth to become more nearly complete, enabling the better functioning of a setups prediction model (i.e., improved correctness of prediction on account of better-formed geometry). In some instances, a neural network to classify a setup (i.e., the Setups Classifier) may aid in the functioning of a setups prediction neural network, because the setups classifier tells that setups prediction neural network when the predicted setup is acceptable for use and can be provided to a method for aligner tray generation. A Setups Classifier (e.g., GDL Setups, RL Setups, VAE Setups, Capsule Setups, MLP Setups, Diffusion Setups, PT Setups, Similarity Setups and FDG Setups, among others) may aid in the generation of final setups and also in the generation of intermediate stages. Furthermore, a Setups Classifier neural network may be combined with the Metrics Visualization tool. In other implementations, a Setups Classification neural network may be combined with the Setups Comparison tool (e.g., the Setup Comparison tool may output an indication of how a setup produced in part by the Setups Classifier compares to a setup produced by another setups prediction method). In some implementations, the VAE for mesh element labelling may identify one or more mesh elements for use in a metrics calculation. The resulting metrics outputs may be visualized by the Metrics Visualization tool.

In some examples, the Setups Classifier neural network may aid in the setups prediction technique described in U.S. Patent Application No. US20210259808A1 (which is incorporated herein by reference in its entirety) or the setups prediction technique described in PCT application with Publication No. WO2021245480A1 (which is incorporated herein by reference in its entirety) or in PCT Application No. PCT/IB2022/057373 (which is incorporated herein by reference in its entirety). The Setups Classifier would help one or more of those techniques to know when the predicted final setup is most nearly correct. In some instances, the Setups Classifier neural network may output an indication of how far away from final setup a given setup is (i.e., a progress indicator).

In some implementations, the latent space embedding vector(s) from the reconstruction VAE can be concatenated with the inputs to the setups prediction neural network described in WO2021245480A1. The latent space vectors can also be incorporated as inputs to the other setups prediction models: GDL Setups, RL Setups, VAE Setups, Capsule Setups, MLP Setups and Diffusion Setups, among others. The advantage is to impart the reconstruction characteristics (e.g., latent vector dimensions of a tooth mesh) to that neural network, hence improving the generated setups prediction.

In some examples, the various setups prediction neural networks of this disclosure may work together to produce the setups required for orthodontic treatment. For example, the GDL Setups model may produce a final setup, and the RL Setups model may use that final setup as input to produce a series of intermediate stages setups. Alternatively, the VAE Setups model (or the MLP Setups model) may create a final setup which may be used by an RL Setups model to produce a series of intermediate stages setups. In some implementations, a setup prediction may be produced by one setups prediction neural network, and then taken as input to another setups prediction neural network for further improvements and adjustments to be made. In some implementations, such improvements may be performed in iterative fashion.

In some implementations, a setups validation model, such as the model disclosed in US Provisional Application No. U.S. 63/366,495, may be involved in this iterative setups prediction loop. First a setup may be generated (e.g., using a model trained for setups prediction, such as GDL Setups, RL Setups, VAE Setups, Capsule Setups, MLP Setups, Diffusion Setups, PT Setups, Similarity Setups and FDG Setups, among others), then the setup undergoes validation. If the setup passes validation, the setup may be outputted for use. If the setup fails validation, the setup may be sent back to one or more of the setups prediction models for corrections, improvements and/or adjustments. In some instances, the setups validation model may output an indication of what is wrong with the setup, enabling the setups generation model to make an improved version upon the next iteration. The process iterates until done.

Generally speaking, in some implementations, two or more of the following techniques of the present disclosure may be combined in the course of orthodontic and/or dental treatment: GDL Setups, Setups Classification, Reinforcement Learning (RL) Setups, Setups Comparison, Autoencoder Setups (VAE Setups or Capsule Setups), VAE Mesh Element Labeling, Masked Autoencoder (MAE) Mesh In-filling, Multi-Layer Perceptron (MLP) Setups, Metrics Visualization, Imputation of Missing Oral Care Parameters Values, Tooth Classification Using Latent Vector, FDG Setups, Pose Transfer Setups, Restoration Design Metrics Calculation, Neural Network Techniques for Dental Restoration and/or Orthodontics (e.g., 3D Oral Care Representation Generation or Modification Using Transformers), Landmark-based (LB) Setups, Diffusion Setups, Imputation of Tooth Movement Procedures, Capsule Autoencoder Segmentation, Diffusion Segmentation, Similarity Setups, Validation of Oral Care Representations (e.g., using autoencoders), Coordinate System Prediction, Restoration Design Generation, or 3D Oral Care Representation Generation or Modification Using Denoising Diffusion Models.

Oral care parameters may include one or more values that specify procedure parameters, or which otherwise pertain to orthodontic treatment. Oral care parameters may additionally or alternatively include one or more values that specify restoration design parameters, or which otherwise pertain to digital dentistry or digital oral care.

Other types of oral care parameters that may be used include doctor preferences (which are used in orthodontic treatment). Still another kind of oral care parameters is called doctor restoration preferences and pertains to digital dentistry. For example, one clinician may prefer one value for a restoration design parameter (RDP), while another clinician may prefer a different value for that RDP, when faced with a similar diagnosis or treatment protocol. One example of such an RDP is dental restoration style. Procedure parameters and/or doctor preferences may, in some implementations, be provided to a setups prediction model for orthodontic treatment, for the purpose of improving the customization of the resulting orthodontic appliance. Restoration design parameters and doctor restoration preferences may in some implementations be used to design tooth geometry for use in the creation of a dental restoration appliance, for the purpose of improving the customization of that appliance. In addition to oral care parameters, doctor preferences, and doctor restoration preferences, some implementations of ML prediction models of this disclosure, in orthodontic treatment, may also take as input a setup (e.g., an arrangement of teeth). In some such implementations, an ML prediction model of this disclosure may take as input a final setup (i.e., final arrangement of teeth), such as in the case of a prediction model trained to generate intermediate stages. For simplicity, these preferences are referred to as doctor restoration preferences, but it is intended to be used in a non-limiting sense. Specifically, it should be appreciated that these preferences may be specified by any treating or otherwise appropriate medical professional and are not intended to be limited to doctor preferences per se (i.e., preferences from someone in possession of an M.D. or equivalent degree).

An oral care professional or clinician, such as a dentist or orthodontist, may specify information about patient treatment in the form of a patient-specific set of procedure parameters. In some instances, an oral care professional may specify a set of general preferences (aka doctor preferences) for use over a broad range of cases, to use as default values in the set of procedure parameters specification process. Oral care parameters may in some implementations be incorporated into the techniques described in this disclosure, such as one or more of GDL Setups, VAE Setups, RL Setups, Setups Comparison, Setups Classification, VAE Mesh Element Labelling, MAE Mesh In-Filling, Validation Using Autoencoders, Imputation of Missing Procedure Parameters Values, Metrics Visualization, or FDG Setups. One or more of these models may take as input one or more procedure parameters vector K and/or one or more doctor preference vectors L. In some implementations, one or more of these models may introduce to one or more of a neural network's hidden layers one or more procedure parameters vector K and/or one or more doctor preferences vectors L. In some implementations, one or more of these models may introduce either or both of K and L to a mathematical calculation, such as a force calculation, for the purpose of improving that calculation and the ultimate customization of the resulting appliance to the patient.

Some implementations of a neural network for predicting a setup (such as GDL Setup, VAE Setup or RL Setup) may incorporate information from an oral care professional (aka doctor). This information may influence the arrangement of teeth in the final setup, bringing the positions and orientations of the teeth into conformance with a specification set by the doctor, within tolerances. In some implementations of the GDL Setup model, oral care parameters may be provided directly into the generator network as a separate input alongside the mesh data. In some implementations of GDL Setups, oral care parameters may be incorporated into the feature vector which is computed for each mesh element before the mesh elements are input to the generator for processing. Some implementations of a VAE Setup model may incorporate oral care parameters into the setups predictions. In some implementations, the procedure parameters K and/or the doctor preference information L may be concatenated with the latent space vector C. A doctor's preferences (e.g., in an orthodontic context) and/or doctor's restoration preferences may be indicated in a treatment form, or they could be based upon characteristics in treatment plans such as final setup characteristics (e.g., amount of bite correction or midline correction in planned final setups), intermediate staging characteristics (e.g., treatment duration, tooth movement protocols, or overcorrection strategies), or outcomes (e.g., number of revisions/refinements).

Orthodontic procedure parameters may specify one or more of the following (with possible values shown in { }). Non-limiting categorical values for some example OPP are described below. In some implementations, a real value may be specified for one or more of these OPP. For example, the Overbite OPP may specify a quantity of overbite (e.g., in millimeters) which is desired in a setup, and may be received as input of a setups prediction model to provide that setups prediction model information about the amount of overbite which is desired in the setup. Some implementations may specify a numerical value for the Overjet OPP, or other OPP. In some implementations, one or more OPP may be defined which correspond to one or more orthodontic metrics (OM). In some instances, a numerical value may be specified for such an OPP, for the purpose of controlling the output of a setups prediction model.
Teeth To Move: {AnteriorsOnly, AnteriorsAndBicuspids, FullArch}
Tooth Movement Restrictions: for each tooth, indicate if tooth is {DoNotMove, Missing, ToBeExtracted, Primary/Erupting, Clear}
Overbite: {ShowResultingOverbiteAfterAlignment, MaintainInitialOverbite, CorrectOpenBite, CorrectDeepBite}
Overjet: {ShowResultingOverjetAfterAlignment, MaintainInitialOverjet, ImproveResultingOverjet}
Anterior/Posterior (AP) Relationship
   Maintain: {Right, Left, Both}
   Improve canine relationship only: {Right, Left, Both}
   Improve canine and/or molar relationship up to 4 mm: {Right, Left, Both}
   Correct to Class I (canine and molar): {Right, Left, Both}
Crossbite (if present)
   Anterior: {DoNotCorrect, Correct, N/A}
   Posterior: {DoNotCorrect, Correct, N/A}
Correction to Class I (canine and molar): {Right, Left, Both}
   Correct with Posterior IPR: {yes, no}
      Class II/III correction simulation (elastics required): {yes, no}
      Sequential Distalization (elastic recommended): {yes, no}
      Include cuts for elastics?: {yes, no}
      Preferred cuts for elastics: {UseButtonCutoutsOnMolarsAndHooksOnCanines, UseButtonCutoutsOnly, UseHooksOnly}
      Stage to start cuts for elastics: [integer]
LevelingOfUpperAnteriors: {Laterals0.5mmShorterThanCentral, LevelIncisalEdges, LevelGingivalMargins, AsIndicated}
Spacing: {CloseAllSpaces, LeaveSpecificSpaces}
Preferred Midline Position: {SetTheUpperMidlineToIdeal, MatchTheUpperAndLowerToEachOther}
Resolve Upper Crowding by Expand: {Primarily, AsNeeded, None}
Resolve Upper Crowding by Procline: {Primarily, AsNeeded, None}
Resolve Upper Crowding by IPR—Anterior: {Primarily, AsNeeded, None}
Resolve Upper Crowding by IPR—Posterior Right: {Primarily, AsNeeded, None}
Resolve Upper Crowding by IPR—Posterior Left: {Primarily, AsNeeded, None}
Resolve Lower Crowding by Expand: {Primarily, AsNeeded, None}
Resolve Lower Crowding by Procline: {Primarily, AsNeeded, None}
Resolve Lower Crowding by IPR—Anterior: {Primarily, AsNeeded, None}
Resolve Lower Crowding by IPR—Posterior Right: {Primarily, AsNeeded, None}
Resolve Lower Crowding by IPR—Posterior Left: {Primarily, AsNeeded, None}
Finishing Arch Form: {Patient'sNatural, AsIndicated}
   [doctor can specify an archform—selected from a set of options or custom-designed]

Other orthodontic procedure parameters may be defined, such as those which may be used to place standardized brackets at prescribed occlusal heights on the teeth. In some implementations, one or more orthodontic procedure parameters may be defined to specify at least one of the 2^{nd} and 3^{rd} order rotation angles to be applied to a tooth (i.e., angulation and torque, respectively), which may enable a target setup arrangement where crown landmarks lie within a threshold distance of a common occlusal plane, for example. In some implementations, one or more orthodontic procedure parameters may be defined to specify the position in global coordinates where at least one landmark (e.g., a centroid) of a tooth crown (or root) is to be placed in a setup arrangement of teeth. Generally, an oral care parameter may be defined which corresponds to an oral care metric. For example, an orthodontic procedure parameter may be defined which corresponds to an orthodontic metric (e.g., to specify at the input of a setups prediction model an amount of a certain metric which is desired to appear in a predicted setup).

Doctor preferences may differ from orthodontic procedure parameters in that doctor preferences pertain to an oral care provider and may comprise of the means, modes, medians, minimums, or maximums (or some other statistic) of past settings associated with an oral care provider's treatment decisions on past orthodontic cases. Procedure parameters, on the other hand, may pertain to a specific patient, and describe the needs of a particular patient's treatment. Doctor preferences may pertain to a doctor and the doctor's past treatment practices, whereas procedure parameters may pertain to the treatment of a particular patient. Doctor preferences (or “treatment preferences”) may specify one or more of the following (with possible values shown in { }).

Orthodontic doctor preferences may specify one or more of the following (with other possible values found elsewhere in this disclosure).
Deep Bite Cases (Amount of Bite Correction)—Final Overbite: [real value in millimeters, e.g., 0.5 mm]
   Option—Intrude Upper Anteriors: {yes, no}
   Option—Include lower canines in vertical overcorrection: {yes, no}
Midline Correction in Planned Final Setup: {MaintainInitialMidline, ImproveMidline WithIPR, AsIndicated}
Deep Bite Cases—Reverse Curve of Speed: {yes, no}
Anterior Open Bite Cases-Final Overbite: [real value in millimeters, e.g., 2 mm]
Is Arch Expansion a Priority for Your Cases?: {Yes, No}
   If yes, specify acceptable expansion per quadrant in mm.
   When expanding upper molars, apply buccal root torque: {yes, no}
Is IPR Acceptable of First Tx Design: {yes, no}
Maximum IPR per contact:
   Upper Anterior: [specify in mm]
   Lower Anterior: [specify in mm]
   Upper and Lower Anterior: [specify in mm]
Is Asymmetric IPR Acceptable?: {yes, no}
Final Tooth Position (Overcorrection Strategy): {Ideal, Overcorrected}
Root Movement: {MoveRootsAsNeededToAchieveTreatmentGoals, LimitPosteriorRootMovement, LimitAllRootMovement}
Final Occlusal Contacts: {AllContactsBalancedWhenPossible, NoOcclusalContactOnUpperIncisors, Finish WithHeavyPosteriorContacts, Other}
Is Asymmetric AP Shift Acceptable for Class Correction?: {yes, no, other}
Treatment Duration: [count of stages]
Tooth Movement Protocol: {protocol_A, protocol_B, protocol_C}

Existing techniques have attempted to move the teeth towards an archform V after a setup prediction has already been rendered by other workflow components, which introduces error to the resulting setup and diminishes performance in view of the purpose of the workflow components which made the setups prediction. The present disclosure provides several improvements over these existing techniques by enabling archform information to be introduced directly into the setups prediction neural network as an input to that neural network, with the technical improvement of providing setups predictions that more accurately meets the orthodontic treatment needs of the patient (thereby improving data precision). Archform information V may be provided as an input to any of the GDL Setups, RL Setups, VAE Setups, Capsule Setups, MLP Setups and Diffusion Setups prediction neural networks. In some implementations, archform information V may be provided directly to one or more internal neural network layers in one or more of those setups applications.

The additional procedure parameters may include text descriptions of the patient's medical condition and of the intended treatment. Such text descriptions may be analyzed via natural language processing operations, including tokenization, stop word removal, stemming, n-gram formation, text data vectorization, bag of words analysis, term frequency inverse document frequency (TF-IDF) analysis, sentiment analysis, naive Bayes classification, and/or logistic regression classification. The outputs of such analysis techniques may be used as input to one or more of the neural networks of this disclosure with the advantage of customizing and improving the predicted outputs (e.g., the predicted setups or predicted mesh geometries).

These additional orthodontic parameters and doctor preferences may also be incorporated into the neural networks of this disclosure, with the data precision and efficiency-related advantages of improving the customization of those neural networks and enabling those neural networks to predict output examples which better match the treatment needs of the individual patient.

In some implementations, a dataset used for training one or more of the neural network models of this disclosure may be filtered conditionally on one or more of the orthodontic procedure parameters described in this section. In some instances, patient cases which exhibit outlier values for one or more of these procedure parameters may be omitted from a dataset (alternatively used to form a dataset) for training one or more of the neural networks of this disclosure.

One or more procedure parameters and/or doctor preferences may be provided to a neural network during training. In this manner the neural network may be conditioned on the one or more procedure parameters and/or doctor preferences. Examples of such neural networks include a conditional generative adversarial network (cGAN) and/or a conditional variational autoencoder (cVAE), either of which may be used for the various neural network-based applications of this disclosure.

In some instances, tooth shape-based inputs may be provided to a neural network for setups predictions. In other instances, non-shape-based inputs can be used, such as a tooth name or designation, as it pertains to dental notation. In some implementations, a vector R of flags may be provided to the neural network, where a ‘1’ value indicates that the tooth is present and a ‘0’ value indicates that the tooth is absent from the patient case (though other values are possible). The vector R may comprise a 1-hot vector, where each element in the vector corresponds to a tooth type, name or designation. Identifying information about a tooth (e.g., the tooth's name) can be provided to the predictive neural networks of this disclosure, with the advantage of enabling the neural network to become trained to handle different teeth in tooth-specific ways. For example, the setups prediction model may learn to make setups transformations predictions for a specific tooth designation (e.g., upper right central incisor, or lower left cuspid, etc.). In the case of the mesh cleanup autoencoders (either for labelling mesh element or for in-filling missing mesh data), the autoencoder may be trained to provide specialized treatment to a tooth according to that tooth's designation, in this manner. In the case of a setups classification neural network, a listing of tooth name(s) present in the patient's arch may better enable the neural network to output an accurate determination of setup classification, because tooth designation is a valuable input to training such a neural network. Tooth designation/name may be defined, for example, according to the Universal Numbering System, Palmer System, or the FDI World Dental Federation notation (ISO 3950).

In one example, where all except the (up to four) wisdom teeth are present in the case, a vector R may be defined as an optional input to the setups prediction neural networks of this disclosure, where there is a 0 in the vector element corresponding to each of the wisdom teeth, and a 1 in the elements corresponding to the following teeth: UR7, UR6, UR5, UR4, UR3, UR2, UR1, UL1, UL2, UL3, UL4, UL5, UL6, UL7, LL7, LL6, LL5, LL4, LL3, LL2, LL1, LR1, LR2, LR3, LR4, LR5, LR6, LR7

In some instances, the position of the tooth tip may be provided to a neural network for setups predictions. In other instances, one or more vectors S of the orthodontic metrics described elsewhere in this disclosure may be provided to a neural network for setups predictions. The advantage is an improved capacity for the network to become trained to understand the state of a maloccluded setup and therefore be able to predict a more accurate final setup or intermediate stage.

In some implementations, the neural networks may take as input one or more indications of interproximal reduction (IPR) U, which may indicate the amount of enamel that is to be removed from a tooth during the course orthodontic treatment (either mesially or distally). In some implementations, IPR information (e.g., quantity of IPR that is to be performed on one or more teeth, as measured in millimeters, or one or more binary flags to indicate whether or not IPR is to be performed on each tooth identified by flagging) may be concatenated with a latent vector A which is produced by a VAE or a latent capsule T autoencoder. The vector(s) and/or capsule(s) resulting from such a concatenation may be provided to one or more of the neural networks of the present disclosure, with the technical improvement or added advantage of enabling that predictive neural network to account for IPR. IPR is especially relevant to setups prediction methods, which may determine the positions and poses of teeth at the end of treatment or during one or more stages during treatment. It is important to account for the amount of enamel that is to be removed ahead of predicted tooth movements.

In some implementations, one or more procedure parameters K and/or doctor preferences vectors L may be introduced to a setups prediction model. In some implementations, one or more optional vectors or values of tooth position N (e.g., XYZ coordinates, in either tooth local or global coordinates), tooth orientation O (e.g., pose, such as in transformation matrices or quaternions, Euler angles or other forms described herein), dimensions of teeth P (e.g., length, width, height, circumference, diameter, diagonal measure, volume—any of which dimensions may be normalized in comparison to another tooth or teeth), distance between adjacent teeth Q. These “dimensions of teeth P” may in some instances be used to describe the intended dimensions of a tooth for dental restoration design generation.

In some implementations, tooth dimensions P such as length, width, height, or circumference may be measured inside a plane, such as the plane that intersects the centroid of the tooth, or the plane that intersects a center point that is located midway between the centroid and either the incisal-most extent or the gingival-most extent of the tooth. The tooth dimension of height may be measured as the distance from gums to incisal edge. The tooth dimension of width may be measured as the distance from the mesial extent to the distal extent of the tooth. In some implementations, the circularity or roundness of the tooth cross-section may be measured and included in the vector P. Circularity or roundness may be defined as the ratio of the radii of inscribed and circumscribed circles.

The distance Q between adjacent teeth can be implemented in different ways (and computed using different distance definitions, such as Euclidean or geodesic). In some implementations, a distance Q1 may be measured as an averaged distance between the mesh elements of two adjacent teeth. In some implementations, a distance Q2 may be measured as the distance between the centers or centroids of two adjacent teeth. In some implementations, a distance Q3 may be measured between the mesh elements of closest approach between two adjacent teeth. In some implementations, a distance Q4 may be measured between the cusp tips of two adjacent teeth. Teeth may, in some implementations, be considered adjacent within an arch. Teeth may, in some implementations, also be considered adjacent between opposing arches. In some implementations, any of Q1, Q2, Q3 and Q4 may be divided by a term for the purpose of normalizing the resulting value of Q. In some implementations, the normalizing term may involve one or more of: the volume of a tooth, the count of mesh elements in a tooth, the surface area of a tooth, the cross-sectional area of a tooth (e.g., as projected into the XY plane), or some other term related to tooth size.

Other information about the patient's dentition or treatment needs (or related parameters) may be concatenated with the other input vectors to one or more of MLP, GAN, generator, encoder structure, decoder structure, transformer, VAE, conditional VAE, regularized VAE, 3D U-Net, capsule autoencoder, diffusion model, and/or any of the neural networks models listed elsewhere in this disclosure.

The vector M may contain flags which apply to one or more teeth. In some implementations, M contains at least one flag for each tooth to indicate whether the tooth is pinned. In some implementations, M contains at least one flag for each tooth to indicate whether the tooth is fixed. In some implementations, M contains at least one flag for each tooth to indicate whether the tooth is pontic. M may also contain at least one flag for each tooth to indicate whether the tooth is either extracted or implanted. Other and additional flags are possible for teeth, as are combinations of fixed, pinned and pontic flags. A flag that is set to a value that indicates that a tooth should be fixed is a signal to the network that the tooth should not move over the course of treatment. In some implementations, the neural network loss function may be designed to be penalized for any movement in the indicated teeth (and in some particular cases, may be heavily penalized). A flag to indicate that a tooth is pontic informs the network that the tooth gap is to be maintained, although that gap is allowed to move. In some cases, M may contain a flag indicating that a tooth is missing. In some implementations, the presence of one or more fixed teeth in an arch may aid in setups prediction, because the one or more fixed teeth may provide an anchor for the poses of the other teeth in the arch (i.e., may provide a fixed reference for the pose transformations of one or more of the other teeth in the arch). In some implementations, one or more teeth may be intentionally fixed, so as to provide an anchor against which the other teeth may be positioned. In some implementations, a 3D representation (such as a mesh) which corresponds to the gums may be introduced, to provide a reference point against which teeth can be moved.

Without the loss of generality, one or more of the optional input vectors K, L, M, N, O, P, Q, R, S, U and V described elsewhere in this disclosure may also be provided to the input or into an intermediate layer of one or more of the predictive models of this disclosure. In particular, these optional vectors may be provided to the MLP Setups, GDL Setups, RL Setups, VAE Setups, Capsule Setups and/or Diffusion Setups, with the advantage of enabling the respective model to generate setups which better meet the orthodontic treatment needs of the patient. In some implementations, such inputs may be introduced, for example, by being concatenated with one or more latent vectors A which are also provided to one or more of the predictive models of this disclosure. In some implementations, such inputs may be introduced, for example, by being concatenated with one or more latent capsules T which are also provided to one or more of the predictive models of this disclosure.

In some implementations, one or more of K, L, M, N, O, P, Q, R, S, U and V may be introduced to the neural network (e.g., MLP or Transformer) directly in a hidden layer of the network. In some instances, one or more of K, L, M, N, O, P, Q, R, S, U and V may be introduced directly into the internal processing of an encoder structure.

In some implementations, a setups prediction model (such as GDL Setups, RL Setups, VAE Setups, Capsule Setups, MLP Setups, PT Setups, Similarity Setups and Diffusion Setups) may take as input one or more latent vectors A which correspond to one or more input oral care meshes (e.g., such as tooth meshes). In some implementations, a setups prediction model (such as GDL Setups, RL Setups, VAE Setups, Capsule Setups, MLP Setups and Diffusion Setups) may take as input one or more latent capsules T which correspond to one or more input oral care meshes (e.g., such as tooth meshes). In some implementations, a setups prediction method may take as input both of A and T.

Some implementations of the setups prediction neural networks (e.g., GDL Setups, RL Setups, VAE Setups, Capsule Setups, MLP Setups, Diffusion Setups, PT Setups, Similarity Setups, or FDG Setup, or other setups prediction network architectures) of this disclosure may take additional inputs to aid in setups prediction. Some of these inputs may reflect the geometrical attributes of one or more teeth or of a whole arch. In some implementations, an archform or arch curve may be provided to a setups prediction neural network, with the technical improvement of aiding that setups prediction neural network in finding a suitable set of final setups poses for the teeth in a patient case (with the technical improvements being directed to both resource footprint reduction by way of more efficient location capabilities and/or data precision in the form of locating a more pertinent final setup). The archform or arch curve may be encoded as a spline, a B-spline, NonUniform Rational B-Splines (NURBS), polynomial spline, non-polynomial spline, parabolic curve, hyperbolic curve or other parameterized curve. Such a curve may be computed as an average of multiple exemplars, such as exemplary final setups. Another non-limiting example of an archform is a Beta curve. In the case of the Setups VAE, the arch information may be provided to the encoder E2, as an additional input alongside E and D. In the case of the GDL Setups neural network, the arch information may be provided to the generator as an additional input to the mesh element lists and associated mesh element feature vectors. In some implementations, an archform may be described by one or more 3D representations, such as a 3D mesh, a set of 3D control points and/or as a 3D polyline. In some implementations, a Frenet frame may be overlaid onto an archform. The Frenet frame may locally describe the coordinate system corresponding to each point along the archform. Such a coordinate system may, in some implementations, be right-handed (or alternatively, in other implementations, left-handed). Such a coordinate system may, in some implementations, be determined, at least in part, by at least one of the tangent to the archform at the point and the archform's curvature. In some implementations, a point may be described using an LDE coordinate frame relative to an archform, where L, D and E correspond to: 1) Length along the curve of the archform, 2) Distance away from the archform, and 3) Distance in the direction perpendicular to the L and D axes (which may be termed Eminence), respectively. Other geometrical inputs may also aid in the training of a setups prediction neural network. In some implementations, the case classification information (e.g., class 1, class 2 or class 3), information about AP Shift or information about IPR may be received as input to the setups prediction model. Some definitions of case classifications may describe the relationship between the cusp tip of an upper arch canine and one or more teeth of the lower arch. For example, a class 1 case may contain a cusp tip of an upper canine that occludes between the corresponding lower canine and the first premolar. A class 2 case may contain a cusp tip of an upper canine that occludes in front of the embrasure between corresponding lower canine and the first premolar. A class 3 case may contain a cusp tip of an upper canine that occludes behind the embrasure between lower canine and first premolar.

Various loss calculation techniques are generally applicable to the techniques of this disclosure (e.g., GDL Setups, RL Setups, VAE Setups, Capsule Setups, MLP Setups, Diffusion Setups, PT Setups, Similarity Setups, Setups Classification, Tooth Classification, VAE Mesh Element Labelling, MAE Mesh In-Filling and the imputation of procedure parameters).

These losses include L1 loss, L2 loss, mean squared error (MSE) loss, cross entropy loss, among others. Losses may be computed and used in the training of neural networks, such as multi-layer perceptron's (MLP), U-Net structures, generators and discriminators (e.g., for GANs), autoencoders, variational autoencoders, regularized autoencoders, masked autoencoders, transformer structures, or the like. Some implementations may use either triplet loss or contrastive loss, for example, in the learning of sequences.

Losses may also be used to train encoder structures and decoder structures. A KL-Divergence loss may be used, at least in part, to train one or more of the neural networks of the present disclosure, such as a mesh reconstruction autoencoder or the generator of GDL Setups, which the advantage of imparting Gaussian behavior to the optimization space. This Gaussian behavior may enable a reconstruction autoencoder to produce a better reconstruction (e.g., when a latent vector representation is modified and that modified latent vector is reconstructed using a decoder, the resulting reconstruction is more likely to be a valid instance of the provided representation). There are other techniques for computing losses which may be described elsewhere in this disclosure. Such losses may be based on quantifying the difference between two or more 3D representations.

MSE loss calculation may involve the calculation of an average squared distance between two sets, vectors or datasets. MSE may be generally minimized. MSE may be applicable to a regression problem, where the prediction generated by the neural network or other machine learning model may be a real number. In some implementations, a neural network may be equipped with one or more linear activation units on the output to generate an MSE prediction. Mean absolute error (MAE) loss and mean absolute percentage error (MAPE) loss can also be used in accordance with the techniques of this disclosure.

Cross entropy may, in some implementations, be used to quantify the difference between two or more distributions. Cross entropy loss may, in some implementations, be used to train the neural networks of the present disclosure. Cross entropy loss may, in some implementations, involve comparing a predicted probability to a ground truth probability. Other names of cross entropy loss include “logarithmic loss,” “logistic loss,” and “log loss”. A small cross entropy loss may indicate a better (e.g., more accurate) model. Cross entropy loss may be logarithmic. Cross entropy loss may, in some implementations, be applied to binary classification problems. In some implementations, a neural network may be equipped with a sigmoid activation unit at the output to generate a probability prediction. In the case of multi-class classifications, cross entropy may also be used. In such a case, a neural network trained to make multi-class predictions may, in some implementations, be equipped with one or more softmax activation functions at the output (e.g., where there is one output node for class that is to be predicted). Other loss calculation techniques which may be applied in the training of the neural networks of this disclosure include one or more of: Huber loss, Hinge loss, Categorical hinge loss, cosine similarity, Poisson loss, Logcosh loss, or mean squared logarithmic error loss (MSLE). Other loss calculation methods are described herein and may be applied to the training of any of the neural networks described in the present disclosure.

One or more of the neural networks of the present disclosure may, in some implementations, be trained, at least in part by a loss which is based on at least one of: a Point-wise Mesh Euclidean Distance (PMD) and an Earth Mover's Distance (EMD). Some implementations may incorporate a Hausdorff Distance (HD) calculation into the loss calculation. Computing the Hausdorff distance between two or more 3D representations (such as 3D meshes) may provide one or more technical improvements, in that the HD not only accounts for the distances between two meshes, but also accounts for the way that those meshes are oriented, and the relationship between the mesh shapes in those orientations (or positions or poses). Hausdorff distance may improve the comparison of two or more tooth meshes, such as two or more instances of a tooth mesh which are in different poses (e.g., such as the comparison of predicted setup to ground truth setup which may be performed in the course of computing a loss value for training a setups prediction neural network).

Reconstruction loss may compare a predicted output to a ground truth (or reference) output. Systems of this disclosure may compute reconstruction loss as a combination of L1 loss and MSE loss, as shown in the following line of pseudocode: reconstruction_loss=0.5*L1 (all_points_target,all_points_predicted)+0.5*MSE (all_points_target,all_points_predicted). In the above example, all_points_target is a 3D representation (e.g., a 3D mesh or point cloud) corresponding to ground truth data (e.g., a ground truth tooth restoration design, or a ground truth example of some other 3D oral care representation). In the above example, all_points_predicted is a 3D representation (e.g., a 3D mesh or point cloud) corresponding to generated or predicted data (e.g., a generated tooth restoration design, or a generated example of some other kind of 3D oral care representation). Other implementations of reconstruction loss may additionally (or alternatively) involve L2 loss, mean absolute error (MAE) loss or Huber loss terms.

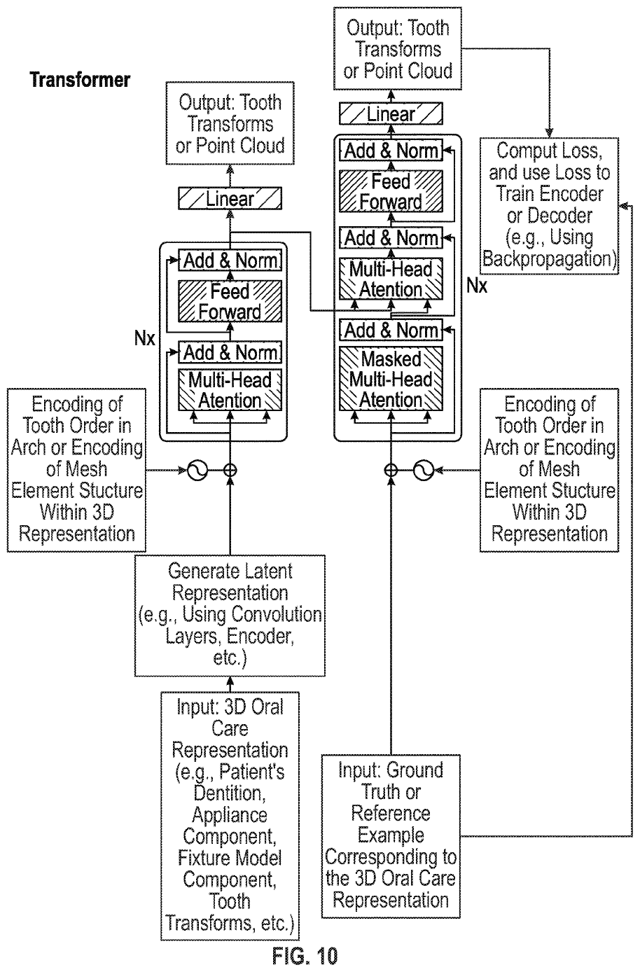

The entirety of the following paper is incorporated herein by reference in its entirety: “Attention Is All You Need”; Ashish Vaswani, Noam Shazeer, Niki Parmar, Niki Parmar, Llion Jones, Aidan N. Gomez, Łukasz Kaiser, Illia Polosukhin; NIPS 2017. The neural network-based models of this disclosure may provide additional advantages in implementations in which they are integrated with a neural network structure referred to as a “transformer.” FIG. 10 shows an example implementation of a transformer architecture.

Before recently developed models such as the transformer model, RNN-type models represented the state of the art for natural language processing (NLP). One example application of NLP is the generation of new text based upon prior words or text. Transformers have in turn provided significant improvements over GRU, LSTM and other such RNN-based NLP techniques due to an important attribute of the transformer model, which has the property of multi-headed attention. In some implementations, the NLP concept of multi-headed attention may describe the relationship between each word in a sentence (or paragraph or document or corpus of documents) and each other word in that sentence (or paragraph or document or corpus of documents). These relationships may be generated by a multiheaded attention module, and may be encoded in vector form. This vector may describe how each word in a sentence (or paragraph or document or corpus of documents) should attend to each other word in that sentence (or paragraph or document or corpus of documents). RNN, LSTM and GRU models process a sequence, such a sentence, one word at a time from the start to the end of the sequence. Furthermore, the model may only account for a given subset (called a window) of the sentence when making a prediction. However, transformer-based models may, in some instances, account for the entirety of the preceding text by processing the sequence in its entirety in a single step. Transformer, RNN, LSTM, and GRU models can all be adapted for use in predictive models in digital dentistry and digital orthodontics, particularly for the setup prediction task. In some implementations, an exemplary transformer model for use with 3D meshes and 3D transforms in setups prediction (or other oral care techniques) may be adapted from the Bidirectional Encoder Representation from Transformers (BERT) and/or Generative Pre-Training (GPT) models. For example, a GPT (or BERT) model may first be trained on other data, such as text or documents data, and then be used in transfer learning. Such a transfer learning process may receive a previously trained GPT or BERT model, and then do further training using data comprising 3D oral care representations. Such transfer learning may be performed to train oral care models such as: segmentation, mesh cleanup, coordinate system prediction, setups prediction, validation of 3D oral care representations, transform prediction for placement of oral care meshes (e.g., teeth, hardware, appliance components, fixture model components), tooth restoration design generation (or generation of other 3D oral care representations-such as appliance components, fixture models or archforms), classification of 3D oral care representations, imputation of missing oral care parameters, clustering of clinicians or clustering of clinician preferences, or the like.

Oral care data may comprise one or more of (or combinations of): 3D representations of tooth (e.g., meshes, point clouds or voxels), sections of tooth meshes (such as subsets of mesh elements), tooth transforms (such as in matrix, vector and/or quaternion form, or combinations thereof), transforms for appliance components, transforms for fixture model components, and mesh coordinate system definitions (such as represented by transforms, for example, transformation matrices) and/or other 3D oral care representations described herein.

Transformers may be trained for generating transforms to position teeth into setups poses (or to place appliance components for use in appliance generation or to place fixture model components for use in fixture model generation). Some implementations may operate in an offline prediction context, and some implementations operation in an online reinforcement learning (RL) context. In some implementations, a transformer may be initially trained in an offline context and then undergo further fine-tuning training in the online context. In the offline prediction context, the transformer may be trained from a dataset of cohort patient case data. In the online RL context, the transformer may be trained from either a physics model, or a CAD model, for example. The transformer may learn from static data, such as transformations (e.g., trajectory transformer). In some implementations, the transform may provide a mapping from malocclusion to setup (e.g., receiving transformation matrices as input and generating transformation matrices as ouput). Some implementations of transformers may be trained to process 3D representations, such as 3D meshes, 3D point clouds or voxels (e.g., using a decision transformer) takes as input geometry (e.g., mesh, point cloud, voxels etc.), outputs transformations. The decision transformer may be coupled with a representation generation module that encodes representation of the patient's dentition (e.g., teeth), such as a VAE, a U-Net, an encoder, a transformer encoder, a pyramid encoder-decoder or a simple dense or fully connected network, or a combination thereof. In some implementations, the representation generation module (e.g., VAE, the U-Net, the encoder, the pyramid encoder-decoder or the dense network for generating the tooth representation) may be trained to generate the representation on one or more teeth. The representation generation module may be trained on all teeth in both arches, only the teeth within the same arch (either upper or lower), only anterior teeth, only posterior teeth, or some other subset of teeth. In some implementations, such a model may be trained on each individual tooth (e.g., an upper right cuspid), so that the model is trained or otherwise configured to generate highly accurate representations for an individual tooth. In some implementations, an encoder structure may encode such a representation. In some implementations, a decision transformer may learn in an online context, in an offline context or both. An online decision transformer may be trained (e.g., using RL techniques) to output action, state, and/or reward. In some implementations, transformations may be discretized, to allow for piecewise or stepwise actions.

In some implementations, a transformer may be trained to process an embedding of the arch (i.e., to predict transforms for multiple teeth concurrently), to predict a setup. In some implementations, embeddings of individual teeth may be concatenated into a sequence, and then input into the transformer. A VAE may be trained to perform this embedding operation, a U-Net may be trained to perform such an embedding, or a simple dense or fully connected network may be trained, or a combination thereof. In some implementations, the transformer-based techniques of this disclosure may predict an action for an individual tooth, or may predict actions for multiple teeth (e.g., predict transformations for each of multiple teeth).

A 3D mesh transformer may include a transformer encoder structure (which may encode oral care data), and may be followed by a transformer decoder structure. The 3D mesh transformer encoder may encode oral care data into a latent representation, which may be combined with attention information (e.g., to concatenate a vector of attention information to the latent representation). In some implementations, the attention information may help the decoder focus on the relevant oral care data during the decoding process (e.g., to focus on tooth order or mesh element connectivity), so that the transformer decoder can generate a useful output for the 3D mesh transformer (e.g., an output which may be used in the generation of an oral care appliance). Either or both of the transformer encoder or transformer decoder may generate a latent representation. The output of the transformer decoder (or transformer encoder) may be reconstructed using a decoder into, for example, one or more tooth transforms for a setup, one or more mesh element labels for segmentation, coordinate systems transforms for use in coordinate system generation, or one or more points of a point cloud or voxels or other mesh elements for another 3D representation). A transformer may include modules such as one or more of: multi-headed attention modules, feed forward modules, normalization modules, linear modules, and softmax modules, and convolution models for latent vector compression, and/or representation.

The encoder may be stacked one or more times, thereby further encoding the oral care data, and enabling different representations of the oral care data to be learned (e.g., different latent representations). These representations may be embedded with attention information (which may influence the decoder's focus to the relevant portions of the latent representation of the oral care data) and may be fed into the decoder in continuous form (e.g., as a concatenation of latent representations-such as latent vectors). In some implementations, the encoded output of the encoder (e.g., latent representations) may be used by downstream processing steps in the generation of oral care appliances. For example, the generated latent representation may be reconstructed into transforms (e.g., for the placement of teeth in setups, or the placement of appliance components or fixture model components), or may be reconstructed into 3D representations (e.g., 3D point clouds, 3D meshes or others disclosed herein). Stated another way, the latent representation which is generated by the transformer (e.g., containing continuously encoded attention information) may be provided to a decoder which has been configured to reconstruct the latent representation into the specific data structure which is required by a particular domain area. Continuously encoded attention information may include attention information which has undergone processing by multiple multi-headed attention modules within the transformer encoder or transformer decoder, to name one example. Furthermore, a loss may be computed for a particular domain using data from that domain. The loss calculation may train the transformer decoder to accurately reconstruct the latent representation into the output data structure pertaining to a particular domain.

For example, when the decoder generates a transform for an orthodontic setup, the decoder may be configured with outputs that describe, for example, the 16 real values which comprise a 4×4 transformation matrix (other data structures for describing transforms are possible). Stated a different way, the latent output generated by the transformer encoder (or transformer decoder) may be used to predict setups tooth transforms for one or more teeth, to place those teeth in setup positions (e.g., either final setups or intermediate stages). Such a transformer encoder (or transformer decoder) may be trained, at least in part using a reconstruction loss (or a representation loss, among others described herein) function, which may compare predicted transforms to ground truth (or reference) transforms.

In a further example, when the decoder generates a transform for a tooth coordinate system, the decoder may be configured with outputs that describe, for example, the 16 real values which comprise a 4×4 transformation matrix (other data structures for describing transforms are possible). Stated a different way, the latent output generated by the transformer encoder (or transformer decoder) may be used to predict local coordinate systems for one or more teeth. Such a transformer encoder (or transformer decoder) may be trained, at least in part using a representation loss (or a reconstruction loss, among others described herein) function, which may compare predicted coordinate systems to ground truth (or reference) coordinate systems.

In a further example, when the decoder generates a 3D point cloud (or other 3D representation—such as 3D mesh, voxelized representation, or the like), the decoder may be configured with outputs that describe, for example, one or more 3D points (e.g., comprising XYZ coordinates). Stated a different way, the latent output generated by the transformer encoder (or transformer decoder) may be used to predict mesh elements for a generated (or modified) 3D representation. Such a transformer encoder (or transformer decoder) may be trained, at least in part using a reconstruction loss (or an L1, L2 or MSE loss, among others described herein) function, which may compare predicted 3D representations to ground truth (or reference) 3D representations.

In a further example, when the decoder generates mesh element labels for 3D representation segmentation or 3D representation cleanup, the decoder may be configured with outputs that describe, for example, labels for one or more mesh elements. Stated a different way, the latent output generated by the transformer encoder (or transformer decoder) may be used to predict mesh element labels for mesh segmentation or mesh cleanup. Such a transformer encoder (or transformer decoder) may be trained, at least in part using a cross entropy loss (or others described herein) function, which may compare predicted mesh element labels to ground truth (or reference) mesh element labels.

Multi-headed attention and transformers may be advantageously applied to the setups-generation problem. Multi-headed attention is a module in a 3D transformer encoder network which computes the attention weights for the provided oral care data and produces an output vector with encoded information on how each example of oral care data should attend to each other oral care data in an arch. An attention weight is a quantification of the relationship between pairs of oral care data.

A 3D representation of oral care data (e.g., comprising voxels, a point cloud, or a 3D mesh composed of vertices, faces or edges) may be provided to the transformer. The 3D representation may describe the patient's dentition, a fixture model (or components of a fixture model), an appliance (or components of an appliance), or the like. In some implementations, a transformer decoder (or a transformer encoder) may be equipped with multi-head attention. Multi-headed attention may enable the transformer decoder (or transformer encoder) to attend to different portions of the 3D representation of oral care data. For example, multi-headed attention may enable the transformer to attend to mesh elements within local neighborhoods (or cliques), or to attend to global dependencies between mesh elements (or cliques). For example, multi-headed attention may enable a transformer for setups prediction (e.g., a setups prediction model which is based on a transformer) to generate a transform for a tooth, and to substantially concurrently attend to each of the other teeth in the arch while that transform is generated. Stated another way, the transform for each tooth may be generated in light of the poses of one or more other teeth in the arch, leading to a more accurate transform (e.g., a transform which conforms more closely to the ground truth or reference transform). In the example of 3D representation generation (e.g., the generation of a 3D point cloud), a transformer model may be trained to generate a tooth restoration design. Multi-headed attention may enable the transformer to attend to multiple portions of the tooth (or to the surfaces of the adjacent teeth) while the tooth undergoes the generative process. For example, the transformer for restoration design generation may generate the mesh elements for the incisal edge of an incisor while, at least substantially concurrently, attending to the mesh elements of the mesial, distal, facial or lingual surfaces of the incisor. The result may be the generation of mesh elements to form an incisal edge for the tooth which merges seamlessly with the adjacent surfaces of the tooth. This use of multi-headed attentions results in more accurate modeling of the distribution of the training dataset, over techniques which do not apply multi-headed attention.

In some implementations of the present disclosure, one or more attention vectors may be generated which describe how aspects of the oral care data interacts with other aspects of the oral care data associated with the arch. In some implementations, the one or more attention vectors may be generated to describe how one or more portions of a tooth T1 interact with one or more portions of a tooth T2, a tooth T3, a tooth T4, and so one. A portion of a mesh may be described as a set of mesh elements, as defined herein. In some implementations, the interacting portions of tooth T1 and tooth T2 may be determined, in part, through the calculation of mesh correspondences, as described herein. Any of these models (RNN, GRU, LSTM and Transformer) may be advantageously applied to the task of setups transform prediction, such as in the models described herein. A transformer may be particularly advantageous in that a transformer may enable the transforms for multiple teeth, or even an entire arch to be generated at once, rather than individually, as may be the case with some other models, such as an encoder structure. In other implementations, attention-free transformers may be used to make predictions based on oral care data.

One implementation of the GDL Setups neural network model may include a representation generation module (e.g., containing a U-Net structure, an autoencoder encoder, a transformer encoder, another type of encoder-decoder structure, or an encoder, etc.) which may provide its output to a module which is trained to generate tooth transformers (e.g., a set of fully connected layers with optional skip connections, or an encoder structure) to generate the prediction of a transform for each individual tooth. Skip connections may, in some implementations, connect the outputs of a particular layer in a neural network to the inputs of another later in the neural network (e.g., a layer which is not immediately adjacent to the originating layer). The transform-generation module (e.g., an encoder) may handle the transform prediction one tooth at a time. Other implementations may replace this encoder structure with a transformer (e.g., transformer encoder or transformer decoder), which may handle all the predictions for all teeth substantially concurrently. Stated another way, a transformer may be configured to receive a large number of input values, larger than some other neural network models (e.g., than a typical MLP). This is because an increased number of inputs may be accommodated by the transformer, the predictions corresponding to those inputs may be generated substantially concurrently. The representation generation module (e.g., U-Net structure) may provide its output to the transformer, and the transformer may generate the setups transforms for all of the several teeth at once, with the technical advantage of improved accuracy (because the transforms for each tooth is generated in light of the transform for each of the adjacent or nearby teeth-leading to fewer collisions and better conformance with the goals of treatment). A transformer may be trained to output a transformation, such as a transform encoded by a 4×4 matrix (or some other size), a quaternion, a translation vector, Euler angles or some other form. The transformation may place a tooth into a setups pose, may place a fixture model component into a pose suitable for fixture model generation, or may place an appliance component into a pose suitable for appliance generation (e.g., dental restoration appliance, clear tray aligner, etc.). In some implementations, the transform may define a coordinate system for aspects of the patient's dentition, such as a tooth mesh (e.g., a local coordinate system for a tooth). In some implementations, the inputs to the transformer may first be encoded using a neural network (e.g., a latent representation or embedding may be generated), such as one or more linear layers, and/or one or more convolutional layers. In some implementations, the transformer may first be trained on an offline dataset, and subsequently be trained using a secondary actor-critic network, which may enable online reinforcement learning.

Transformers may, in some implementations, enable large model capacity and/or enable an attention mechanism (e.g., the capability to pay attention and respond to certain inputs). The attention mechanisms (e.g., multi-headed attention) that are found within transformers may enable intra-sequence relationships to be encoded into neural network features. Intra-sequence relationships may be encoded, for example, by associating an order number (e.g., 1, 2, 3, etc.) with each tooth in an arch, or by associating an order number with each mesh element in a 3D representation (e.g., of a tooth). In implementations where latent vectors of teeth are provided to the transformer, intra-sequence relationships may be encoded, for example, by associating an order number (e.g., 1, 2, 3, etc.) with each element in the latent vector.

Transformers may be scaled by increasing the number of attention heads and/or by increasing the number of transformer layers. Stated differently, one or more aspects of a transformer may be independently trained to handle discrete tasks, and later combined to allow the resulting transformer to perform all of the tasks for which the individual components had been trained, without degrading the predictive accuracy of the neural network. Scaling a convolutional network may be more difficult, because the models may be less malleable or may be less interchangeable.

Convolution has an ability to be rotation and translation invariant, which leads to improved generalization, because a convolution model may not need to account for the manner in which the input data in rotated or translated. Transformers have an ability to be permutation invariant, because intra-sequence relationships may be encoded into neural network features.

In some implementations for the generation or modification of 3D oral care representations, transformers may be combined with convolution-based neural networks, such as by vertically stacking convolution layers and attention layers. Stacking transformer blocks with convolutional blocks enables the resulting structure to have the translation invariance of convolution, and also the permutation invariance of a transformer. Such stacking may improve model capacity and/or model generalization. CoAtNet is an example of a network architecture which combines convolutional and attention-based elements and may be applied to the processing of oral care data. In some instances, a network for the modification or generation of 3D oral care representations may be trained, at least in part, from CoAtNet (or another model that combines convolution and self-attention/transformers) using transfer learning.

The techniques of this disclosure may include operations such as 3D convolution, 3D pooling, 3D unconvolution and 3D unpooling. 3D convolution may aid segmentation processing, for example in down sampling a 3D mesh. 3D un-convolution undoes or reverts a 3D convolution, for example, in a U-Net. 3D pooling may aid the segmentation processing, for example in summarized neural network feature maps. 3D un-pooling undoes 3D pooling, for example in a U-Net. These operations may be implemented by way of one or more layers in the predictive or generative neural networks described herein. These operations may be applied directly on mesh elements, such as mesh edges or mesh faces. These operations provide for technical improvements over other approaches because the operations are invariant to mesh rotation, scale, and translation changes. In general, these operations depend on edge (or face) connectivity, therefore these operations remain invariant to mesh changes in 3D space as long as edge (or face) connectivity is preserved. That is, the operations may be applied to an oral care mesh and produce the same output regardless of the orientation, position or scale of that oral care mesh, which may lead to data precision improvement. MeshCNN is a general-purpose deep neural network library for 3D triangular meshes, which can be used for tasks such as 3D shape classification or mesh element labelling (e.g., for segmentation or mesh cleanup). MeshCNN implements these operations on mesh edges. Other toolkits and implementations may operate on edges or faces.

In some implementations of the techniques of this disclosure, neural networks may be trained to operate on 2D representations (such as images). In some implementations of the techniques of this disclosure, neural networks may be trained to operate on 3D representations (such as meshes or point clouds). An intraoral scanner may capture 2D images of the patient's dentition from various views. An intraoral scanner may also (or alternatively) capture 3D mesh or 3D point cloud data which describes the patient's dentition. According to various techniques, autoencoders (or other neural networks described herein) may be trained to operate on either or both of 2D representations and 3D representations.

A 2D autoencoder (comprising a 2D encoder and a 2D decoder) may be trained on 2D image data to encode an input 2D image into a latent form (such as a latent vector or a latent capsule) using the 2D encoder, and then reconstruct a facsimile of the input 2D image using the 2D decoder. In the case of a handheld mobile app which has been developed for such analysis (e.g., for the analysis of dental anatomy), 2D images may be readily captured using one or more of the onboard cameras. In other examples, 2D images may be captured using an intraoral scanner which is configured for such a function. Among the operations which may be used in the implementation a 2D autoencoder (or other 2D neural network) for 2D image analysis are 2D convolution, 2D pooling and 2D reconstruction error calculation.

2D image convolution may involve the “sliding” of a kernel across a 2D image and the calculation of elementwise multiplications and the summing of those elementwise multiplications into an output pixel. The output pixel that results from each new position of the kernel is saved into an output 2D feature matrix. In some implementations, neighboring elements (e.g., pixels) may be in well-defined locations (e.g., above, below, left and right) in a rectilinear grid.

A 2D pooling layer may be used to down sample a feature map and summarize the presence of certain features in that feature map.

2D reconstruction error may be computed between the pixels of the input and reconstructed images. The mapping between pixels may be well understood (e.g., the upper pixel [23,134] of the input image is directly compared to pixel [23,134] of the reconstructed image, assuming both images have the same dimensions).

Among the advantages provided by the 2D autoencoder-based techniques of this disclosure is the ease of capturing 2D image data with a handheld device. In some instances, where outside data sources provide the data for analysis, there may be instances where only 2D image data are available. When only 2D image data are available, then analysis using a 2D autoencoder is warranted.

Modern mobile devices (such as commercially available smartphones) may also have the capability of generating 3D data (e.g., using multiple cameras and stereophotogrammetry, or one camera which is moved around the subject to capture multiple images from different views, or both), which in some implementations, may be arranged into 3D representations such as 3D meshes, 3D point clouds and/or 3D voxelized representations. The analysis of a 3D representation of the subject may in some instances provide technical improvements over 2D analysis of the same subject. For example, a 3D representation may describe the geometry and/or structure of the subject with less ambiguity than a 2D representation (which may contain shadows and other artifacts which complicate the depiction of depth from the subject and texture of the subject). In some implementations, 3D processing may enable technical improvements because of the inverse optics problem which may, in some instances, affect 2D representations. The inverse optics problem refers to the phenomenon where, in some instances, the size of a subject, the orientation of the subject and the distance between the subject and the imaging device may be conflated in a 2D image of that subject. Any given projection of the subject on the imaging sensor could map to an infinite count of {size, orientation, distance} pairings. 3D representations enable the technical improvement in that 3D representations remove the ambiguities introduced by the inverse optics problem.

A device that is configured with the dedicated purpose of 3D scanning, such as a 3D intraoral scanner (or a CT scanner or MRI scanner), may generate 3D representations of the subject (e.g., the patient's dentition) which have significantly higher fidelity and precision than is possible with a handheld device. When such high-fidelity 3D data are available (e.g., in the application of oral care mesh classification or other 3D techniques described herein), the use of a 3D autoencoder is offers technical improvements (such as increased data precision), to extract the best possible signal out of those 3D data (i.e., to get the signal out of the 3D crown meshes used in tooth classification or setups classification).

A 3D autoencoder (comprising a 3D encoder and a 3D decoder) may be trained on 3D data representations to encode an input 3D representation into a latent form (such as a latent vector or a latent capsule) using the 3D encoder, and then reconstruct a facsimile of the input 3D representation using the 3D decoder. Among the operations which may be used to implement a 3D autoencoder for the analysis of a 3D representation (e.g., 3D mesh or 3D point cloud) are 3D convolution, 3D pooling and 3D reconstruction error calculation.

For each mesh element, a 3D convolution may be performed to aggregate local features from nearby mesh elements. Processing may be performed above and beyond the techniques for 2D convolution, to account for the differing count and locations of neighboring mesh elements (relative to a particular mesh element). A particular 3D mesh element may have a variable count of neighbors and those neighbors may not be found in expected locations (as opposed to a pixel in 2D convolution which may have a fixed count of neighboring pixels which may be found in known or expected locations). In some instances, the order of neighboring mesh elements may be relevant to 3D convolution.

A 3D pooling operation may enable the combining of features from a 3D mesh (or other 3D representation) at multiple scales. 3D pooling may iteratively reduce a 3D mesh into mesh elements which are most highly relevant to a given application (e.g., for which a neural network has been trained). Similarly to 3D convolution, 3D pooling may benefit from special processing beyond that entailed in 2D convolution, to account for the differing count and locations of neighboring mesh elements (relative to a particular mesh element). In some instances, the order of neighboring mesh elements may be less relevant to 3D pooling than to 3D convolution.

3D reconstruction error may be computed using one or more of the techniques described herein, such as computing Euclidean distances between corresponding mesh elements, between the two meshes. Other techniques are possible in accordance with aspects of this disclosure. 3D reconstruction error may generally be computed on 3D mesh elements, rather than the 2D pixels of 2D reconstruction error. 3D reconstruction error may enable technical improvements over 2D reconstruction error, because a 3D representation may, in some instances, have less ambiguity than a 2D representation (i.e., have less ambiguity in form, shape and/or structure). Additional processing may, in some implementations, be entailed for 3D reconstruction which is above and beyond that of 2D reconstruction, because of the complexity of mapping between the input and reconstructed mesh elements (i.e., the input and reconstructed meshes may have different mesh element counts, and there may be a less clear mapping between mesh elements than there is for the mapping between pixels in 2D reconstruction). The technical improvements of 3D reconstruction error calculation include data precision improvement.

A 3D representation may be produced using a 3D scanner, such as an intraoral scanner, a computerized tomography (CT) scanner, ultrasound scanner, a magnetic resonance imaging (MRI) machine or a mobile device which is enabled to perform stereophotogrammetry. A 3D representation may describe the shape and/or structure of a subject. A 3D representation may include one or more 3D mesh, 3D point cloud, and/or a 3D voxelized representation, among others. A 3D mesh includes edges, vertices, or faces. Though interrelated in some instances, these three types of data are distinct. The vertices are the points in 3D space that define the boundaries of the mesh. These points would alternatively be described as a point cloud but for the additional information about how the points are connected to each other, as described by the edges. An edge is described by two points and can also be referred to as a line segment. A face is described by a number of edges and vertices. For instance, in the case of a triangle mesh, a face comprises three vertices, where the vertices are interconnected to form three contiguous edges. Some meshes may contain degenerate elements, such as non-manifold mesh elements, which may be removed, to the benefit of later processing. Other mesh pre-processing operations are possible in accordance with aspects of this disclosure. 3D meshes are commonly formed using triangles, but may in other implementations be formed using quadrilaterals, pentagons, or some other n-sided polygon. In some implementations, a 3D mesh may be converted to one or more voxelized geometries (i.e., comprising voxels), such as in the case that sparse processing is performed. The techniques of this disclosure which operate on 3D meshes may receive as input one or more tooth meshes (e.g., arranged in one or more dental arches). Each of these meshes may undergo pre-processing before being input to the predictive architecture (e.g., including at least one of an encoder, decoder, pyramid encoder-decoder and U-Net). This pre-processing may include the conversion of the mesh into lists of mesh elements, such as vertices, edges, faces or in the case of sparse processing-voxels. For the chosen mesh element type or types, (e.g., vertices), feature vectors may be generated. In some examples, one feature vector is generated per vertex of the mesh. Each feature vector may contain a combination of spatial and/or structural features, as specified in the following table:

TABLE 1

| Element | Spatial Features | Structural Features |
|---|---|---|
| Edges | XYZ position of an edge | Edge curvature (depends on a |
| | midpoint, XYZ positions | connectivity neighborhood, |
| | of the edge vertices, | average curvature of two |
| | or the normal vector | vertices), dihedral angles, edge |
| | at an edge midpoint | length, density measure such as |
| | (average of the normal | a count of incident edges (i.e., a |
| | vectors of two | count of the other neighboring |
| | vertices). | edges which share the vertices |
| | | of that edge). |
| Faces | XYZ position of a | Face curvature (average |
| | face centroid, surface | curvature of the vertices of the |
| | normal vector. | face), face area, density measure |
| | | such as count of adjacent faces |
| | | (i.e., which share at least one |
| | | edge with the face). |
| Vertices | XYZ position, normal | Vertex curvature, density |
| | vector (weighted average | measure such as the count of |
| | of the normal vectors | vertices within a radius of the |
| | of the connecting | vertex, density measure such as |
| | faces for the | the count of incident edges or |
| | vertex). | faces. |
| Points | XYZ position | density measure such as the |
| | | count of neighboring points |
| | | within a radius of the point |
| Voxels | XYZ centroid. | Volume, [height × depth × width] |
| | | dimensions, density measure |
| | | such as a count of contained |
| | | vertices, density measure such as |
| | | count of intersected faces, |
| | | density measure such as count of |
| | | intersected edges. |

Table 1 discloses non-limiting examples of mesh element features. In some implementations, color (or other visual cues/identifiers) may be considered as a mesh element feature in addition to the spatial or structural mesh element features described in Table 1. As used herein (e.g., in Table 1), a point differs from a vertex in that a point is part of a 3D point cloud, whereas a vertex is part of a 3D mesh and may have incident faces or edges. A dihedral angle (which may be expressed in either radians or degrees) may be computed as the angle (e.g., a signed angle) between two connected faces (e.g., two faces which are connected along an edge). A sign on a dihedral angle may reveal information about the convexity or concavity of a mesh surface. For example, a positively signed angle may, in some implementations, indicate a convex surface. Furthermore, a negatively signed angle may, in some implementations, indicate a concave surface. To calculate the principal curvature of a mesh vertex, directional curvatures may first be calculated to each adjacent vertex around the vertex. These directional curvatures may be sorted in circular order (e.g., 0, 49, 127, 210, 305 degrees) in proximity to the vertex normal vector and may comprise a subsampled version of the complete curvature tensor. Circular order means: sorted in by angle around an axis. The sorted directional curvatures may contribute to a linear system of equations amenable to a closed form solution which may estimate the two principal curvatures and directions, which may characterize the complete curvature tensor. Consistent with Table 1, a voxel may also have features which are computed as the aggregates of the other mesh elements (e.g., vertices, edges and faces) which either intersect the voxel or, in some implementations, are predominantly or fully contained within the voxel. Rotating the mesh may not change structural features but may change spatial features. And, as described elsewhere in this disclosure, the term “mesh” should be considered in a non-limiting sense to be inclusive of 3D mesh, 3D point cloud and 3D voxelized representation. In some implementations, apart from mesh element features, there are alternative methods of describing the geometry of a mesh, such as 3D keypoints and 3D descriptors. Examples of such 3D keypoints and 3D descriptors are found in “TONIONI A, et al. in ‘Learning to detect good 3D keypoints.’, Int J Comput. Vis. 2018 Vol. 126, pages 1-20.”. 3D keypoints and 3D descriptors may, in some implementations, describe extrema (either minima or maxima) of the surface of a 3D representation. In some implementations, one or more mesh element features may be computed, at least in part, via deep feature synthesis (DFS), e.g. as described in: J. M. Kanter and K. Veeramachaneni, “Deep feature synthesis: Towards automating data science endeavors,” 2015 IEEE International Conference on Data Science and Advanced Analytics (DSAA), 2015, pp. 1-10, doi: 10.1109/DSAA.2015.7344858.

Representation generation neural networks based on autoencoders, U-Nets, transformers, other types of encoder-decoder structures, convolution and/or pooling layers, or other models may benefit from the use of mesh element features. Mesh element features may convey aspects of a 3D representation's surface shape and/or structure to the neural network models of this disclosure. Each mesh element feature describes distinct information about the 3D representation that may not be redundantly present in other input data that are provided to the neural network. For example, a vertex curvature may quantify aspects of the concavity or convexity of the surface of a 3D representation which would not otherwise be understood by the network. Stated differently, mesh element features may provide a processed version of the structure and/or shape of the 3D representation, data that would not otherwise be available to the neural network. This processed information is often more accessible, or more amenable for encoding by the neural network. A system implementing the techniques disclosed herein has been utilized to run a number of experiments on 3D representations of teeth. For example, mesh element features have been provided to a representation generation neural network which is based on a U-Net model, and also to a representation generation model based on a variational autoencoder with continuous normalizing flows. Based on experiments, it was found that systems using a full complement of mesh element features (e.g., “XYZ” coordinates tuple, “Normal vector”, “Vertex Curvature”, Points-Pivoted, and Normals-Pivoted) were at least 3% more accurate than systems that did not. Points-Pivoted describes “XYZ” coordinates tuples that have local coordinate systems (e.g., at the centroid of the respective tooth). Normals-Pivoted describes “Normal Vectors” which have local coordinate systems (e.g., at the centroid of the respective tooth). Furthermore, training converges more quickly when the full complement of mesh element features are used. Stated another way, the machine learning models trained using the full complement of mesh element features tended to be more accurate more quickly (at earlier epochs) than systems which did not. For an existing system observed to have a historical accuracy rate of 91%, an improvement in accuracy of 3% reduces the actual error rate by more than 30%.

Predictive models which may operate on feature vectors of the aforementioned features include but are not limited to: GDL Setups, RL Setups, VAE Setups, Capsule Setups, MLP Setups, Diffusion Setups, PT Setups, Similarity Setups, Tooth Classification, Setups Classification, Setups Comparison, VAE Mesh Element Labeling, MAE Mesh In-filling, Mesh Reconstruction Autoencoder, Validation Using Autoencoders, Mesh Segmentation, Coordinate System Prediction, Mesh Cleanup, Restoration Design Generation, Appliance Component Generation And/Or Placement, and Archform Prediction. Such feature vectors may be presented to the input of a predictive model. In some implementations, such feature vectors may be presented to one or more internal layers of a neural network which is part of one or more of those predictive models.

As described herein, tooth movements specify one or more tooth transformations that can be encoded in various ways to specify tooth positions and orientations within the setup and are applied to 3D representations of teeth. For instance, according to particular implementations, the tooth positions can be cartesian coordinates of a tooth's canonical origin location which is defined in some semantic context. Tooth orientations can be represented as rotation matrices, unit quaternions, or another 3D rotation representations such as Euler angles with respect to a frame of reference (either global or local). Dimensions are real valued 3D spatial extents and gaps can be binary presence indicators or real valued gap sizes between teeth especially in instances when certain teeth are missing. In some implementations, tooth rotations may be described by 3×3 matrices (or by matrices of other dimensions). Tooth position and rotation information may, in some implementations, be combined into the same transform matrix, for example, as a 4×4 matrix, which may reflect homogenous coordinates. In some instances, affine spatial transformation matrices may be used to describe tooth transformations, for example, the transformations which describe the maloccluded pose of a tooth, an intermediate pose of a tooth and/or a final setup pose of a tooth. Some implementations may use relative coordinates, where setup transformations are predicted relative to malocclusion coordinate systems (e.g., a malocclusion-to-setup transformation is predicted instead of a setup coordinate system directly). Other implementations may use absolute coordinates, where setup coordinate systems are predicted directly for each tooth. In the relative mode, transforms can be computed with respect to the centroid of each tooth mesh (vs the global origin), which is termed “relative local.” Some of the advantages of using relative local coordinates include eliminating the need for malocclusion coordinate systems (landmarking data) which may not be available for all patient case datasets. Some of the advantages of using absolute coordinates include simplifying the data preprocessing as mesh data are originally represented as relative to the global origin. These details about tooth position encoding and tooth orientation encoding may, in some implementations, also apply one or more of the neural networks models of the present disclosure, including but not limited to: GDL Setups, RL Setups, VAE Setups, Capsule Setups, MLP Setups, Diffusion Setups, PT Setups, Similarity Setups, FDG Setups, Setups Classification, Setups Comparison, VAE Mesh Element Labeling, MAE Mesh In-filling, Mesh Reconstruction VAE, and Validation Using Autoencoders.

According to particular implementations, convolution layers in the various 3D neural networks described herein may use edge data to perform mesh convolution. The use of edge information guarantees that the model is not sensitive to different input orders of 3D elements. In addition to or separate from using edge data, the convolution layers may use vertex data to perform mesh convolution. The use of vertex information is advantageous in that there are typically fewer vertices than edges or faces, so vertex-oriented processing may lead to a lower processing overhead and lower computational cost. In addition to or separate from using edge data or vertex data, the convolution layers may use face data to perform mesh convolution. Furthermore, in addition to or separate from using edge data, vertex data, or face data, the convolution layers may use voxel data to perform mesh convolution. The use of voxel information is advantageous in that, depending on the granularity chosen, there may be significantly fewer voxels to process compared to the vertices, edges or faces in the mesh. Sparse processing (with voxels) may lead to a lower processing overhead and lower computational cost (especially in terms of computer memory or RAM usage).

Representation generation neural networks based on autoencoders, U-Nets, transformers, other types of encoder-decoder structures, convolution and/or pooling layers, or other models may benefit from the use of oral care arguments (e.g., oral care metrics or oral care parameters). For example, oral care metrics (e.g., orthodontic metrics or restoration design metrics) may convey aspects of the shape and/or structure of the patient's dentition (e.g., the shape and/or structure of an individual tooth, or the special relationships between two or more teeth) to the neural network models of this disclosure. Each oral care metric describes distinct information about the patient's dentition that may not be redundantly present in other input data that are provided to the neural network. For example, an “Overbite” metric may quantify the overlap between the upper and lower central incisors along the vertical Z-axis, information which may not otherwise, in some implementations, be readily ascertainable by a traditional neural network. Stated another way, the oral care metrics provide refined information about the patient's dentition that a traditional neural network (e.g., a representation generation neural network) may not be adequately trained or configured to extract the oral care metrics described herein. However, a neural network which is specifically trained to generate oral care metrics may overcome such a shortcoming, because, for example loss may be computed in such a way as to facilitate accurate oral care metrics prediction. Mesh oral care metrics may provide a processed version of the structure and/or shape of the patient's dentition, data which may not otherwise be available to the neural network. This processed information is often more accessible, or more amenable for encoding by the neural. A system disclosing the techniques disclosed herein has been utilized to run a number of experiments on 3D representations of teeth. For example, oral care metrics have been provided to a representation generation neural network which is based on a U-Net model. Based on experiments, it was found that systems using oral care metrics (e.g., “Overbite”, “Overjet” and “Canine Class Relationship” metrics) were at least 2.5% more accurate than systems that did not. Furthermore, training converges more quickly when the oral care metrics are used. Stated another way, the machine learning models trained using oral care metrics tended to be more accurate more quickly (at earlier epochs) than systems which did not. For a system which has previously been 91% accurate, an improvement in accuracy of 2.5% reduces the actual error rate by almost 30%.

PCT application with Publication No. WO2020026117A1 is incorporated herein by reference in its entirety. WO2020026117A1 lists some examples of Orthodontic Metrics (OM). Further examples are disclosed herein. The orthodontic metrics may be used to quantify the physical arrangement of an arch of teeth for the purpose of orthodontic treatment (as opposed to restoration design metrics-which pertain to dentistry and describe the shape and/or form of one or more pre-restoration teeth, for the purpose of supporting dental restoration). These orthodontic metrics can measure how badly maloccluded the arch is, or conversely the metrics can measure how correctly arranged the teeth are. In some implementations, the GDL Setups model (or RL Setups, VAE Setups, Capsule Setups, MLP Setups, Diffusion Setups, PT Setups, Similarity Setups and FDG Setups) may incorporate one or more of these orthodontic metrics, or other similar or related orthodontic metrics. In some implementations, such orthodontic metrics may be incorporated into the feature vector for a mesh element, where these per-element feature vectors are fed into the setups prediction network as inputs. In some implementations, such orthodontic metrics may be directly consumed by a generator, an MLP, a transformer, or other neural network as direct inputs (such as presented in one or more input vectors of real numbers S, such as described elsewhere in this disclosure. The use of such orthodontic metrics in the training of the generator may improve the performance (i.e., correctness) of the resulting generator, resulting in predicted transforms which place teeth more nearly in the correct final setups poses than would otherwise be possible. Such orthodontic metrics may be consumed by an encoder structure or by a U-Net structure (in the case of GDL Setups). Such orthodontic metrics may be consumed by an autoencoder, variational autoencoder, masked autoencoder or regularized autoencoder (in the case of the VAE Setups, VAE Mesh Element Labelling, MAE Mesh In-Filling). Such orthodontic metrics may be consumed by a neural network which generates action predictions as a part of a reinforcement learning RL Setups model. Such orthodontic metrics may be consumed by a classifier which applies a label to a setup arch (e.g., labels such as mal, staging or final setup). This description is non-limiting, as the orthodontic metrics may also be incorporated in other ways into the various techniques of this disclosure.

The various loss calculations of the present disclosure may, in some examples, incorporate one or more orthodontic metrics, with the advantage of improving the correctness of the resulting neural network. An orthodontic metric may be used to directly compare a predicted example to the corresponding ground truth example (such as is done with the metrics in the Setups Comparison description). In other examples, one or more orthodontic metrics may be taken from this section and incorporated into a loss computation. Such an orthodontic metric may be computed on the predicted example, and then the orthodontic metric would also be computed on the ground truth example. These two orthodontic metrics results would then be consumed by the loss computation, with the advantage of improving the performance of the resulting neural network. In some implementations, one or more orthodontic metrics pertaining to the alignment of two or more adjacent teeth may be computed and incorporated into a loss function, for example, to train, at least in part, a setups prediction neural network. In some implementations, such an orthodontic metric may facilitate the network in aligning the mesial surface of one tooth with distal surface of adjacent tooth. Backpropagation is an exemplary algorithm by which a neural network may be trained using one or more loss values.

In some implementations, one or more orthodontic metrics may be used to evaluate the predicted output of a neural network, such as a setups prediction. Such a metric(s) may enable the training algorithm to determine how close the predicted output is to an acceptable output, for example, in a quantified sense. In some implementations, this use of an orthodontic metric may enable a loss value to be computed which does not depend entirely on a comparison to a ground truth. In some implementations, such a use of an orthodontic metric may enable loss calculation and network training to proceed without the need for a comparison against a ground truth example. The advantage of such an approach is that loss may be computed based on a general principle or specification for the predicted output (such as a setup) rather than tying loss calculation to a specific ground truth example (which may have been defined by a particular doctor, clinician, or technician, whose treatment philosophy may differ from that of other technicians or doctors). In some implementations, such an orthodontic metric may be defined based on a FID (Frechet Inception Distance) score.

The following is a description of some of the orthodontic metrics which are used to quantify the state of a set of teeth in an arch for the purpose of orthodontic treatment. These orthodontic metrics indicate the degree of malocclusion that the teeth are in at a given stage of clear tray aligner treatment.

An orthodontic metric that can be computed using tensors may be especially advantageous when training one of the neural networks of the present disclosure, because tensor operations may promote efficient computations. The more efficient (and faster) the computation, the faster the rate at which training can proceed.

In some examples, an error pattern may be identified in one or more predicted outputs of an ML model (e.g., a transformation matrix for a predicted tooth setup, a labelling of mesh elements for mesh cleanup, an addition of mesh elements to a mesh for the purpose of mesh in-filling, a classification label for a setup, a classification label for a tooth mesh, etc.). One or more orthodontic metrics may be selected to become an input to the next round of ML model training, to address any pattern of errors or deficiencies which may be identified in the one or more predicted outputs.

Some OM may be defined relative to an archform coordinate frame, the LDE coordinate system. In some implementations, a point may be described using an LDE coordinate frame relative to an archform, where L, D and E correspond to: 1) Length along the curve of the archform, 2) Distance away from the archform, and 3) distance in the direction perpendicular to the L and D axes (which may be termed Eminence), respectively.

Various of the OM and other techniques of the present disclosure may compute collisions between 3D representations (e.g., of oral care objects, such as teeth). Such collisions may be computed as at least one of: 1) penetration distance between 3D tooth representations, 2) count of overlapping mesh elements between 3D tooth representations, and 3) volume of overlap between 3D tooth representations. In some implementations, an OM may be defined to quantify the collision of two or more 3D representations of oral care structures, such as teeth. Some optimization algorithms, such as setups prediction techniques, may seek to minimize collisions between oral care structures (such as teeth). Between-arch orthodontic metrics are as follows.

Six (6) metrics for the comparison of two or more arches are listed below. Other suitable comparison orthodontic metrics are found elsewhere in this disclosure, such as in the section for the Setups Comparison technique.
1. Rotation geodesic distance (rotation between predicted example and ground truth setup example)
2. Translation distance (gap between predicted example and ground truth setup example)
3. Normalized translation distance
4. 3D alignment error that measures the distance between predicted mesh elements and ground truth mesh elements, in units of mm.
5. Normalized 3D alignment
6. Percent overlap (% overlap) by volume (alternatively % overlap by mesh elements) of predicted example and corresponding ground truth example

Within-arch orthodontic metrics are as follows.

Alignment—A 3D tooth orientation vector may be calculated using the tooth's mesial-distal axis. A 3D vector, which may be tangent vector to the archform at the position of the tooth may also be calculated. The XY components (i.e., which may be 2D vectors) may then be used to compare the orientation of the archform at the tooth's location to the tooth's orientation in XY space. Cosine similarity may be used to calculate the 2D orientation difference (angle) between the archform tangent and the tooth's mesial-distal axis.
Arch Symmetry—For each left-right pair of teeth (e.g., lower left lateral incisor and/or lower right lateral incisor) the absolute difference may be calculated between each tooth's X-coordinate and the global coordinate reference frame's X-axis. This delta may indicate the arch asymmetry for a given tooth pair. The result of such a calculation may be the mean X-axis delta of one or more tooth-pairs from the arch. This calculation may, in some implementations, be performed relative to the Y-axis with y-coordinates (and/or relative to the Z axis with Z-coordinates).
Archform D-axis Differences—May compute the D dimension difference (i.e., the positional difference in the facial-lingual direction) between two arch states, for one or more teeth. May, in some implementations, return a dictionary of the D-direction tooth movement for each tooth, with tooth UNS number as the key. May use the LDE coordinate system relative to an archform.
Archform (Lower) Length Ratio—May compute the ratio between the current lower arch length and the arch length as it was in the original maloccluded lower arch.
Archform (Upper) Length Ratio—May compute the ratio between the current upper arch length and the arch length as it was in the original maloccluded upper arch.
Archform Parallelism (Full arch)—For at least one local tooth coordinate system origin in the upper arch, the one or more nearest origins (e.g., tooth local coordinate system origins) in the lower arch. In some implementations, the two nearest origins may be used. May compute the straight-line distance from the upper arch point to the line formed between the origins of the two teeth in the opposing (lower) arch. May return the standard deviation of the set of “point-to-line” distances mentioned above, where the set may be composed of the point-to-line distances for each tooth in the arch.
Archform Parallelism (Individual tooth)—This metric may share some computational elements with the archform_parallelism_global orthodontic metric, except that this metric may input the mean distance from a tooth origin to the line formed by the neighboring teeth in opposing arches (e.g., a tooth in the upper arch and the corresponding tooth in the lower arch). The mean distance may be computed for one or more such pairs of teeth. In some implementations, this may be computed for all pairs of teeth. Then the mean distance may be subtracted from the distance that is computed for each tooth pair. This OM may yield the deviation of a tooth from a “typical” tooth parallelism in the arch.
Buccolingual Inclination—For at least one molar or premolar, find the corresponding tooth on the opposite side of the same arch (i.e., for a tooth on the left side of the arch, find the same type of tooth on the right side and vice versa). This OM may compute an n-element list for each tooth (e.g. n may equal 2). This list may contain at least the tooth IDs of the teeth in each pair of teeth (e.g., LeftLowerFirstMolar and RightLowerFirstMolar in a list=[left_tooth_idx_1, right_tooth_idx_2]). Such an n-element vector may be computed for each molar and each premolar in the upper and lower arches. The buccal cusps may be identified on the molars and premolars on each of the left and right sides of the arch. Draw a line between the buccal cusps of the left tooth and the buccal cusps on the right tooth. Make a plane using this line and the z-axis of the arch. The lingual cusps may be projected onto the plane (i.e., at this point the angle of inclination may be determined). By performing an additional projection, the approximate vertical distance between the lingual cusps and the buccal cusps may be computed. This distance may be used as the buccolingual inclination OM.
Canine Overbite—The upper and lower canines may be identified. The first premolar for the given side of the mouth may be identified. On a given side of the arch, a distance may be computed between the upper canine and the lower canine, and also between the upper pre-molar and the lower pre-molar. The average (or median, or mode or some other statistic) may be computed for the measured distances. The z-component of this result indicates the degree of overbite. Overbite may be computed between any tooth in one arch and the corresponding tooth in the other arch.
Canine Overjet Contact—May calculate the collisions (e.g., collision distances) between pairs of canines on opposing arches.
Canine Overjet Contact KDE—May take an orthodontic metric score for the current patient case as input and may convert that score into to a log-likelihood using a previously trained kernel density estimation (KDE) model or distribution. This operation may yield information about where in the distribution of “typical” values this patient case lies.
Canine Overjet—This OM may share some computational steps with the canine overbite OM. In some implementations, average distances may be computed. In some implementations, the distance calculation may compute the Euclidean distance of the XY components of a tooth in the upper arch and a tooth in the lower arch, to yield overjet (i.e., as opposed to computing the difference in Z-components, as may be performed for canine overbite). Overjet may be computed between any tooth in one arch and the corresponding tooth in the other arch.
Canine Class Relationship (also applies to first, second and third molars)—This OM may, in some implementations comprise two functions (e.g., written in Python).
get_canine_landmarks( ): Get landmarks for each tooth which may be used to compute the class relationship, and then, in some implementations, map those landmarks onto the global coordinate space so that measurements may be made between teeth.
class_relationship_score_by_side( ): May compute the average position of at least one landmark on at least one tooth in the lower arch, and may compute the same for the upper arch. Then may compute the vector from the upper arch landmark position to the lower arch landmark position, and finally projects this vector onto the lower arch to yield a quantification (e.g., as a scalar) of the amount of delta in “arch 1-axis” position there is. This OM may compute how far forward or behind the tooth is positioned on the 1-axis relative to the tooth or teeth of interest in the opposing arch.
   Crossbite—Fossa in at least one upper molar may be located by finding the halfway point between distal and mesial marginal ridge saddles of the tooth. A lower molar cusp may lie between the marginal ridges of the corresponding upper molar. This OM may compute a vector from the upper molar fossa midpoint to the lower molar cusp. This vector may be projected onto the d-axis of the archform, yielding a lateral measure of distance from the cusp to the fossa. This distance may define the crossbite magnitude.
   Edge Alignment—This OM may identify the leftmost and rightmost edges of a tooth, and may identify the same for that tooth's neighbor.
The OM may then draw a vector from the leftmost edge of the tooth to the leftmost edge of the tooth's neighbor.
The OM may then draw a vector from the rightmost edge of the tooth to the rightmost edge of the tooth's neighbor.
The OM may then calculates the linear fit error between the two vectors.
Such a calculation may involve making two vectors:
Vec_tooth=right_tooths_leftside to left_tooths_leftside
Vec_neighbor=right_tooths_rightside to left_tooths_leftside
And then may involve computing the dot-product of these two vectors and subtracting the result from 1. (i.e., EdgeAlignment score=1-abs (dot (Vec_tooth, Vec_neighbor))).
A score of 0 may indicate perfect alignment. A score of 1 may mean perpendicular alignment.
   Incisor Interarch Contact KDE—May identify the deviation of the IncisorInterarchContact from the means of a modeled distribution of such statistics across a dataset of one or more other patient cases.
   Leveling—May compute a measure of leveling between a tooth and its neighbor. This OM may calculate the difference in height between two or more neighboring teeth. For molars, this OM may use the midpoint between the mesial and distal saddle ridges as the height of the molar. For non-molar teeth, this OM may use the length of the crown from gums to tip. In some implementations, the tip may be the origin of the local coordinate space of the tooth. Other implementations may place the origin in other locations. A simple subtraction between the heights of neighboring teeth may yield the leveling delta between the teeth (e.g., by comparing Z components).
   Midline—May compute the position of the midline for the upper incisors and/or the lower incisors, and then may compute the distance between them.
   Molar Interarch Contact KDE—May compute a molar interarch contact score (i.e., a collision depth or other type of collision), and then may identify where that score lies in a pre-defined KDE (distribution) built from representative cases.
   Occlusal Contacts—For a particular tooth from the arch, this OM may identify one or more landmarks (e.g., mesial cusp, or central cusp, etc.). Get the tooth transform for that tooth. For each cusp on the current tooth, the cusp may be scored according to how well the cusp contacts the neighboring (corresponding) tooth in the opposite arch. A vector may be found from the cusp of the tooth in question to the vertical intersection point in the corresponding tooth of the opposing arch. The distance and/or direction (i.e., up or down) to the opposing arch may be computed. A list may be returned that contains the resulting signed distances, one for each cusp on the tooth in question.
   Overbite—The upper and lower central incisors may be compared along the z-axis. The difference along the z-axis may be used as the overbite score.
   Overjet—The upper and lower central incisors may be compared along the y-axis. The difference along the y-axis may be used as the overjet score.
   Molar Interarch Contact—May calculate the contact score between molars, and may use collision measurement(s) (such as collision depth).
   Root Movement d—The tooth transforms for an initial state and a next state may be recieved. The archform axes at a point L along the archform may be computed. This OM may return a distance moved along the d-axis. This may be accomplished by projecting the root pivot point onto the d-axis.
   Root Movement l—The tooth transforms for an initial state and a next state may be received. The archform axes at a point L along the archform may be computed. This OM may return a distance moved along the 1-axis. This may be accomplished by projecting the root pivot point onto the 1-axis.
   Spacing—May compute the spacing between each tooth and its neighbor. The transforms and meshes for the arch may be received. The left and right edges of each tooth mesh may be computed. One or more points of interest may be transformed from local coordinates into the global arch coordinate frame. The spacing may be computed in a plane (e.g., the XY plane) between each tooth and its neighbor to the “left”. May return an array of one or more Euclidean distances (e.g., such as in the XY plane) which may represent the spacing between each tooth and its neighbor to the left.
   Torque—May compute torque (i.e., rotation around and axis, such as the x-axis). For one or more teeth, one or more rotations may be converted from Euler angles into one or more rotation matrices. A component (such as a x-component) of the rotations may be extracted and converted back into Euler angles. This x-component may be interpreted as the torque for a tooth. A list maybe returned which contains the torque for one or more teeth, and may be indexed by the UNS number of the tooth.

The neural networks of this disclosure may exploit one or more benefits of the operation of parameter tuning, whereby the inputs and parameters of a neural network are optimized to produce more data-precide results. One parameter which may be tuned is neural network learning rate (e.g., which may have values such as 0.1, 0.01, 0.001, etc.). Data augmentation schemes may also be tuned or optimized, such as schemes where “shiver” is added to the tooth meshes before being input to the neural network (i.e., small random rotations, translations and/or scaling may be applied to vary the dataset and make the neural network robust to variations in data).

A subset of the neural network model parameters available for tuning are as follows:
Learning rate (LR) decay rate (e.g., how much the LR decays during a training run)
Learning rate (LR). The floating-point value (e.g., 0.001) that is used by the optimizer.
LR schedule (e.g., cosine annealing, step, exponential)
Voxel size (for cases with sparse mesh processing operations)
Dropout % (e.g., dropout which may be performed in a linear encoder)
LR decay step size (e.g., decay every 10 or 20 or 30 epochs)
Model scaling, which may increase or decrease the count of layers and/or the count of parameters per layer.

Parameter tuning may be advantageously applied to the training of a neural network for the prediction of final setups or intermediate staging to provide data precision-oriented technical improvements. Parameter tuning may also be advantageously applied to the training of a neural network for mesh element labeling or a neural network for mesh in-filling. In some examples, parameter tuning may be advantageously applied to the training of a neural network for tooth reconstruction. In terms of classifier models of this disclosure, parameter tuning may be advantageously applied to a neural network for the classification of one or more setups (i.e., classification of one or more arrangements of teeth). The advantage of parameter tuning is to improve the data precision of the output of a predictive model or a classification model. Parameter tuning may, in some instances, provide the advantage of obtaining the last remaining few percentage points of validation accuracy out of a predictive or classification model.

Some techniques of the present disclosure, for example the setups comparison technique, and the setups prediction techniques (e.g., such as GDL Setups, MLP Setups, VAE Setups and the like), may benefit from a processing step which may align (or register) arches of teeth (e.g., where a tooth may be represented by a 3D point cloud, or some other type of 3D representation described herein). Such a processing setup may, for example, be used to register a ground truth setup arch from a patient case with the maloccluded arch from that same case, before these mal and ground truth setup arches are used to train a setups prediction neural network model. Such a step may aid in loss calculation, because the predicted arch (e.g., an arch outputted by a generator) may be in better alignment with the ground truth setup arch, a condition which may facilitate the calculation of reconstruction loss, representation loss, L1 loss, L2 loss, MSE loss and/or other kinds of losses described herein. In some implementations, an iterative closest point (ICP) technique may be used for such registration. ICP may minimize the squared errors between corresponding entities, such as 3D representations. In some implementations, linear least squares calculations may be performed. In some implementations, non-linear least squares calculations may be performed. Various registration models may incorporate portions of the following algorithms, in whole or in part: Levenberg-Marquardt ICP, Least Square Rigid transformation, Robust Rigid transformation, random sample consensus (RANSAC) ICP, K-means based RANSAC ICP and Generalized ICP (GICP). Registration may, in some instances, help decrease the subjectivity and/or randomness that may, in some instances, occur in reference ground truth setup designs which have been designed by technicians (i.e., two technicians may produce different but valid final setups outputs for the same case) or by other optimization techniques.

In experiments, during training of a setups prediction model, the ground truth (or reference) setup was registered to the malocclusion (or maloccluded setup). The maloccluded teeth were provided to the setups prediction model, which generated final setup transforms for the maloccluded teeth. Loss was computed between the resulting predicted setup and the pre-registered ground truth setup, so that corresponding aspects of the two setups would line-up. The result was a more accurate loss calculation. This pre-registration operation resulted in a 6% improvement in absolute accuracy (e.g., as measured by ADD10 score), which amounts to a reduction in error rate of nearly 50% compared with conventional techniques.

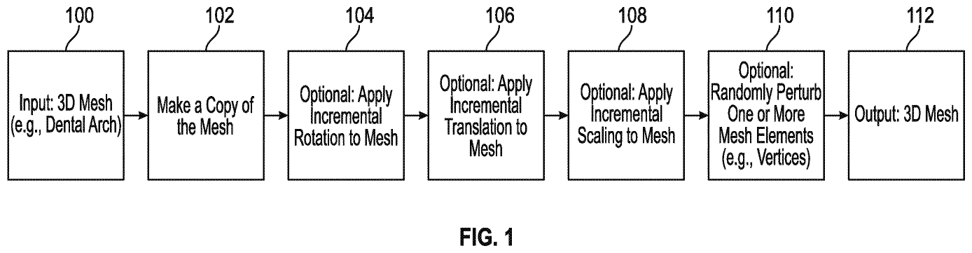

Various neural network models of this disclosure may draw benefits from data augmentation. Examples include models of this which are trained on 3D meshes, such as GDL Setups, RL Setups, VAE Setups, Capsule Setups, MLP Setups, Diffusion Setups, PT Setups, Similarity Setups, FDG Setups, Setups Classification, Setups Comparison, VAE Mesh Element Labeling, MAE Mesh In-filling, Mesh Reconstruction VAE, and Validation Using Autoencoders. Data augmentation, such as by way of the workflow shown in FIG. 1, may increase the size of the training dataset of dental arches. Data augmentation can provide additional training examples by adding random rotations, translations, and/or rescaling to copies of existing dental arches. In some implementations of the techniques of this disclosure, data augmentation may be carried out by perturbing or jittering the vertices of the mesh, in a manner similar to that described in (“Equidistant and Uniform Data Augmentation for 3D Objects”, IEEE Access, Digital Object Identifier 10.1109/ACCESS.2021.3138162). The position of a vertex may be perturbed through the addition of Gaussian noise, for example with zero mean, and 0.1 standard deviation. Other mean and standard deviation values are possible in accordance with the techniques of this disclosure. Other data augmentation techniques which are not disclosed by prior techniques may involve augmentation through the use of neural networks. For example, an encoder-decoder structure (e.g., which may have been trained to function as a reconstruction autoencoder at training time) may be used for data augmentation. For example, a 3D oral care representation (e.g., one or more tooth meshes, or one or more tooth transforms) may be provided to the encoder portion of such an encoder-decoder, and be encoded into a latent representation. Techniques of this disclosure may, in some implementations, compute correspondences (e.g., mesh correspondences or correspondences between elements of a transform) between the 3D oral care representation and a template 3D oral care representation (e.g., a tooth with a standard or average shape). Such correspondence calculations may standardize the data, which may improve the accuracy of the latent representation(s) generated by the encoder (e.g., as observed during training of the systems and techniques of this disclosure). For example, it was observed that systems that did not utilize the correspondence calculations generated latent representations of teeth which led to reconstructions that had higher error rates. The latent representation (e.g., a latent vector-such as a latent vector of size 512 or 1024 that represents a tooth mesh) may undergo targeted modification (e.g., using an ML model which has been trained for that purpose), and then be reconstructed using the decoder portion of the encoder-decoder structure. The targeted modifications may, in some implementations, be based on a mapping of the latent space, such as may be performed by a series of experiments where changes are made to a latent vector and the effects on the subsequent reconstructed 3D oral care presentation are recorded (e.g., in a table or other data store). The reconstructed 3D oral care representation (e.g., reconstructed tooth mesh or reconstructed transform, or other examples of 3D oral care representations disclosed herein) may have augmented properties. For example, the reconstructed 3D oral care representation may have an augmented (or modified) shape and/or structure relative to the original version of that 3D oral care representation (e.g., a reconstructed tooth may have a different shape, or a reconstructed transform may place an object into a slightly different pose). This reconstructed 3D oral care representation may serve as an augmented data sample, and may be outputted for use in training the ML models of this disclosure.

FIG. 1 shows a data augmentation workflow that systems of this disclosure may apply to 3D oral care representations. A non-limiting example of a 3D oral care representation is a tooth mesh or a set of tooth meshes. Tooth data 100 (e.g., 3D meshes) are received at the input. The systems of this disclosure may generate copies of the tooth data 100 (102). In the example of FIG. 1, the systems of this disclosure may apply one or more stochastic rotations to the tooth data 100 (104). In the example of FIG. 1, the systems of this disclosure may apply stochastic translations to the tooth data 100 (106). The systems of this disclosure may apply stochastic scaling operations to the tooth data 100 (108). The systems of this disclosure may apply stochastic perturbations to one or more mesh elements of the tooth data 100 (110). The systems of this disclosure may output augmented tooth data 112 that are formed by way of the method of FIG. 1.

Because generator networks of this disclosure can be implemented as one or more neural networks, the generator may contain an activation function. When executed, an activation function outputs a determination of whether or not a neuron in a neural network will fire (e.g., send output to the next layer). Some activation functions may include: binary step functions, or linear activation functions. Other activation functions impart non-linear behavior to the network, including: sigmoid/logistic activation functions, Tanh (hyperbolic tangent) functions, rectified linear units (ReLU), leaky ReLU functions, parametric ReLU functions, exponential linear units (ELU), softmax function, swish function, Gaussian error linear unit (GELU), or scaled exponential linear unit (SELU). A linear activation function may be well suited to some regression applications (among other applications), in an output layer. A sigmoid/logistic activation function may be well suited to some binary classification applications (among other applications), in an output layer. A softmax activation function may be well suited to some multiclass classification applications (among other applications), in an output layer. A sigmoid activation function may be well suited to some multilabel classification applications (among other applications), in an output layer. A ReLU activation function may be well suited in some convolutional neural network (CNN) applications (among other applications), in a hidden layer. A Tanh and/or sigmoid activation function may be well suited in some recurrent neural network (RNN) applications (among other applications), for example, in a hidden layer. There are multiple optimization algorithms which can be used in the training of the neural networks of this disclosure (such as in updating the neural network weights), including gradient descent (which determines a training gradient using first-order derivatives and is commonly used in the training of neural networks), Newton's method (which may make use of second derivatives in loss calculation to find better training directions than gradient descent, but may require calculations involving Hessian matrices), and conjugate gradient methods (which may yield faster convergence than gradient descent, but do not require the Hessian matrix calculations which may be required by Newton's method). In some implementations, additional methods may be employed to update weights, in addition to or in place of the techniques described above. These additional methods include the Levenberg-Marquardt method and/or simulated annealing. The backpropagation algorithm is used to transfer the results of loss calculation back into the network so that network weights can be adjusted, and learning can progress.

Neural networks contribute to the functioning of many of the applications of the present disclosure, including but not limited to: GDL Setups, RL Setups, VAE Setups, Capsule Setups, MLP Setups, Diffusion Setups, PT Setups, Similarity Setups, Tooth Classification, Setups Classification, Setups Comparison, VAE Mesh Element Labeling, MAE Mesh In-filling, Mesh Reconstruction Autoencoder, Validation Using Autoencoders, imputation of oral care parameters, 3D mesh segmentation (3D representation segmentation), Coordinate System Prediction, Mesh Cleanup, Restoration Design Generation, Appliance Component Generation and/or Placement, or Archform Prediction. The neural networks of the present disclosure may embody part or all of a variety of different neural network models. Examples include the U-Net architecture, multi-later perceptron (MLP), transformer, pyramid architecture, recurrent neural network (RNN), autoencoder, variational autoencoder, regularized autoencoder, conditional autoencoder, capsule network, capsule autoencoder, stacked capsule autoencoder, denoising autoencoder, sparse autoencoder, conditional autoencoder, long/short term memory (LSTM), gated recurrent unit (GRU), deep belief network (DBN), deep convolutional network (DCN), deep convolutional inverse graphics network (DCIGN), liquid state machine (LSM), extreme learning machine (ELM), echo state network (ESN), deep residual network (DRN), Kohonen network (KN), neural Turing machine (NTM), or generative adversarial network (GAN). In some implementations, an encoder structure or a decoder structure may be used. Each of these models provides one or more of its own particular advantages. For example, a particular neural networks architecture may be especially well suited to a particular ML technique. For example, autoencoders are particularly suited to the classification of 3D oral care representations, due to the ability to encode the 3D oral care representation into a form which is more easily classifiable.

In some implementations, the neural networks of this disclosure can be adapted to operate on 3D point cloud data (alternatively on 3D meshes or 3D voxelized representation). Numerous neural network implementations may be applied to the processing of 3D representations and may be applied to training predictive and/or generative models for oral care applications, including: PointNet, PointNet++, SO-Net, spherical convolutions, Monte Carlo convolutions and dynamic graph networks, PointCNN, ResNet, MeshNet, DGCNN, VoxNet, 3D-ShapeNets, Kd-Net, Point GCN, Grid-GCN, KCNet, PD-Flow, PU-Flow, MeshCNN and DSG-Net. Oral care applications include, but are not limited to: setups prediction (e.g., using VAE, RL, MLP, GDL, Capsule, Diffusion, etc. which have been trained for setups prediction), 3D representation segmentation, 3D representation coordinate system prediction, element labeling for 3D representation clean-up (VAE for Mesh Element labeling), in-filling of missing elements in 3D representation (MAE for Mesh In-Filling), dental restoration design generation, setups classification, appliance component generation and/or placement, archform prediction, imputation of oral care parameters, setups validation, or other validation applications and tooth 3D representation classification.

Some implementations of the techniques of this disclosure incorporate the use of an autoencoder. Autoencoders that can be used in accordance with aspects of this disclosure include but are not limited to: AtlasNet, FoldingNet and 3D-PointCapsNet. Some autoencoders may be implemented based on PointNet.

Representation learning may be applied to setups prediction techniques of this disclosure by training a neural network to learn a representation of the teeth, and then using another neural network to generate transforms for the teeth. Some implementations may use a VAE or a Capsule Autoencoder to generate a representation of the reconstruction characteristics of the one or more meshes related to the oral care domain (including, in some instances, information about the structures of the tooth meshes). Then that representation (either a latent vector or a latent capsule) may be used as input to a module which generates the one or more transforms for the one or more teeth. These transforms may in some implementations place the teeth into final setups poses. These transforms may in some implementations place the teeth into intermediate staging poses. In some implementations, a transform may be described by a 9×1 transformation vector (e.g., that specifies a translation vector and a quaternion). In other implementations, a transform may be described by a transformation matrix (e.g., a 4×4 affine transformation matrix).

In some implementations, systems of this disclosure may implement a principal components analysis (PCA) on an oral care mesh, and use the resulting principal components as at least a portion of the representation of the oral care mesh in subsequent machine learning and/or other predictive or generative processing.

Systems of this disclosure may implement end-to-end training. Some of the end-to-end training-based techniques of this disclosure may involve two or more neural networks, where the two or more neural networks are trained together (i.e., the weights are updated concurrently during the processing of each batch of input oral care data). End-to-end training may, in some implementations, be applied to setups prediction by concurrently training a neural network which learns a representation of the teeth, along with a neural network which generates the tooth transforms.

According to some of the transfer learning-based implementations of this disclosure, a neural network (e.g., a U-Net) may be trained on a first task (e.g., such as coordinate system prediction). The neural network trained on the first task may be executed to provide one or more of the starting neural network weights for the training of another neural network that is trained to perform a second task (e.g., setups prediction). The first network may learn the low-level neural network features of oral care meshes and be shown to work well at the first task. The second network may exhibit faster training and/or improved performance by using the first network as a starting point in training. Certain layers may be trained to encode neural network features for the oral care meshes that were in the training dataset. These layers may thereafter be fixed (or be subjected to minor changes over the course of training) and be combined with other neural network components, such as additional layers, which are trained for one or more oral care tasks (such as setups prediction). In this manner, a portion of a neural network for one or more of the techniques of the present disclosure (e.g., setups prediction) may receive initial training on another task, which may yield important learning in the trained network layers. This encoded learning may then be built upon with further task-specific training of another network.

In accordance with this disclosure, transfer learning may be used for setups prediction, as well as for other oral care applications, such as mesh classification (e.g., tooth or setups classification), mesh element labeling, mesh element in-filling, procedure parameter imputation, mesh segmentation, coordinate system prediction, restoration design generation, mesh validation (for any of the applications disclosed herein). In some implementations, a neural network trained to output predictions based on oral care meshes may first be partially trained on one of the following publicly available datasets, before being further trained on oral care data: Google PartNet dataset, ShapeNet dataset, ShapeNetCore dataset, Princeton Shape Benchmark dataset, ModelNet dataset, ObjectNet3D dataset, Thingi10K dataset (which is especially relevant to 3D printed parts validation), ABC: A Big CAD Model Dataset For Geometric Deep Learning, ScanObjectNN, VOCASET, 3D-FUTURE, MCB: Mechanical Components Benchmark, PoseNet dataset, PointCNN dataset, MeshNet dataset, MeshCNN dataset, PointNet++ dataset, PointNet dataset, or PointCNN dataset.

In some implementations, a neural network which was previously trained on a first dataset (either oral care data or other data) may subsequently receive further training on oral care data and be applied to oral care applications (such as setups prediction). Transfer learning maybe employed to further train any of the following networks: GCN (Graph Convolutional Networks), PointNet, ResNet or any of the other neural networks from the published literature which are listed above.

In some implementations, a first neural network may be trained to predict coordinate systems for teeth (such as by using the techniques described in WO2022123402A1 or US Provisional Application No. U.S. 63/366,492). A second neural network may be trained for setups prediction, according to any of the setups prediction techniques of the present disclosure (or a combination of any two or more of the techniques described herein). Transfer learning may transfer at least a portion of the knowledge or capability of the first neural network to the second neural network. As such, transfer learning may provide the second neural network an accelerated training phase to reach convergence. In some implementations, the training of the second network may, after being augmented with the transferred learning, then be completed using one or more of the techniques of this disclosure.

Systems of this disclosure may train ML models with representation learning. The advantages of representation learning include the fact that the generative network (e.g., neural network that predicts a transform for use in setups prediction) can be configured to receive input with a known size and/or standard format, as opposed to receiving input with a variable size or structure. Representation learning may produce improved performance over other techniques, because noise in the input data may be reduced (e.g., because the representation generation model extracts hierarchical neural network features and/or reconstruction characteristics of an inputted representation (e.g., a mesh or point cloud) through loss calculations or network architectures chosen for that purpose).

Reconstruction characteristics may comprise values in of a latent representation (e.g., a latent vector) that describe aspects of the shape and/or structure of the 3D representation that was provided to the representation generation module that generated the latent representation. The weights of the encoder module of a reconstruction autoencoder, for example, may be trained to encode a 3D representation (e.g., a 3D mesh, or others described herein) into a latent vector representation (e.g., a latent vector). Stated another way, the capability to encode a large set (e.g., hundreds, thousands or millions) of mesh elements into a latent vector (e.g., of hundreds or a thousand real values—e.g., 512, 1024, etc.) may be learned by the weights of the encoder. Each dimension of that latent vector may contain a real number which describes some aspect of the shape and/or structure of the original 3D representation. The weights of the decoder module of the reconstruction autoencoder may be trained to reconstruct the latent vector into a close fascimilie of the original 3D representation. Stated another way, the capability to interpret the dimensions of the latent vector, and to decode the values within those dimensions, may be learned by the decoder. In summary, the encoder and decoder neural network modules are trained to perform the mapping of a 3D representation into a latent vector, which may then be mapped back (or otherwise reconstructed) into a 3D representation that is substantially similar to an original 3D representation for which the latent vector was generated.

Returning to loss calculation, examples of loss calculation may include KL-divergence loss, reconstruction loss or other losses disclosed herein. Representation learning may reduce the size of the dataset required for training a model, because the representation model learns the representation, enabling the generative network to focus on learning the generative task. The result may be improved model generalization because meaningful neural network features of the input data (e.g., local and/or global features) are made available to the generative network. Stated another way, a first network may learn the representation, and a second network may make the predictive decision. By training two networks to perform their own separate tasks, each of the networks may generate more accurate results for their respective tasks than with a single network which is trained to both learn a representation and make a decision. In some instances, transfer learning may first train a representation generation model. That representation generation model (in whole or in part) may then be used to pre-train a subsequent model, such as a generative model (e.g., that generates transform predictions). A representation generation model may benefit from taking mesh element features as input, to improve the capability of a second ML module to encode the structure and/or shape of the inputted 3D oral care representations in the training dataset.

One or more of the neural networks models of this disclosure may have attention gates integrated within. Attention gate integration provides the enhancement of enabling the associated neural network architecture to focus resources on one or more input values. In some implementations, an attention gate may be integrated with a U-Net architecture, with the advantage of enabling the U-Net to focus on certain inputs, such as input flags which correspond to teeth which are meant to be fixed (e.g., prevented from moving) during orthodontic treatment (or which require other special handling). An attention gate may also be integrated with an encoder or with an autoencoder (such as VAE or capsule autoencoder) to improve predictive accuracy, in accordance with aspects of this disclosure. For example, attention gates can be used to configure a machine learning model to give higher weight to aspects of the data which are more likely to be relevant to correctly generated outputs. As such, and because a machine learning model configured with these attention gates (or mechanisms) utilizes aspects of the data that are more likely to be relevant to correctly generated outputs, the ultimate predictive accuracy of those machine learning models is improved.

The quality and makeup of the training dataset for a neural network can impact the performance of the neural network in its execution phase. Dataset filtering and outlier removal can be advantageously applied to the training of the neural networks for the various techniques of the present disclosure (e.g., for the prediction of final setups or intermediate staging, for mesh element labeling or a neural network for mesh in-filling, for tooth reconstruction, for 3D mesh classification, etc.), because dataset filtering and outlier removal may remove noise from the dataset. And while the mechanism for realizing an improvement is different than using attention gates, that ultimate outcome is that this approach allows for the machine learning model to focus on relevant aspects of the dataset, and may lead to improvements in accuracy similar to improvements in accuracy realized vis-à-vis attention gates.

In the case of a neural network configured to predict a final setup, a patient case may contain at least one of a set of segmented tooth meshes for that patient, a mal transform for each tooth, and/or a ground truth setup transform for each tooth. In the case of a neural network to predict a set of intermediate stage setups, a patient case may contain at least one of a set of segmented tooth meshes for that patient, a mal transform for each tooth, and/or a set of ground truth intermediate stage transforms for each tooth. In some implementations, a training dataset may exclude patient cases which contact passive stages (i.e., stages where the teeth of an arch do not move). In some implementations, the dataset may exclude cases where passive stages exist at the end of treatment. In some implementations, a dataset may exclude cases where overcrowding is present at the end of treatment (i.e., where the oral care provider, such as an orthodontist or dentist) has chosen a final setup where the tooth meshes overlap to some degree. In some implementations, the dataset may exclude cases of a certain level (or levels) of difficulty (e.g., easy, medium and hard).

In some implementations, the dataset may include cases with zero pinned teeth (or may include cases where at least one tooth is pinned). A pinned tooth may be designated by a technician as they design the treatment to stop the various tools from moving that particular tooth. In some implementations, a dataset may exclude cases without any fixed teeth (conversely, where at least one tooth is fixed). A fixed tooth may be defined as a tooth that shall not move in the course of treatment. In some implementations, a dataset may exclude cases without any pontic teeth (conversely, cases in which at least one tooth is pontic). A pontic tooth may be described as a “ghost” tooth that is represented in the digital model of the arch but is either not actually present in the patient's dentition or where there may be a small or partial tooth that may benefit from future work (such as the addition of composite material through a dental restoration appliance). The advantage of including a pontic tooth in a patient's case is to leave space in the arch as a part of a plan for the movements of other teeth, in the course of orthodontic treatment. In some instances, a pontic tooth may save space in the patient's dentition for future dental or orthodontic work, such as the installation of an implant or crown, or the application of a dental restoration appliance, such as to add composite material to an existing tooth that is too small or has an undesired shape.

In some implementations, the dataset may exclude cases where the patient does not meet an age requirement (e.g., younger than 12). In some implementations, the dataset may exclude cases with interproximal reduction (IPR) beyond a certain threshold amount (e.g., more than 1.0 mm). The dataset to train a neural network to predict setups for clear tray aligners (CTA) may exclude patient cases which are not related to CTA treatment. The dataset to train a neural network to predict setups for an indirect bonding tray product may exclude cases which are not related to indirect bonding tray treatment. In some implementations, the dataset may exclude cases where only certain teeth are treated. In such implementations, a dataset may comprise of only cases where at least one of the following are treated: anterior teeth, posterior teeth, bicuspids, molars, incisors, and/or cuspids.

The mesh comparison module may compare two or more meshes, for example for the computation of a loss function or for the computation of a reconstruction error. Some implementations may involve a comparison of the volume and/or area of the two meshes. Some implementations may involve the computation of a minimum distance between corresponding vertices/faces/edges/voxels of two meshes. For a point in one mesh (vertex point, mid-point on edge, or triangle center, for example) compute the minimum distance between that point and the corresponding point in the other mesh. In the case that the other mesh has a different number of elements or there is otherwise no clear mapping between corresponding points for the two meshes, different approaches can be considered. For example, the open-source software packages CloudCompare and MeshLab each have mesh comparison tools which may play a role in the mesh comparison module for the present disclosure. In some implementations, a Hausdorff Distance may be computed to quantify the difference in shape between two meshes. The open-source software tool Metro, developed by the Visual Computing Lab, can also play a role in quantifying the difference between two meshes. The following paper describes the approach taken by Metro, which may be adapted by the neural networks applications of the present disclosure for use in mesh comparison and difference quantification: “Metro: measuring error on simplified surfaces” by P. Cignoni, C. Rocchini and R. Scopigno, Computer Graphics Forum, Blackwell Publishers, vol. 17(2), June 1998, pp 167-174.

Some techniques of this disclosure may incorporate the operation of, for one or more points on the first mesh, projecting a ray normal to the mesh surface and calculating the distance before that ray is incident upon the second mesh. The lengths of the resulting line segments may be used to quantify the distance between the meshes. According to some techniques of this disclosure, the distance may be assigned a color based on the magnitude of that distance and that color may be applied to the first mesh, by way of visualization.

The setups prediction techniques described herein may generate a transform to place a tooth in a setup pose. Such a predicted transform may entail both the position and the orientation of the tooth, which is a significant improvement over existing techniques which use one neural network to generate a position prediction and another neural network to generate a pose prediction. In setups prediction, the predicted position and the predicted orientation affect each other. Generating the predicted position and the predicted orientation substantially concurrently offers improvements in predictive accuracy relative to generating predicted position and predicted orientation separately (e.g., predicting one without the benefit of the other).

The MLP Setups, VAE Setups, and Capsule Setups models of the present disclosure improve upon existing techniques with the addition of (among other things) a latent space input: either the latent space vector A of an oral care mesh or the latent capsule T of an oral care mesh. Prior setups prediction techniques did not train a reconstruction autoencoder to generate representations of teeth, and therefore could not verify the correctness of their outputs. The advantage of using a reconstruction autoencoder to generate tooth representations is that the latent representation (e.g., A or T) may be reconstructed by the reconstruction autoencoder. Reconstruction error (as described herein) may be computed, to demonstrate the correctness of the latent encoding (e.g., to demonstration that the latent representation correctly describes the shape and/or structure of the tooth). Results with a high reconstruction error may be excluded from downstream (e.g., further or additional) processing, which leads to a more accurate system as a whole. Either or both of A and T may be reconstructed (via a decoder) into a facsimile of an inputted oral care 3D representation (e.g., an inputted tooth mesh). One or more latent space vectors A (or latent capsules T) may be provided to the MLP Setups model. One or more latent space vectors A (or latent capsules T) may also be provided to the VAE Setups model. One or more latent capsules T (or latent vectors A) may also be provided to the Capsule Autoencoder Setups model.

The latent space vector A (or latent capsule T) for a tooth mesh (which may comprise thousands of interconnected mesh elements) describes the reconstruction characteristics of that tooth mesh in a compact form, for example a vector of length N (e.g., where in one example N=128). This latent space vector A (or latent capsule T) may be reconstructed into a close facsimile of the input tooth mesh through the operation of a decoder that has been trained for that task. The latent space vector A (or latent capsule T) is powerful because, although A (or T) is relatively extremely compact, A (or T) describes sufficient characteristics of the inputted oral care mesh (e.g., tooth mesh) to enable such a reconstruction of that oral care mesh (e.g., tooth mesh). In some implementations, the latent space vector A (or latent capsule T) can be used as an additional input to predictive or generative models of this disclosure. The latent space vector A (or latent capsule T) can be used as an additional input to at least one of an MLP, an encoder, a transformer, a regularized autoencoder, or a VAE of this disclosure. The latent space vector A (or latent capsule T) can be used as an input to the GDL Setups model described in the present disclosure. Furthermore, the latent space vector A (or latent capsule T) can be used as an input to the RL Setups model described in the present disclosure. The advantage of training a setups prediction neural network to take a latent space vector A (or latent capsule T) as an input is to provide information about the reconstruction characteristics of the tooth mesh to the network. Reconstruction characteristics may contain information about local and/or global attributes of the mesh. Reconstruction characteristics may include information about mesh structure. Information about shape may, in some instances, be included. An awareness of these reconstruction characteristics may better enable the trained setups prediction model to predict a final setup or intermediate staging, thereby providing the technical improvement of improved data precision. A further advantage of using the latent space vector A (or latent capsule T) is the vector's size. A neural network may encode an understanding of the input mesh and pose data more resource-efficiently if those data are presented in a compact form (such as a vector of 128 real values), as opposed to inputting the full mesh (which may contain thousands of mesh elements). The latent representation of a mesh (or multiple meshes) may provide a more favorable signal-to-noise ratio than the original form of that mesh or those meshes, thereby improving the capability of a subsequent ML model (such as a neural network or SVM) to form predictions, draw inferences, and/or otherwise generate outputs (such as transforms or meshes) based on the input mesh(es).

FIG. 2 shows how some of various setups prediction models can take as input either 1) tooth meshes, 2) latent space vectors (or latent capsules) which represent tooth meshes in reduced-dimensionality form, or tooth transforms.

Diffusion models are a class of deep generative neural networks which may be trained to generate transformations (e.g., may be used to modify the positions or orientations of 3D representations in 3D space), generate images, generate 3D representations (e.g., such as point clouds, 3D meshes or voxelized representations), or other 3D oral care representations. Diffusion models may be implemented using one or more encoders, one or more MLPs, one or more autoencoders, one or more U-Nets, among other machine learning models. In some implementations, a diffusion model may take, as input, a doctor's treatment plan (comprising, at least, a set of one or more procedure parameters, zero or more doctor preferences and zero or more text samples which describe the nature of the intended oral care treatment-such as a final setup or a restoration design generation), and also take, as input, one or more 3D representations of teeth (e.g., a full arch of segmented teeth in maloccluded poses). In some implementations, a diffusion model may be trained to generate a setup, such as a final setup, which satisfies the specification described by the procedure parameters and/or text. Such a model may be termed a Diffusion Setups neural network or Diffusion Setups model. A diffusion model which conditions on text may use a neural network to reformat and/or reduce the dimensionality of that text, for example, to generate a latent encoding or latent embedding of the text (e.g., using a transformer or an encoder).

A diffusion model may comprise at least one of a forward pass and a reverse pass. The forward pass of the diffusion model may generate training data by iteratively adding noise (e.g., Gaussian noise) to a received 3D oral care representation (e.g., a tooth transform or a point cloud representation of a tooth restoration design). The reverse pass of the diffusion model may further operate through an iterative denoising process (e.g., such as using a U-Net trained for the purpose), which iteratively removes noise from a received 3D oral care representation (e.g., a tooth transform or a point cloud representation a tooth restoration design). Such tooth transforms may define the poses of the teeth in one or more arches. A Diffusion Setups model may generate a setup (such as a final setup or intermediate stage). This iterative denoising of a Diffusion Setups model may operate on one or more latent vectors TA which are trained on tooth transform information. The latent vectors TA contain reduced-dimensionality information about the one or more tooth transforms. These latent vectors TA may, in some implementations, be conditioned on latent vectors A which correspond to the one or more 3D representations of teeth. A diffusion model which receives one ore more 3D representations of teeth may be trained for generating tooth restoration designs (e.g., such as with GGDM-which may also be trained to generate other types of 3D oral care representations, such as appliance components, transforms, or trimlines). These latent vectors TA may also be conditioned on one or more procedure parameters K and/or one or more doctor preferences L. Such conditioning may be implemented, for example, by concatenating a latent vector TA with K, L, or any of the other model inputs described in this disclosure, such as M, N, O, R, S, P, Q, U, V.

Internally to the diffusion model, a latent vector TA (e.g., which may have been generated using an encoder) may undergo many iterations of noise through the course of the forward pass. The series of increasingly noisy versions of TA may be used to train, at least in part, a denoising diffusion neural network (e.g., such as an autoencoder or a U-Net). The latent vector TA may start out as Gaussian noise at the beginning of the reverse pass. Through the several iterations of the diffusion model reverse pass process (e.g., using a trained U-Net or autoencoder), TA may evolve into a form that may be reconstructed (e.g., using a decoder) into one or more transforms which may place one or more teeth into a setup configuration (e.g., a final setup or an intermediate stage).

In some implementations, a Setups Diffusion model may use a U-Net architecture with ResNet blocks and self-attention layers as a part of the reverse pass. A ResNet block refers to a residual block, where the activation of one layer in the neural network is forwarded directly to a subsequent deeper layer, with the advantage of enabling deeper networks to be trained. The self-attention layers make use of an attention mechanism which relates different portions of a sequence (i.e., the sequence of intermediate stages) in order to compute a representation of that same sequence. Self-attention is advantageous to intermediate staging prediction, in that each stage of the sequence may be updated or refined with information about other stages in the sequence, as the diffusion model iterates. The diffusion model for setups transforms prediction may be trained through gradient descent and/or backpropagation. In some implementations, the losses described elsewhere in this disclosure may be used to train, at least in part, the Setups Diffusion model. Either or both of L1 and L2 losses may, in some implementations, play a role in loss calculation.

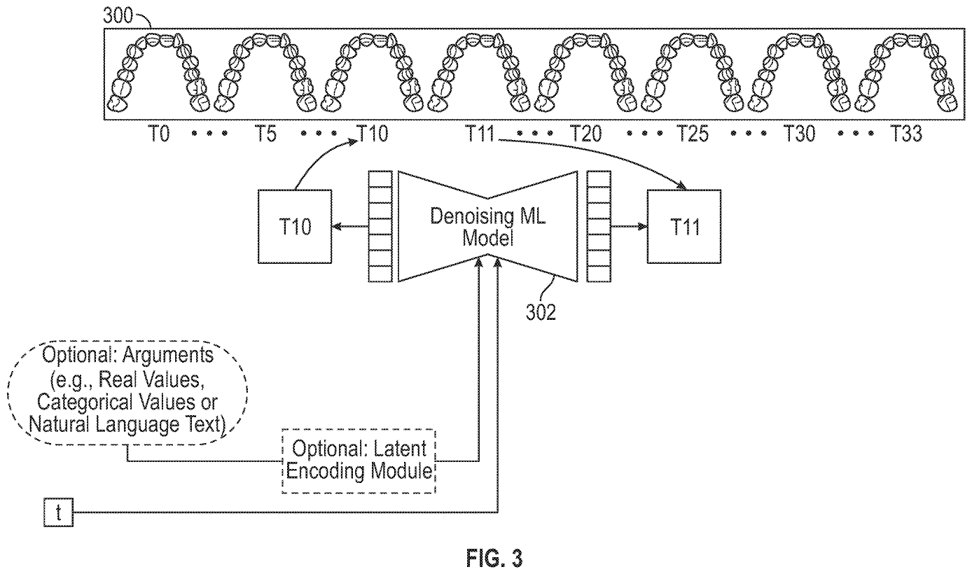

Example of Diffusion model for setups prediction: FIG. 3 shows how the Denoising Diffusion Setups model may be trained on a patient case consisting of 34 stages. Transforms (T0 through T33) 300 from different stages in the sequence are iteratively used to train the autoencoder (or U-Net) 302 at the center of the reverse pass of the diffusion model. A transform may comprise a 4×4 affine transform, although it will be appreciated that other dimensions are also compatible with the diffusion model-based techniques of this disclosure. In some instances, a transform may include one or more translation vectors, one or more Euler angles and/or one or more quaternions. The “t” input is a time representation, which controls which time point (i.e., stage) is sampled during a given timestep of diffusion model training (e.g., the training of the denoising neural network). The input “t” is used for positional encoding. The use of positional encoding, similar to that used in transformers, enables the model to be aware of the relative positions of the stages in the treatment plan sequence. Through this approach, the model can learn how to progress an orthodontic treatment from stage to stage, leveraging what the Diffusion model has learned from prior orthodontic treatment examples in the training dataset.

The similarity setups prediction method involves a search for case data which bears a similarity to one or more trial cases. A trial maloccluded setup is designated S4, and the corresponding predicted final setup is designated S5. A datastore of patient case data contains maloccluded arches and corresponding ground truth final setups arches. An example maloccluded arch from the datastore is designated S6, and the corresponding ground truth final setup is designated S7. A final setup for S4 is predicted by drawing upon ground truth final setups data from one or more similar cases from the datastore.

A datastore may store data in structure or unstructured form. Example datastores may be any one or more of a relational database management system, online analytical processing database, table, network file share, folder in a cloud storage drive or on a hard drive, or any other suitable structure for storing data.

This setups technique may involve a search of a datastore of patient cases (each comprising a respective upper arch and/or lower arch) to find the k patient cases S6 which are most similar to a trial case S4. This similarity measure can take a number of different forms. One or more of the following methods and/or operations can be executed in the calculation of setups similarity (aka arch similarity), which seeks to compare two or more arches (e.g., S4 against S6), for example, to find maloccluded arches which are similar. Once it is established that S6 is similar to S4, then S7 can be used to contribute to the calculation of S5. In some implementations, when k==1, S5 may be set to be equal to S7. In other instances when k==1, S5 may be set to a modified version of S7 (perhaps modified using output from one or more other setups prediction methods, such as GDL Setups, RL Setups, VAE Setups, Capsule Setups, MLP Setups, Diffusion Setups, PT Setups, Similarity Setups and FDG Setups). In the event that k>1, then S5 may be set to the average of the k S7 arches (alternatively, a method other than averaging could be used to combine the k S7 arches). K-Nearest Neighbors (k-NN) may in some implementations, be used to compare S4 to S6 and/or to quantify the difference between S4 and S6.

The similarity between S4 and S6 may be computed by one or more different methods. The following techniques may be used in isolation or in combination with one another. In some implementations, one or more of the metrics from elsewhere in this disclosure may be computed to quantify the difference between S4 and S6, so that the similarity of S4 and S6 can be determined and used for Similarity Setups. In some implementations, tooth identity may be used to establish similarity between S4 and S6 (e.g., in the case that the search for an S6 is restricted to only include one or more of the teeth which appear in S4). For example, if S4 contains all teeth except for the 3^{rd} molars (i.e., S4 contains the standard 28 teeth), then the search for an S6 may in some implementations be restricted to only the cases which contain those 28 teeth.

In some implementations, a similarity between S4 and S6 may be computed, at least in part, by at least one of a Point-wise Mesh Euclidean Distance (PMD), an Earth Mover's Distance (EMD) and a Chamfer Distance (CD), where that similarity is then used for Similarity Setups. PMD, EMD and/or CD may be used to compare the mesh elements (such as vertices) of S4 and S6.

In some implementations, the archform of S4 and S6 may be compared in the course of similarity comparison. An archform may be represented using a set of nodes (or control points), a set of vertices and/or edges, a curve, a B-spline, a NURBS surface, a 3D mesh, or another kind of geometry that describes the curve of the arch. PMD, EMD and/or CD may be used to compare the archform representations of S4 and S6, so that the similarity of S4 and S6 can be determined and used for Similarity Setups. In some implementations, 3D keypoints and/or 3D descriptors (such as those described elsewhere in this disclosure) may be computed for S4 and S6 and used to determine a similarity match for use in the similarity setups prediction techniques of this disclosure. In some instances, the Setups Comparison Tool described herein may compare S4 and S6, to determine a similarity match for use in Similarity Setups. In some implementations, one of the methods described elsewhere in this disclosure may compare S4 and S6, to determine a similarity match for use in Similarity Setups. In some implementations, an overlap may be computed between two or more teeth at the closure of arches S4 and S6 (e.g., between the central incisors of S4 and S6, or between the upper left 2nd bicuspid of S4 and the upper left 2nd bicuspid of S6). The greater the overlap, the greater the similarity match. Overlap may be computed as an overlap in 3D volume, an overlap in surface area, an overlap in the shadow cast onto a plane (such as the XY plane), among others. In some implementations, deep features may be computed between two or more teeth between S4 and S6, and be used by a Setups Classifier neural network to find one or more S6 which are similar to S4. These deep features may include at least one feature from the following deep feature types: pose features, mesh element features, and 3D keypoints/3D descriptors.

In some implementations, patient cases may be clustered using the metrics described elsewhere in this disclosure, for the purpose of identifying j standard setup configurations. In some instances, the data from the patient cases in one of those j clusters may be averaged or otherwise combined to form one or more standard or typical setups examples for that cluster. Such an averaged or typical cluster setup may be used for the output S7, in the event that an input setup S4 matches well to that cluster.

Each tooth in an arch has a local coordinate system. Similarity Setups may benefit for having a standard method of assigning a coordinate system to each tooth. In some implementations, the same automated and/or machine learning method may be used to apply the coordinate system to each tooth in each patient case in the datastore, with the advantage of standardizing the coordinate systems. Such standardization can be bolstered by having a standard setup of guidelines for applying a coordinate system to a tooth. With greater standardization in the application of local coordinate systems, the better the outcome of Similarity Setups. If S4 and S6 both have standard local coordinate systems (i.e., coordinate systems which are applied to the teeth in the same way), then the transforms which are able to transform S6 into S7 will be effective in transforming S4 and S5.

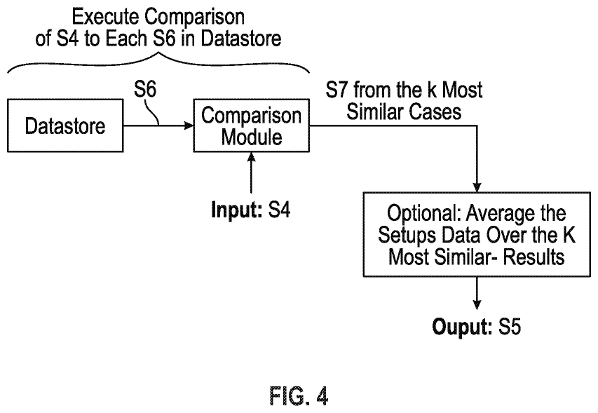

In some implementations, latent space representations may be used to facilitate similarity comparisons. In some instances, the meshes of the setups arches S4 and S6 may be encoded into one or more latent space forms, such as a latent vector (via a variational autoencoder) or a latent capsule (via a capsule autoencoder). In some implementations, the latent space form of the arch mesh(es) may be used for finding a match between S4 and S6. In some implementations, the latent space form of the arch mesh(es) may be used for the clustering application mentioned above (e.g., arches may be encoded into latent space form and then clustered, for the purpose of creating clusters that can be used for Similarity Setups). Two or more latent vectors (or latent capsules) may be compared using L2 distance, L1 norm, PMD, EMD and/or CD, in order to find a match. Such distances are generally to be minimized. FIG. 4 shows an overview of Similarity Setups.

The step that involves averaging the k most-similar cases may entail computing the average for one or more tooth transforms. For example, in the event that k==2, and both of the S6 in that collection have the same 28 teeth, the mal-to-final-setup transform for each tooth may be averaged between each of the S6 in that collection. For example, the mal-to-final-setup transform for the upper left cuspid of the first S6 may be averaged with the mal-to-final-setup transform for the upper left cuspid of the second S6, and the resulting averaged transform be used as the mal-to-final-setup transform in the output S5. Other methods of combining and/or averaging the set k setups are possible.

GDL Setups may use a U-Net architecture, an encoder structure or a pyramid encoder-decoder structure to predict a final setup (or an intermediate stage) for orthodontic treatment with clear tray aligners or indirect bonding trays.

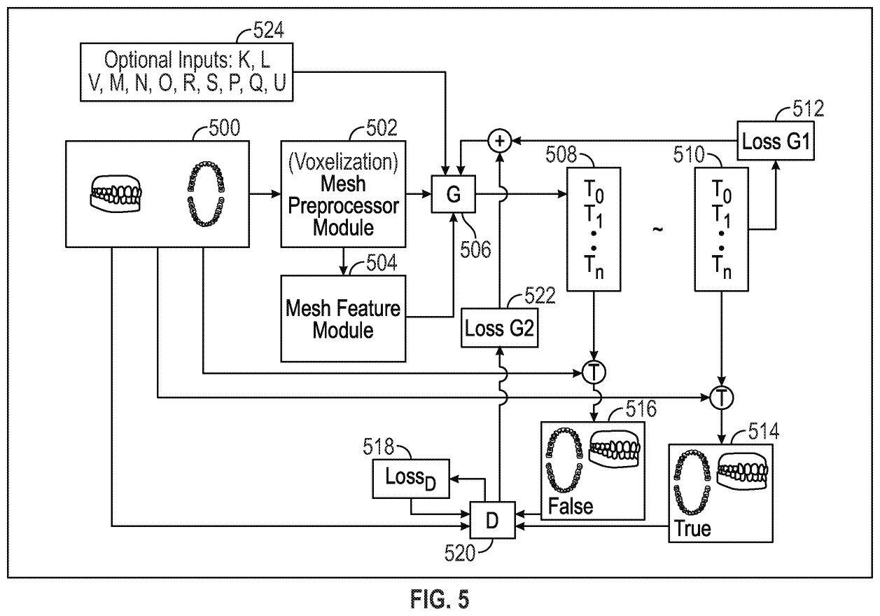

FIG. 5 shows an example training method for the ML techniques of the present disclosure which may be trained to generate transforms for 3D oral care representations. The method of FIG. 5 may train a model to predict setups transforms for an arch of teeth, predict a local coordinate system for a tooth, predict a transform to place a hardware element on a tooth, predict a transform to place an appliance or appliance component on a tooth, or to place some other oral care mesh in relation to another oral care mesh. In the example method shown in FIG. 5, oral care meshes 500 (e.g., dental arches comprising multiple segmented teeth in mal poses) may be received as input. The tooth meshes may undergo processing to organize mesh elements into lists and, in the case of sparse processing, optionally be converted to voxels by the mesh preprocessor module 502. An optional mesh element feature vector may be computed for each mesh element by mesh element feature module 504. Optional inputs 524 (described elsewhere in this disclosure) may be provided to the generator 506, with the advantage of improving the ability of the generator 506 to customize outputs. The predicted transform 508 is produced by the generator 506 and compared to the corresponding ground truth transform 510 (e.g., a predicted setup of teeth is compared numerically to a ground truth setup of teeth). The resulting loss G1 is fed back (512) to be used in training the generator 506, for example, by backpropagation. In this manner, the generator 506 may be trained to predict setups transforms (or other transforms for other types of 3D oral care representations which are present in the training data—such as appliance components or fixture model components). The generator 506 may be implemented, at least in part using an encoder, a U-Net, a transformer (e.g., comprising at least one of a transformer encoder and a transformer decoder, such as a GPT2 decoder), an autoencoder, a pyramid encoder-decoder, or a multilayer perceptron (e.g., 4 fully connected layers with optional skip connections). In some implementations, additional training of the generator 506 may be achieved through the use of a discriminator 520, which may be trained using a LossD 518 to distinguish between predicted setups 516 and ground truth setups 514. The discriminator 520 may output a loss G2 522 which may, in some implementations, be combined with loss G1 (512), and used to train the generator 506, with the technical enhancement of improving data precision and accuracy.

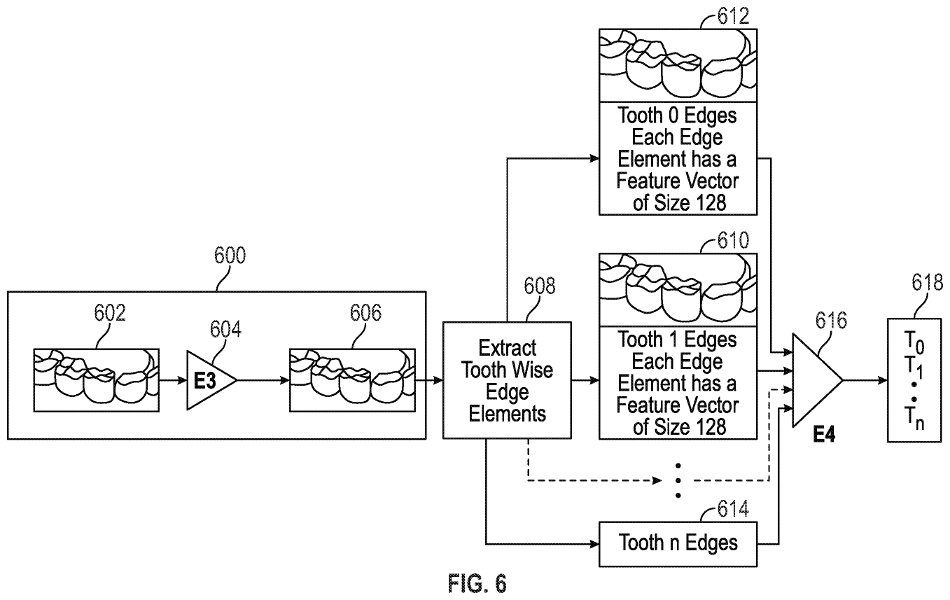

FIG. 6 shows an example implementation of generator 606. In the case of setups prediction, the tooth meshes of the mal setup 602 are provided to a module 604 (e.g., which may comprise a U-Net, an encoder, a transformer encode, a transformer decoder, or a pyramid encoder-decoder, among others) which converts the tooth meshes 602 into a form 606 (e.g., a representation which includes hierarchical neural network features-such as global, intermediate or local features) which may be further processed by module 608, which may extract tooth-wise mesh elements (e.g., edges, faces, vertices, points or voxels). Each mesh element may optionally have a mesh element feature vector computed (612, 610, 614, etc.). These mesh elements 608 (and optional associated mesh feature vectors) may be received by a module 616 (e.g., an encoder or a set of fully connected layers), which may generate a transformation prediction 618. Some implementations may operate on edges, while other implementations may operate on other mesh elements (and their corresponding mesh element feature vectors) in this method. In still other variants of this method, module 600 may use module 604 to generate an embedding vector which is directly provided to the module 616, resulting in a transformation prediction 618. Such a transformation prediction may be used for setups prediction.

FIG. 5 is an example architecture for GDL Setups. Dental arches in a maloccluded configuration are taken as inputs (mal transforms may in some instances be provided separately). Other optional inputs may customize the setup to the treatment needs of the patient, including procedure parameters K, doctor preferences L, flags M (such as indicating fixed or pinned teeth), tooth position info N, tooth orientation info O, tooth name/designation information R, one or more orthodontic metrics S, tooth dimension info P, distance between adjacent teeth Q and IPR info U (such as the amount of mesial and/or distal IPR applied to each tooth in mm). In some implementations, either or both of a latent vector A and a latent capsule T may be provided to the generator. In some implementations, archform information V may be provided to the generator.

FIG. 6 shows a non-limiting example generator architecture for GDL Setups. Dental arches in a maloccluded configuration are taken as inputs (mal transforms may in some instances be provided separately). Other optional inputs include procedure parameters K, doctor preferences L, flags M (such as indicating fixed or pinned teeth), tooth position info N, tooth orientation info O, tooth name/designation information R, one or more orthodontic metrics S, tooth dimension info P, distance between adjacent teeth Q and IPR info U. In some implementations, E3 may be replaced by a U-Net or by a pyramid encoder-decoder. In some implementations, E4 may be replaced by a transformer or by a series of fully connected layers. In some implementations, the encoder, the U-Net or pyramid encoder-decoder for generating the tooth representation may be trained to generate the representation on one or more teeth. Such a model may be trained on all teeth in both arches, only the teeth within the same arch (either upper or lower), only anterior teeth, only posterior teeth, or some other subset of teeth. In some implementations, such a model may be trained on each individual tooth (e.g., an upper right cuspid), so that the model gets really good at generating a representation for an individual tooth. In some implementations, archform information V may be provided to the generator.

The architecture may contain elements of the following. The mal arch (or maloccluded arch) S1 is input to the model. For each tooth, a mesh feature vector is computed for each mesh element, such as a vertex or an edge or face. In this example, vertex mesh elements are considered. Spatial features, such as XYZ coordinates may be concatenated onto the computed feature vector. The mesh elements (and associated feature vectors) for all teeth in the arch are concatenated and provided to the U-Net. The U-Net encodes the local and global information of for each mesh element. The output of the U-Net is then concatenated with the spatial features and provided to the encoder structure. Whereas all the mesh element information for the entire arch is provided to the U-Net at the same time, the encoder structure processes the mesh elements for each tooth individually. The output of the encoder structure is a transformation (e.g., as a 3×3 matrix) for the inputted tooth. Other types of outputs are possible. The 3×3 matrix is converted to a 4×3 matrix. two rows of the 3×3 matrix are used to two vectors can be used to compute a valid coordinate system with 3 orthogonal axes using the Gram Schmidt process (a process of orthoganizing a set of vectors in an inner product space), the remaining row corresponds to the translation vector for the tooth. The result is a 4×3 transformation matrix. In some implementations, the transformation matrix may be converted to a 4×4 matrix by appending zeros. Other implementations may encode rotational transformations in other forms, such as quaternions or Euler angles. Transformations (including rotational transformations, translational transformations and combinations thereof) can be defined with respect to local (tooth) coordinate systems, or with respect to global (whole arch) coordinate systems. The term mesh should be considered in a non-limiting sense to be inclusive of 3D representations such as: 3D mesh, 3D point cloud and 3D voxelized representation.

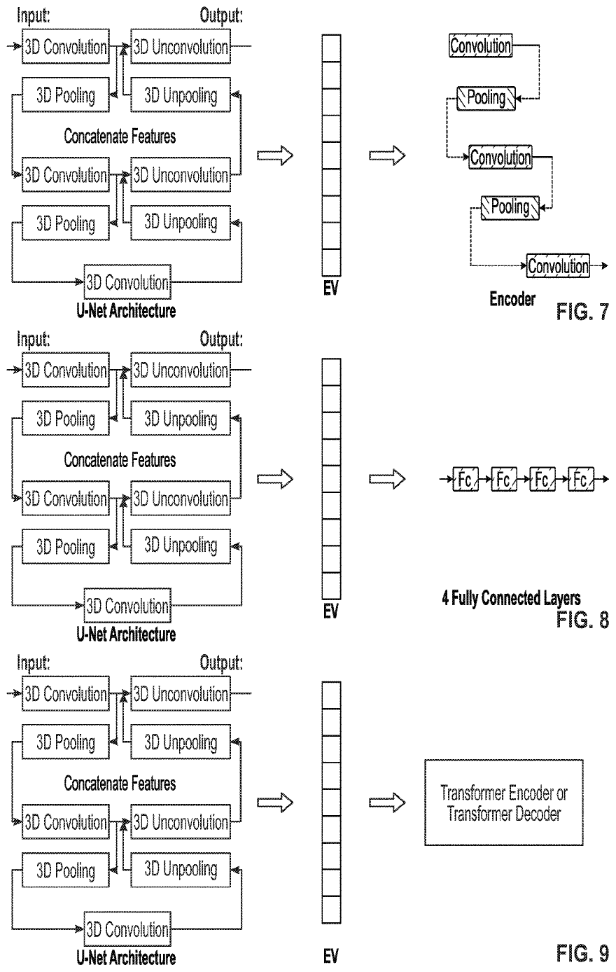

In some implementations, an encoder structure may be used to predict a transformation for each tooth in an arch, for the prediction of a setup. An encoder structure may be combined with a decoder structure, wherein the output of one or more levels of the encoder structure are input to one or more of the inputs of a decoder structure. U-Net architecture is the result of a combination of an encoder structure with a decoder structure, as shown in FIG. 7, 8 or 9. In some implementations, the U-Net architecture is followed by an encoder structure that outputs a transform for a tooth. This transform is applied to a tooth mesh, to move that tooth into a predicted setup position. In some implementations, the U-Net architecture is followed by a transformer that outputs a transform for one or more teeth. A transformer is advantageous in that a transformer can generate multiple teeth at once, taking into account the physical interactions between teeth. A transformer could, in some implementations, generate transforms for all teeth in the arch at once, while taking into account interactions between the teeth. In some implementations, a generator comprises a U-Net and is at least partially trained using a discriminator neural network. In other implementations, a generator comprises of an encoder structure.

The advantage of a U-Net is to extract both local and global information for each mesh element in a tooth mesh. advantage of an encoder structure is to extract both local and global information for the tooth mesh as a whole, rather than for each individual mesh element. a further advantage of a U-Net is to perform feature selection for the features which are to be consumed by an encoder which consumes the output of the U-Net.

In other implementations, such as in FIG. 6, the first encoder 604 of FIG. 6 may directly output the tooth transforms for the several teeth of one or more arches. In still other implementations, the first encoder 604 in FIG. 6 may be replaced by a transformer encoder (or transformer decoder), which may directly output the tooth transforms for the several teeth of one or more arches. In still other implementations, the transformer may be trained to act as a preprocessor for the tooth data and be trained to generate an embedding vector (or alternatively, a latent vector), which may then be provided to another machine learning model which may be trained to output one or more setups transforms. In some implementations, the mesh preprocessor module (which may, in some implementations, convert the mesh elements of the inputted 3D oral care representation(s) into lists which are convenient for the generator to consume) and mesh element feature module from FIG. 5 may also be applied to the inputs of the network in FIG. 6. In some implementations, the methods in each of FIGS. 5 and 6 may implement sparse processing and operate on voxelized mesh data, in which case the mesh pre-processor may convert the input mesh data into voxels.

In some implementations, the generator may follow the general pyramid encoder-decoder structure shown in Provisional U.S. Patent Application No. 63/264,914, the entire disclosure of which is incorporated herein by reference in its entirety.

Mesh pooling down-samples the count of mesh elements in the mesh while aggregating features related to each mesh element into features that contain information from other mesh elements (i.e., mesh elements which have contributed to the pooling). Mesh pooling is generally local at a layer in the neural network, pertaining to a small neighborhood around each mesh element. Global mesh pooling pertains to the entire tooth, rather than a small neighborhood. Mesh unpooling reverses the mesh pooling procedure by unpacking the information that each reduced-resolution mesh element contains into information that can apply to multiple mesh elements in the higher (or original) resolution mesh.

Mesh convolution aggregates information from a local neighborhood of mesh elements using a kernel. Mesh convolution is learnable using kernels.

A coordinate normalization layer is a layer in the neural network which can be used to generate normalized positional information for mesh elements, which can then be concatenated with other features and fed into another layer in the neural network. An example of coordinate normalization is found in (“An intriguing failing of convolutional neural networks and the CoordConv solution” Rosanne Liu, Joel Lehman, Piero Molino, Felipe Petroski Such, Eric Frank, Alex Sergeev, Jason Yosinski. NeurIPS 2018), the entire disclosure of which is incorporated herein by reference.

A GDL Setups generator may comprise of one or more elements, including U-Nets, encoders, decoders, fully connected layers, transformers, autoencoders, embedding vectors (or latent vectors) or pyramid encoder-decoders. FIGS. 7-9 show a few non-limiting generator designs. FIG. 7 shows a U-Net+EV+encoder architecture. FIG. 8 shows a U-Net+EV+MLP architecture. FIG. 9 shows a U-Net+EV+transformer architecture.

Some implementations of the 3D U-Net (e.g., the U-net used for GDL Setups prediction) may incorporate drop-out layers into either or both of the encoder and decoder components, which is an improvement over existing techniques, because the dropout enables the U-Net to counteract the effects of overfitting. Some implementations may also utilize normalization layers.

The embedding vector (EV) output by the U-Net encodes global and local information from the input mesh. The advantage of the EV is that all of these global and local mesh characteristics are encoded in a succinct data structure, a data structure which is easily consumable by a later ML model, for example, for classification (i.e., in the case of mesh segmentation and mesh element labeling models which label mesh elements with class labels) or output generation (i.e., in the case of a setup prediction model that feeds the output of a U-Net structure to an MLP, Transformer or Encoder to generate one or more transforms to place one or more teeth into a setups pose—either for a final setup or an intermediate stage).

The spatial and/or structural features described elsewhere in this disclosure may be applied to the inputs of the GDL Setups, as with the other setups prediction models. These features may be provided to the input of the generator and/or discriminator. The features may also be provided to one or more of the layers internal to either of the generator or the discriminator.

In some implementations, spatial features are concatenated onto the lists of mesh elements which are provided to the generator. The spatial features are computed based on the provided coordinates. Spatial features may include the XYZ vertices of the mesh. The vertices may be normalized to have a normal distribution or may be normalized to be bound to a unit sphere, among other examples. The advantage of this type of spatial feature is that the spatial features can be injected into selected layers of the network, not only at the input layer. Input mesh features are concatenated with spatial features, and the resulting vectors of mesh element features go into the U-Net for processing. Spatial features are also concatenated with the output of the U-Net, for input to the Encoder.

A tooth mesh or set of tooth meshes may be converted to a voxelized form before being provided to the generator. In some implementations, for the purposes of the present disclosure, a voxel may be considered to be a type of mesh element (alongside vertices, faces and edges). This conversion may be formed by a mesh pre-processor module (see FIG. 5), which reformats the mesh data for input to the generator (e.g., rearranging the mesh elements into lists).

One advantage of using an auto-differentiation engine is the support of processing on disconnected meshes. Some of the auto-differentiation engines incorporated by the techniques of this disclosure may use a 3D convolution technique which borrows from and extends the conventional technique of convolution in 2D images. The use of an auto-differentiation engine overcomes a challenge in 3D processing (namely, the significant memory consumption) by taking advantage of sparsity in data representations e.g., point clouds that span the surface of the object instead of the volume of the object. The techniques of the present disclosure advantageously apply the voxelization techniques of one or more auto-differentiation engines to the domain of digital oral care. Resource conservation-based advantages of voxelization as used in the techniques of this disclosure include the following: 1) saving on the RAM required to describe the two dental arches, thereby enabling the entirety of both dental arches to be processed together, enabling arch interactions to be accounted for, and 2) reducing the time required to train the network.

The techniques of this disclosure use the auto-differentiation engine for voxelization and sparse processing. Spatial information is included in the input features. It is important that those spatial features not be distorted by the way that voxelization is done. While doing voxelization, the features of different vertices are aggregates into the voxel centroid. Each element has features assigned to it, and those features get aggregated to the voxel centroid, which may lead to distortion of spatial features. The splat( ) and sparse( ) functions from the auto-differentiation engine do interpolation differently. Splat( ) scales the features relative to the centroid of the voxel, which can distort spatial position information. Sparse( ) does not have this problem. Sparse( ) takes a different approach to assign mesh element features to the voxel. Sparse( ) averages all features for mesh elements within the voxel and assigns that average to the centroid. Sparse( ) yields better experimental results than Splat( ).

A feature vector may be computed for a voxel in manner similar to that of the mesh elements. Just as each mesh element has a feature vector, each voxel may have a feature vector which accompanies the voxel when the voxel is provided to one of the neural networks of the present disclosure. The feature vector may be formed as a result of averaging the feature vectors of the mesh elements which fall within the voxel. Such features may include the spatial and structural features described herein. In some implementations, each voxel may have features computed which are specific to the voxel, such as the volume of the voxel or a quantification of the distribution of mesh elements contained within the voxel.

A tooth may also be represented as a finite element, such as is used in finite element analysis (FEA). Such as tooth may be used for the training and deployment of one or more of the neural networks of the present disclosure.

In some implementations, one or more of the other neural networks models of the present disclosure may also benefit from sparse mesh processing operations which involve the conversion of one or more meshes into voxels, including but not limited to: GDL Setups, RL Setups, VAE Setups, Capsule Setups, MLP Setups, Diffusion Setups, PT Setups, Similarity Setups, Setups Comparison, Setups Classification, VAE Mesh Element Labelling, MAE Mesh In-Filling, Validation Using Autoencoders, or Imputation of Missing Procedure Parameters Values. The advantage of doing so is lower memory requirements and possibly faster processing. Doing so may also improve the predictive results of the respective model, because voxelization may enable that model to isolation and/or identify the important features of the input mesh and focus model training on the encoding of those features.

The generator or discriminator in FIG. 5 may be trained, at least in part, using one or more of Loss G1, Loss G2, and/or LossD. Loss G1 and Loss G2 may involve the calculation of one or more of: representation loss, reconstruction loss, L1 loss, L2 loss, MSE loss, smooth L1 loss, among others. In some implementations, normalization operations may be applied. For example, the loss may in some implementations be normalized with respect to the size of the tooth (e.g., as measured by averaged L1 or L2 distance of mesh elements from the mesh center).

The generator in FIG. 5 may include one or more encoder structures, one or more decoders, one or more U-Net structures, one or more multi-layer perceptrons (MLPs), or one or more transformers. In some implementations, the generator may comprise of an encoder structure, which outputs a transform. In some implementations, the generator may comprise a U-Net structure which generates an output which is consumed by an encoder structure, which outputs a transform. In some implementations, the generator may comprise a U-Net structure which generates an output which is consumed by a transformer, which outputs one or more transforms.

Some implementations may incorporate a Chamfer Distance (CD) calculation into the loss, which measures the squared distance between each point in one set of mesh elements and its nearest neighbor in another set of mesh elements. Chamfer Distance may, in some implementations, enable a differentiable method of comparing mesh element sets (such as set of vertices). Some implementations may incorporate an Earth mover's distance (EMD) into the loss, which measures the squared distance between two sets of mesh elements. Some implementations may incorporate a Point-wise Mesh Euclidean Distance (PMD) calculation into the loss calculation. Some implementations may incorporate a Hausdorff Distance (HD) calculation into the loss calculation. The discriminator in FIG. 5 may include an encoder structure or another type of classifier. LossD may include the calculation of a cross entropy loss, among others.

Representation loss has two components. One component is related to rotation and the other component is related to translation of the tooth. Each component is directly calculated on the coordinate system representation, for example the 3×3 rotation matrix and the 3×1 translation vector. A 4×3 matrix is formed out of the 3×3 and the 1×3 matrices. The distance is calculated as the difference between the ground truth and predicted transform.

The predicted 3×3 matrix is subtracted from the ground truth 3×3 rotation matrices, and either the L1 norm or L2 norm of the result as the rotation loss is computed. The predicted 1×3 matrix is also subtracted from the 1×3 ground truth translation vector, and similarly either the L1 norm or the L2 norm of the result as the translation loss is computed. The total loss is a weighted average or summation of the rotation and translation losses.

Representation loss makes good rotation predictions, but translation predictions present one or more challenges. Reconstruction loss overcomes this limitation of representation loss. First the predicted transformation is applied to the mal tooth, and then the ground truth setup transformation is applied to the mal tooth. The computed loss is the average distance between the mesh elements of these two transformed meshes. Distances may be computed using an L1 norm or an L2 norm, or a combination of both can be used. The distances between the mesh elements of ground truth setup-transformed mesh and prediction-transformed mesh may be followed by a normalization procedure. The normalization procedure may entail dividing the calculated distance value by a term, such as the size of the ground truth mesh. Size may in some implementations be defined by mesh diameter. In other implementations, size may be defined by the average distance of the mesh elements from the centroid of the mesh (e.g., computed by L1 norm or L2 norm of each mesh element from the mesh centroid of that mesh). In one implementation, the L1 distance between mesh elements is calculated and that distance is normalized using the L1 size of the mesh. Next, L2 distance between mesh elements is calculated, and that distance value is normalized using the L2 size of the mesh. In turn, the results of these normalized L1 and L2 calculations are summed and outputted as the loss. MSE loss may in some implementations be used in place of L2 loss. A similar calculation is performed by the comparison tool, to quantify the difference between the ground truth setup-transformed version of a tooth and the prediction-transformed version of a tooth. The advantage of reconstruction loss is that both rotational loss and translation loss are trained, without one of rotational vs. translation loss being favored over the other.

In some implementations, the Loss G1 corresponding to each patient case is the average of the losses of the individual teeth in that patient case. In other implementations, the loss is computed as a weighted average of the losses of the individual teeth, where some teeth have greater weight than others. In still other implementations, the loss in computed as the max loss of any of the teeth in that patient case. In some implementations, a different transform can be predicted for each mesh element or for a subset of mesh elements. In other implementations, a coordinate system can be predicted for the whole tooth. A combination is also possible. Some implementations of Loss G1 calculate unified loss, where loss is calculated on a single transformation per tooth, as opposed to calculating the loss on many transformations in the tooth (i.e., one transformation per tooth element prior to global pooling). Prior to global pooling, there can be one transformation for each tooth mesh element (such as a vertex, edge or face). In unified loss, there is one transformation per whole tooth, and the loss is computed based on that one loss. There are relative losses and absolute losses. ‘Absolute’ is the alternative to relative local. That is, in ‘absolute’ the local coordinate system for each tooth is predicted. The absolute loss-based techniques may benefit from the knowledge of malocclusion local coordinate systems by the network. ‘Relative’ loss, in contrast to ‘absolute’ loss, predicts the transformation that maps a tooth from malocclusion to setup. ‘Local’ means that the relative transformation is computed by assuming that the malocclusion tooth is positioned at the origin. Some implementations may combine two or more of the loss computation strategies described herein, such as the representation loss and the reconstruction loss.

In some implementations, the accuracy of the generator G may be measured using an ADD score. A measurement is taken of the number or percentage of tooth mesh elements in a prediction-transformed tooth mesh that are less than a threshold distance (i.e., 1/10th of the teeth size distant) from the ground truth-transformed tooth mesh. A distance is computed between corresponding mesh elements (e.g., between a vertex in the prediction-transformed tooth mesh and the corresponding vertex in the ground truth-transformed tooth mesh). Distance may be computed using an L1 norm, an L2 norm, or by another method. In some implementations, a distance value may be normalized, for example, by dividing the distance value by a tooth mesh dimension (such as a tooth diameter). If the normalized value is less than a threshold, (e.g., 0.1), then the prediction-transformed tooth mesh element is considered to be close enough to the corresponding ground truth-transformed tooth mesh element. In some implementations, training accuracy (or validation accuracy) is the percentage of tooth mesh elements in the prediction-transformed tooth mesh that fall within the designated threshold distance away from their corresponding mesh elements in the ground truth-transformed tooth mesh. In some implementations, training accuracy (or validation accuracy) is the count or percentage of teeth in an arch where at least a threshold percentage (e.g., 90%) of tooth mesh elements in the prediction-transformed tooth mesh fall within the designated threshold distance away from their corresponding mesh elements in the ground truth-transformed tooth mesh. The advantage of using the ADD score is that the ADD score may engage the geometry of the tooth mesh while providing a criterion to compare the predicted and ground truth setup transforms.

One or more of the other neural networks and/or predictive ML models of the present disclosure may also deliver technical improvements in implementations in which they are augmented with the calculation of ADD score as a measure of progress during model training. Examples of such models of this disclosure include, but are not limited to: GDL Setups, RL Setups, VAE Setups, Capsule Setups, MLP Setups, Diffusion Setups, PT Setups, Similarity Setups, Setups Comparison, Setups Classification, VAE Mesh Element Labelling, MAE Mesh In-Filling, Validation Using Autoencoders, or Imputation of Missing Procedure Parameters Values. FDG Setups may also benefit from the calculation of ADD score as a measure of progress during model training.

There are other approaches to accuracy calculation for the generator G. Training and validation accuracy can, in other implementations, be computed as the percentage overlap between two or more corresponding tooth meshes. For example, if 90% of the two meshes overlap (e.g., by volume, by element count, or by surface area), then the prediction may be considered accurate. In these examples, a correct prediction is a prediction in which the predicted tooth overlaps with the ground truth setup tooth by at least the threshold amount (e.g., by volume, by element count or by surface area). The data precision-based technical improvement is to cause the loss calculation to take into consideration the physical boundaries of the teeth.

Some implementations of the Generator G (e.g., involving the U-Net, among others) may use a coordinate normalization layer so that coordinates and other positional information may be treated differently than the way that other features are treated. There are two sets of information: positional information and other features. These two sets of information may be handled differently during execution of the neural network. Positional information are treated separately from the other features, because positional information may be distorted by the voxelization process. There are two ways to input positional information to the generator network G.

NoCoordNormLayer: Positional information are provided to the network alongside other features, attached to the feature vector which is associated with each mesh element.

WithCoordNormLayer (aka CoordNorm): Positional information are not provided to the network alongside other features, but rather the positional information are first provided to the normalization layer, where the positional information are normalized/standardized in 3D space and then concatenated with either: other input features or with some intermediate network layers.

Experiments found that NoCoordNormLayer and WithCoordNormLayer had comparable validation accuracies, although the training accuracy did show a difference. The training accuracy was higher with the coordinate normalization layer.

The embedding vector (EV) may in some implementations be outputted by the representation generation machine learning module (e.g., the first machine learning model) and is a vector of features which are to be used in predicting a transformation. A representation generation machine learning module may contain one or more U-Net architectures, one or more 3D SWIN transformers, one or more pyramid encoder-decoder structures, or other networks which may be trained to extract hierarchical neural network features from the 3D representations of the teeth (e.g., or other 3D representations for which transforms are to be generated). The embedding vector may comprise a reduced-dimensionality form of a tooth. This reduced-dimensionality form of the tooth may enable the setups prediction neural network to more efficiently encode the reconstruction characteristics of the tooth, and better learn to place the tooth into a pose suitable for either final setups or intermediate stages, thereby providing technical improvements in terms of both data precision and resource footprint.

Furthermore, the reduced dimensionality representations of the teeth may be provided to the second ML module, which may generate predicted setups transforms. The low dimensionality can provide a number of advantages. For example, training machine learning models on data samples (e.g., from the training dataset) which have variable sizes (e.g., one sample has a different size from the other) can be highly error-prone, with the resulting machine learning models generating less accurate predictive outputs. Furthermore, training machine learning models on data samples which are larger than a particular size may result in a less accurate model, because the model is incapable of encoding the distribution of the large data samples. Both of these problems are present in a typical dataset of cohort patient case data. The standard size and low-dimensionality nature of the latent vectors described herein solves both of these problems, which results in more accurate machine learning models (e.g., a second ML module which may be trained to generate setups transforms or to perform classification).

In some implementations, the EV may be provided to a second machine learning module (e.g., an encoder, or an MLP) that has been trained to generate a prediction of a final setup or staging transforms for one or more teeth. In some implementations, the EV may be provided to one or more global average pooling layers that have been trained to generate a prediction of a final setup or staging transform for a tooth. In other implementations, the EV may be received by a multilayer perceptron (MLP) that has been trained to generate a prediction of a final setup or staging transform for a tooth. In one implementation, this MLP includes four (4) fully connected neural network layers. The EV, in some implementations, may contain local and/or global spatial information about the inputted mesh or meshes. The EV may, in some implementations, contain structural information about the inputted mesh or meshes. In some instances, there may be an EV for each tooth mesh element. In other instances, there may be an EV for a whole tooth mesh. An EV or a set of EVs may be used by, for example, an encoder structure (alternatively an MLP or transformer) to make a prediction for a transformation to move a tooth into a setup pose (either for an intermediate stage or for a final setup). The size of the EV is a parameter which may be tuned in the course of training a setups prediction neural network. Possible sizes may include, but are not limited to, powers of two: 2, 4, 8, 16, 32, 64, 128, 256, 512, etc.

In some implementations, the U-Net may output an EV for each mesh element. In an example where there are 28 teeth in a patient case, and each tooth contains 1000 vertices (a number selected for the purpose of simplicity), then the U-Net may output an embedding vector (e.g., of size 9) for each of the 28×1000=28000 mesh elements that was received at the input to the U-Net. These sets of embedding vectors (28,000 embedding vectors in this particular example) may be concatenated and fed into a second ML model which may map those embedding vectors into one or more vectors of transformation values for one or more teeth (e.g., the second ml model may generate transforms for the 28 teeth of the patient to put those teeth into setups poses).

In some instances, the embedding vector EV at the output of the U-Net structure can be used for classification. In some implementations, the EV may be used for tooth mesh classification (e.g., tooth type, tooth health). In some implementations, the EV may be used to classify a full arch of teeth for the purpose of setups classification (e.g., mal, staging, final setups).

Techniques described herein may be trained to generate transforms which may place the patient's teeth into poses suitable for use in orthodontic setups (e.g., intermediate stages or final setups), according to the requirements of the oral care arguments which may, in some implementations, be provided to the generative model. Oral care arguments may include oral care parameters as disclosed herein, or other real-valued, text-based or categorical inputs which specify intended aspects of the one or more 3D oral care representations which are to be generated. In some instances, oral care arguments may include oral care metrics, which may describe intended aspects of the one or more 3D oral care representations which are to be generated. Oral care arguments are specifically adapted to the implementations described herein. For example, the oral care arguments may specify the intended the designs (e.g., including shape and/or structure) of 3D oral care representations which may be generated (or modified) according to techniques described herein. In short, implementations using the specific oral care arguments disclosed herein generate more accurate 3D oral care representations than implementations that do not use the specific oral care arguments. In some instances, a text encoder may encode a set of natural language instructions from the clinician (e.g., generate a text embedding). A text string may comprise tokens. An encoder for generating text embeddings may, in some implementations, apply either mean-pooling or max-pooling between the token vectors. In some instances, a transformer (e.g., BERT or Siamese BERT) may be trained to extract embeddings of text for use in digital oral care (e.g., by training the transformer on examples of clinical text, such as those given below). In some instances, such a model for generating text embeddings may be trained using transfer learning (e.g., initially trained on another corpus of text, and then receive further training on text related to digital oral care). Some text embeddings may encode text at the word level. Some text embeddings may encode text at the token level. A transformer for generating a text embedding may, in some implementations, be trained, at least in part, with a loss calculation which compares predicted outputs to ground truth outputs (e.g., softmax loss, multiple negatives ranking loss, MSE margin loss, cross-entropy loss or the like). In some instances, the non-text arguments, such as real values or categorical values, may be converted to text, and subsequently embedded using the techniques described herein. The following are examples of natural language instructions that may be issued by a clinician to the generative models described herein: “Generate a setup to set to Class I molar and canine, 2 mm overbite and add 2 mm of expansion 5-5/5-5”, “Generate a setup to align with proclination and expansion and finish with 0.5 mm spaces U2-2 for future restorative”, or “Adjust the setup with no second molar movement, rotate upper first molars mesial out for Class I, level lower to a reverse curve of Spee 2 mm, advance the mandible with elastics to Class I canine.”

In some instances, a local coordinate system for a 3D oral care representation, such as a tooth, may be described by one or more transforms (e.g., an affine transformation matrix, translation vector or quaternion). Systems of this disclosure may be trained for coordinate system prediction using past cohort patient case data. The past patient data may include at least: one or more tooth meshes or one or more ground truth tooth coordinate systems. Machine learning models such as: U-Nets, encoders, autoencoders, pyramid encoder-decoders, transformers, or convolution and/or pooling layers, may be trained for coordinate system prediction. Representation learning may determine a representation of a tooth (e.g., encoding a mesh or point cloud into a latent representation, for example, using a U-Net, encoder, transformer, convolution and/or pooling layers or the like), and then predict a transform for that representation (e.g., using a trained multilayer perceptron, transformer, encoder, transformer, or the like) that defines a local coordinate system for that representation (e.g., comprising one or more coordinate axes). In the instance where the coordinate system is predicted for a tooth mesh, the mesh convolutional techniques described herein can leverage invariance to rotations, translations, and/or scaling of that tooth mesh to generate predications that techniques that are not invariant to the rotations, translations, and/or scaling of that tooth mesh cannot generate. Pose transfer techniques may be trained for coordinate system prediction, in the form of predicting a transform for a tooth. Reinforcement learning techniques may be trained for coordinate system prediction, in the form of predicting a transform for a tooth.

Machine learning models such as: U-Nets, encoders, autoencoders, pyramid encoder-decoders, transformers, or convolution and/or pooling layers, may be trained as a part of a method for hardware (or appliance component) placement. Representation learning may train a first module to determine an embedded representation of a 3D oral care representation (e.g., encoding a mesh or point cloud into a latent form using an autoencoder, or using a U-Net, encoder, transformer, block of convolution and/or pooling layers or the like). That representation may comprise a reduced dimensionality form and/or information-rich version of the inputted 3D oral care representation. In some implementations, the generation of a representation may be aided by the calculation of a mesh element feature vector for one or more mesh elements (e.g., each mesh element). In some implementations, a representation may be computed for a hardware element (or appliance component). Such representations are suitable to be provided to a second module, which may perform a generative task, such as transform prediction (e.g., a transform to place a 3D oral care representation relative to another 3D oral care representation, such as to place a hardware element or appliance component relative to one or more teeth) or 3D point cloud generation. Such a transform may comprise an affine transformation matrix, translation vector or quaternion or the like. Machine learning models which may be trained to predict a transform to place a hardware element (or appliance component) relative to elements of patient dentition include: MLP, transformer, encoder, or the like. Systems of this disclosure may be trained for 3D oral care appliance placement using past cohort patient case data. The past patient data may include at least: one or more ground truth transforms and one or more 3D oral care representations (such as tooth meshes, or other elements of patient dentition). In the instance where a U-Net (among other neural networks) is trained to generate the representations of tooth meshes, the mesh convolution and/or mesh pooling techniques described herein leverage invariance to rotations, translations, and/or scaling of that tooth mesh to generate predications that techniques that are not invariant to the rotations, translations, and/or scaling of that tooth mesh cannot generate. Pose transfer techniques may be trained for hardware or appliance component placement. Reinforcement learning techniques may be trained for hardware or appliance component placement.

Techniques of this disclosure may, in some implementations, use PointNet, PointNet++, or derivative neural networks (e.g., networks trained via transfer learning using either PointNet or PointNet++ as a basis for training) to extract local or global neural network features from a 3D point cloud or other 3D representation (e.g., a 3D point cloud describing aspects of the patient's dentition-such as teeth or gums). Techniques of this disclosure may, in some implementations, use U-Nets to extract local or global neural network features from a 3D point cloud or other 3D representation.

3D oral care representations are described herein as such because 3-dimensional representations are currently state of the art. Nevertheless, 3D oral care representations are intended to be used in a non-limiting fashion to encompass any representations of 3-dimensions or higher orders of dimensionality (e.g., 4D, 5D, etc.), and it should be appreciated that machine learning models can be trained using the techniques disclosed herein to operate on representations of higher orders of dimensionality.

In some instances, input data may comprise 3D mesh data, 3D point cloud data, 3D surface data, 3D polyline data, 3D voxel data, or data pertaining to a spline (e.g., control points). An encoder-decoder structure may comprise one or more encoders, or one or more decoders. In some implementations, the encoder may take as input mesh element feature vectors for one or more of the inputted mesh elements. By processing mesh element feature vectors, the encoder is trained in a manner to generate more accurate representations of the input data. For example, the mesh element feature vectors may provide the encoder with more information about the shape and/or structure of the mesh, and therefore the additional information provided allows the encoder to make better-informed decisions and/or generate more-accurate latent representations of the mesh. Examples of encoder-decoder structures include U-Nets, autoencoders or transformers (among others). A representation generation module may comprise one or more encoder-decoder structures (or portions of encoders-decoder structures-such as individual encoders or individual decoders). A representation generation module may generate an information-rich (optionally reduced-dimensionality) representation of the input data, which may be more easily consumed by other generative or discriminative machine learning models.

A U-Net may comprise an encoder, followed by a decoder. The architecture of a U-Net may resemble a U shape. The encoder may extract one or more global neural network features from the input 3D representation, zero or more intermediate-level neural network features, or one or more local neural network features (at the most local level as contrasted with the most global level). The output from each level of the encoder may be passed along to the input of corresponding levels of a decoder (e.g., by way of skip connections). Like the encoder, the decoder may operate on multiple levels of global-to-local neural network features. For instance, the decoder may output a representation of the input data which may contain global, intermediate or local information about the input data. The U-Net may, in some implementations, generate an information-rich (optionally reduced-dimensionality) representation of the input data, which may be more easily consumed by other generative or discriminative machine learning models.

An autoencoder may be configured to encode the input data into a latent form. An autoencoder may train an encoder to reformat the input data into a reduced-dimensionality latent form in between the encoder and the decoder, and then train a decoder to reconstruct the input data from that latent form of the data. A reconstruction error may be computed to quantify the extent to which the reconstructed form of the data differs from the input data. The latent form may, in some implementations, be used as an information-rich reduced-dimensionality representation of the input data which may be more easily consumed by other generative or discriminative machine learning models. In most scenarios, an autoencoder may be trained to input a 3D representation, encode that 3D representation into a latent form (e.g., a latent embedding), and then reconstruct a close facsimile of that input 3D representation at the output.

A transformer may be trained to use self-attention to generate, at least in part, representations of its input. A transformer may encode long-range dependencies (e.g., encode relationships between a large number of inputs). A transformer may comprise an encoder or a decoder. Such an encoder may, in some implementations, operate in a bi-directional fashion or may operate a self-attention mechanism. Such a decoder may, in some implementations, may operate a masked self-attention mechanism, may operate a cross-attention mechanism, or may operate in an auto-regressive manner. The self-attention operations of the transformers described herein may, in some implementations, relate different positions or aspects of an individual 3D oral care representation in order to compute a reduced-dimensionality representation of that 3D oral care representation. The cross-attention operations of the transformers described herein may, in some implementations, mix or combine aspects of two (or more) different 3D oral care representations. The auto-regressive operations of the transformers described herein may, in some implementations, consume previously generated aspects of 3D oral care representations (e.g., previously generated points, point clouds, transforms, etc.) as additional input when generating a new or modified 3D oral care representation. The transformer may, in some implementations, generate a latent form of the input data, which may be used as an information-rich reduced-dimensionality representation of the input data, which may be more easily consumed by other generative or discriminative machine learning models.

In some implementations, an encoder-decoder structure may first be trained as an autoencoder. In deployment, one or more modifications may be made to the latent form of the input data. This modified latent form may then proceed to be reconstructed by the decoder, yielding a reconstructed form of the input data which differs from the input data in one or more intended aspects. Oral care arguments, such as oral care parameters or oral care metrics may be provided to the encoder, the decoder, or may be used in the modification of the latent form, to influence the encoder-decoder structure in generating a reconstructed form that has desired characteristics (e.g., characteristics which may differ from that of the input data).

Techniques of this disclosure may, in some instances, be trained using federated learning. Federated learning may enable multiple remote clinicians to iteratively improve a machine learning model (e.g., validation of 3D oral care representations, mesh segmentation, mesh cleanup, other techniques which involve labeling mesh elements, coordinate system prediction, non-organic object placement on teeth, appliance component generation, tooth restoration design generation, techniques for placing 3D oral care representations, setups prediction, generation or modification of 3D oral care representations using autoencoders, generation or modification of 3D oral care representations using transformers, generation or modification of 3D oral care representations using diffusion models, 3D oral care representation classification, imputation of missing values), while protecting data privacy (e.g., the clinical data may not need to be sent “over the wire” to a third party). Data privacy is particularly important to clinical data, which is protected by applicable laws. A clinician may receive a copy of a machine learning model, use a local machine learning program to further train that ML model using locally available data from the local clinic, and then send the updated ML model back to the central hub or third party. The central hub or third party may integrate the updated ML models from multiple clinicians into a single updated ML model which benefits from the learnings of recently collected patient data at the various clinical sites. In this way, a new ML model may be trained which benefits from additional and updated patient data (possibly from multiple clinical sites), while those patient data are never actually sent to the 3rd party. Training on a local in-clinic device may, in some instances, be performed when the device is idle or otherwise be performed during off-hours (e.g., when patients are not being treated in the clinic). Devices in the clinical environment for the collection of data and/or the training of ML models for techniques described herein may include intra-oral scanners, CT scanners, X-ray machines, laptop computers, servers, desktop computers or handheld devices (such as smart phones with image collection capability). In addition to federated learning techniques, in some implementations, contrastive learning may be used to train, at least in part, the ML models described herein. Contrastive learning may, in some instances, augment samples in a training dataset to accentuate the differences in samples from difference classes and/or increase the similarity of samples of the same class.

In some implementations, an automated setups prediction model may be trained to generate a setup with a customized curve-of-spee (e.g., a curve-of-spee which conforms to the intended outcome of the treatment of the patient). Such a model may be trained on cohort patient case data. One or more oral care metrics may be computed on each case to quantify or measure aspects of that case's curve-of-spee. At training time, one or more of such metrics may be provided to the setups prediction model, for example, to influence the model regarding the geometry and/or structure of each case's curve-of-spee. Upon deployment of the setups prediction model, that same input pathway to the trained neural network may be configured with one or more values as instructions to the model about an intended curve-of-spee. Such values may automatically generate a setup with a curve-of-spee which meets the aesthetic and/or medical treatment needs of the particular patient case.

In some implementations, a curve-of-spee metric may measure the curvature of the occlusal or incisal surfaces of the teeth on either the left or right sides of the arch, with respect to the occlusal plane. The occlusal plane may, in some instances, be computed as a surface which averages the incisal or occlusal surfaces of the teeth (for one or both arches). In some implementations, a curvature metric may be computed along a normal vector, such as a vector which is normal to the occlusal plane. In other implementations, a curvature metric may be computed along the normal vector of another plane. In some implementations, an XY plane may be defined to correspond to the occlusal plane. An orthogonal plane may be defined as the plane that is orthogonal to the occlusal plane, which also passes through a curve-of-spee line segment, where the curve-of-spee line segment is defined by a first endpoint which is a landmarking point on a first tooth (e.g., canine) and a second endpoint which is a landmarking point on the most-posterior tooth of the same side of the arch. A landmarking point can in some implementations be located along the incisal edge of a tooth or on the cusp of a tooth. In some instances, the landmarking points for the intermediate teeth (e.g., teeth which are located between the first tooth and the most posterior tooth) on either the left or right sides of the arch may form a curved path, such as may be described by a polyline. The following is a non-limiting list of curve-of-spee oral care metrics.
1) Measure the vertical height between a line segment and a point. Stated another way, measure a distance between a line segment and a point along the z-axis. The line segment is defined by joining the highest cusp of the most-posterior tooth (in the lower arch) and the cusp of the first tooth on that side (in the lower arch). Given the subset of teeth between the first tooth and the most-posterior tooth, the point is defined by the highest cusp of the lowest tooth of this subset. Stated another way, a curve-of-spee metric may be computed using the following 4 steps. i) Line: Form a line between the highest cusp on the most posterior tooth and the cusp of the first tooth. ii) Curve_Point_A: Given the set of teeth between the most posterior tooth and the first tooth, find the highest point of the lowest tooth. iii) Curve_Point_B: Project Curve_Point_A onto the Line to find a point (Curve_Point_B) along the line that is closest to Curve_Point_A. iv) Curve-Of-Spee: Find the height difference between Curve_Point_B and Curve_Point_A.
2) Project one or more intermediate landmark points (e.g., points on the teeth which lie between the first tooth and the most-posterior tooth on that side of the arch) and the curve-of-spee line segment onto the orthogonal plane. Compute the curve-of-spee metric by measuring the distance between the farthest of the projected intermediate points to the projected curve-of-spee line segment. This yields a measure for the curvature of the arch relative to the orthogonal plane.
3) Project one or more intermediate landmark points and the curve-of-spee line segment onto the occlusal plane. Compute Curve of Spee in this plane by measuring the distance between the farthest of the projected intermediate points to the projected curve-of-spee line segment. This yields a measure for the curvature of the arch relative to the occlusal plane.
4) Skip the projection and compute the distances and curvatures in the 3D space. Compute Curve of Spee by measuring the distance between the farthest of the intermediate points to the curve-of-spee line segment. This yields a measure for the curvature of the arch in 3D space.
5) Compute the slope of the projected curve-of-spee line segment on the occlusal plane.
6) Compute the slope of the projected curve-of-spee line segment in the orthogonal plane.

Curve-of-spee metrics 5 and 6 may help the network to reduce some more degrees of freedom in defining how the patient's arch is curved in the posterior of the mouth.

### EXAMPLES

Example 1. A method of generating setups for orthodontic alignment treatment, the method comprising: receiving, by processing circuitry of a computing device, a digital representation of a patient's teeth; receiving, by the processing circuitry, at least one value pertaining to a customization of orthodontic treatment with respect to a patient; forming, by the processing circuitry, a prediction for one or more tooth movements for a setup, by executing a generator network that comprises one or more neural networks initially trained to predict the one or more tooth movements for the setup; and further training, by the processing circuitry, the generator network based on the formed prediction, to modify the generator network by performing operations comprising: predicting, using the generator network, the one or more tooth movements for the setup based on the digital representation of the patient's teeth, wherein the one or more tooth movements are described by at least one of a position or an orientation; quantifying, using the generator network, a difference between a representation of the one or more tooth movements predicted by the generator network and a representation of one or more reference tooth movements; generating a loss value based on the quantified difference; and modifying the generator network based at least in part on the loss value to form a modified generator network.

Example 2. The method of Example 1, wherein the generator is used in conjunction with a machine learning model which predicts a restoration tooth design.

Example 3. The method of Example 1, wherein the generator is used in conjunction with a machine learning model which generates at least one component or places at least one component for the creation of an oral care appliance.

Example 4. The method of Example 1, wherein at least one transform predicted by the generator is used in the generation of an orthodontic appliance.

Example 5. The method of Example 4, wherein the orthodontic appliance is a clear tray aligner (CTA).

Example 6. The method of Example 5, wherein the CTA thermoformed.

Example 7. The method of Example 5, wherein the CTA is 3D printed.

Example 8. The method of Example 1, wherein the generator contains at least one attention mechanism.

Example 9. The method of Example 1, wherein at least one of mesh pooling, mesh unpooling, mesh convolution or mesh unconvolution is applied to the digital representation of a patient's teeth in the course of generating a representation of the patient's teeth.

Example 10. The method of Example 1, wherein the generator uses sparse processing.

Example 11. The method of Example 1, wherein the generator is trained, at least in part, using end to end training.

Example 12. The method of Example 1, wherein the generator is trained, at least in part, using representation learning.

Example 13. The method of Example 1, wherein the generator is trained, at least in part, on setups data which undergone data augmentation.

Example 14. The method of Example 1, wherein at least one of the one or more tooth movements employ relative local tooth transformation encoding.

Example 15. The method of Example 1, wherein at least one of the one or more tooth movements employ absolute tooth transformation encoding.

Example 16. The method of Example 1, wherein the generator takes information pertaining to an archform as input.

Example 17. The method of Example 1, wherein the generator is trained, at least in part, through transfer learning.

Example 18. The method of Example 17, wherein the generator is trained, at least in part, through transfer learning using a neural network which has first be trained on coordinate system prediction.

Example 19. The method of Example 1, wherein a generator which undergo at least partial training is then used to train a neural network for another technique using transfer learning.

Example 20. The method of Example 1, further applying, by the processing circuitry, at least one interproximal reduction operation to at least one tooth of the digital representation of the patient's teeth, before the at least one tooth is provided to the generator network.

Example 21. The method of Example 9, wherein the representation of the patient's teeth is invariant to at least one of rotation, scale or translation.

Example 22. The method of Example 1, wherein the one or more tooth movements are implemented by one or more transforms.

Example 23. The method of Example 22, wherein the one or more transforms takes the form of at least one of: a transformation matrix, a translation vector, a quaternion, or at least Euler angle.

Example 24. The method of Example 22, wherein the one or more transforms are generated by at least one of: an MLP, a transformer or an encoder in the generator.

Example 25. The method of Example 1, wherein the generator contains one or more coordinate normalization layers.

Example 26. The method of Example 1, wherein a rotation to be applied to at least one tooth of the patient's dentition has pivot point at one of: the crown centroid, apex of the root tip, origin of malocclusion transform or at a point along an archform in proximity to the tooth.

1. A method of generating setups for orthodontic alignment treatment, the method comprising:
receiving, by processing circuitry of a computing device, a digital representation of a patient's teeth;
receiving, by the processing circuitry, at least one value pertaining to a customization of orthodontic treatment with respect to a patient;
forming, by the processing circuitry, a prediction for one or more tooth movements for a setup, by executing a generator network that comprises one or more neural networks initially trained to predict the one or more tooth movements for the setup; and
further training, by the processing circuitry, the generator network based on the formed prediction, to modify the generator network by performing operations comprising:
predicting, using the generator network, the one or more tooth movements for the setup based on the digital representation of the patient's teeth, wherein the one or more tooth movements are described by at least one of a position or an orientation;
quantifying, using the generator network, a difference between a representation of the one or more tooth movements predicted by the generator network and a representation of one or more reference tooth movements;
generating a loss value based on the quantified difference; and
modifying the generator network based at least in part on the loss value to form a modified generator network.

2. The method of claim 1, wherein the digital representation includes a plurality of mesh elements and a respective mesh element feature vector associated with at least one mesh element in the plurality of mesh elements.

3. The method of claim 2, further comprising computing, by the processing circuitry, a respective spatial feature corresponding to at least one of the respective mesh element feature vectors.

4. The method of claim 2, further comprising computing, by the processing circuitry, a respective structural feature corresponding to at least one of the respective mesh element feature vectors.

5. The method of claim 1, further comprising providing, by the processing circuitry, at least one oral care metric as an input to the generator network.

6. The method of claim 1, further comprising providing, by the processing circuitry, at least one orthodontic procedure parameter as an input to the generator network.

7. The method of claim 1, further comprising providing, by the processing circuitry, at least one doctor preference as an input to the generator network.

8. The method of claim 1, where the one or more neural networks of the generator network comprise at least one of an encoder structure, a decoder structure, an autoencoder structure, a U-Net structure, a pyramid encoder-decoder structure, or a transformer structure.

9. The method of claim 1, further comprising providing, by the processing circuitry, a binary flag as an input to the generator network.

10. The method of claim 9, wherein a value of the binary flag indicates at least one of whether a corresponding tooth is one of fixed, pinned, pontic, extracted, implanted, or missing.

11. The method of claim 1, wherein the digital representation comprises at least one of a 3D mesh, a 3D point cloud, or a voxelized representation.

12. The method of claim 1, further comprising computing, by the processing circuitry, a loss value by comparing the predicted setup to a predetermined ground truth setup, wherein the loss value computes at least one pairwise distance between at least one aspect of a 3D tooth representation in a tooth pose as represented in the predicted setup and at least one corresponding aspect of a representation of a corresponding tooth in a reference pose in a ground truth setup.

13. The method of claim 1, wherein the initial training is based on a training dataset that is filtered based on at least one oral care metric.

14. The method of claim 1, wherein the setup associated with the tooth movements represents a predicted setup for the patient, the method further comprising registering the predicted setup with a corresponding ground truth setup.

15. The method of claim 1, wherein the wherein the digital representation represents a maloccluded setup associated with the patient, the method further comprising registering the maloccluded setup with a corresponding ground truth setup.

16. The method of claim 1, further comprising providing, by the processing circuitry, information about interproximal reduction as an input to the generator network.

17. The method of claim 1, further comprising providing, by the processing circuitry, information about an anterior posterior shift as an input to the generator network.

18. The method of claim 1, further comprising providing, by the processing circuitry, a case classification as an input to the generator network.

19. The method of claim 1, wherein the computing device is deployed at a clinical context, and wherein the method is performed in near real-time during an encounter with a patient.

20. A computing device for generating setups for orthodontic alignment treatment, the computing device comprising:
interface hardware configured to:
receive a digital representation of a patient's teeth; and
receive at least one value pertaining to a customization of orthodontic treatment with respect to the patient; and
processing circuitry configured to:
form a prediction for one or more tooth movements for a setup, by executing a generator network that comprises one or more neural networks initially trained to predict the one or more tooth movements for the setup; and
further train the generator network based on the formed prediction, to modify the generator network, wherein to further train the generator network, the processing circuitry is configured to:
predict, using the generator network, the one or more tooth movements for the setup based on the digital representation of the patient's teeth, wherein the one or more tooth movements are described by at least one of a position or an orientation;
quantify, using the generator network, a difference between a representation of the one or more tooth movements predicted by the generator network and a representation of one or more reference tooth movements;
generate a loss value based on the quantified difference; and
modify the generator network based at least in part on the loss value to form a modified generator network.
